(19) United States
(12) Patent Application Publication
(10) Pub. No.: US 2026/0230847 A1
(43) Pub. Date: Aug. 6, 2026

(54) CLUSTERS FOR MOBILITY PREDICTIONS

(71) Applicant: QUALCOMM Incorporated, San Diego, CA (US)

(72) Inventors: Rajeev KUMAR, San Diego, CA (US); Punyaslok PURKAYASTHA, San Diego, CA (US); Aziz GHOLMIEH, Del Mar, CA (US)

(21) Appl. No.: 19/045,498

(22) Filed: Feb. 4, 2025

(51) Int. Cl. H04W 24/02; H04W 24/08; H04W 48/08

(52) U.S. Cl. CPC H04W 24/02; H04W 24/08; H04W 48/08

(57) ABSTRACT

The apparatus may be a wireless device configured to obtain, first information identifying a cell cluster comprising one or more cells of a plurality of cells, wherein the plurality of cells comprises a serving cell and one or more neighboring cells, and perform, based on the first information, a task associated with a ML model. The apparatus may be a network entity configured to transmit, for a UE, first information identifying a cell cluster comprising one or more cells of a plurality of cells, wherein the plurality of cells comprises a serving cell and one or more neighboring cells, and output, for a ML model associated with a task to be performed by the UE, a data collection configuration associated with the cell cluster.

### TECHNICAL FIELD

The present disclosure relates generally to communication systems, and more particularly, to radio resource management (RRM) for wireless communication.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a wireless device such as a user equipment (UE) configured to obtain, first information identifying a cell cluster comprising one or more cells of a plurality of cells, where the plurality of cells comprises a serving cell and one or more neighboring cells, and perform, based on the first information, a task associated with a machine learning (ML) model.

In an aspect of the disclosure, a method, a computer-readable medium, and an apparatus are provided. The apparatus may be a network entity such as a network, a network node, a network function, a base station, or orchestration, administration, and management (OAM) function configured to transmit, for a UE, first information identifying a cell cluster comprising one or more cells of a plurality of cells, where the plurality of cells comprises a serving cell and one or more neighboring cells, and output, for a ML model associated with a task to be performed by the UE, a data collection configuration associated with the cell cluster.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communications system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating a set of clusters that may be associated with RRM and mobility predictions in accordance with some aspects of the disclosure.

FIG. 5 is an illustrative block diagram of an example machine learning (ML) model represented by an artificial neural network (ANN).

FIG. 6 is an illustrative block diagram of an example ML architecture 60 that may be used for wireless communications in any of the various implementations, processes, environments, networks, or use cases listed above.

FIG. 7 is an illustrative block diagram of an example ML architecture of a first wireless device in communication with a second wireless device, in accordance with various aspects of the present disclosure.

FIG. 8 is a call flow diagram illustrating a method of wireless communication in accordance with some aspects of the disclosure.

FIG. 9 is a call flow diagram illustrating a method of wireless communication in accordance with some aspects of the disclosure.

FIG. 10 is a call flow diagram illustrating a method of wireless communication in accordance with some aspects of the disclosure.

FIG. 11 is a call flow diagram illustrating a method of wireless communication in accordance with some aspects of the disclosure.

FIG. 12 is a call flow diagram illustrating a method of wireless communication in accordance with some aspects of the disclosure.

FIG. 13 is a flowchart of a method of wireless communication.

FIG. 14 is a flowchart of a method of wireless communication.

FIG. 15 is a flowchart of a method of wireless communication.

FIG. 16 is a flowchart of a method of wireless communication.

FIG. 17 is a flowchart of a method of wireless communication.

FIG. 18 is a flowchart of a method of wireless communication.

FIG. 19 is a flowchart of a method of wireless communication.

FIG. 20 is a flowchart of a method of wireless communication.

FIG. 21 is a flowchart of a method of wireless communication.

FIG. 22 is a flowchart of a method of wireless communication.

FIG. 23 is a flowchart of a method of wireless communication.

FIG. 24 is a flowchart of a method of wireless communication.

FIG. 25 is a flowchart of a method of wireless communication.

FIG. 26 is a flowchart of a method of wireless communication.

FIG. 27 is a diagram illustrating an example of a hardware implementation for an example apparatus and/or network entity.

FIG. 28 is a diagram illustrating an example of a hardware implementation for an example network entity.

FIG. 29 is a diagram illustrating an example of a hardware implementation for an example network entity.

### DETAILED DESCRIPTION

In some aspects of wireless communication, a wireless device (e.g., a UE) may perform RRM operations. In some aspects, the RRM operations may be associated with artificial intelligence (AI) and/or machine learning (ML) based prediction(s). An RRM prediction, in some aspects, may involve one or more prediction(s) related to radio measurement, measurement events, radio link failure events, handover failure events, and other mobility related measurements or events. The AI/ML based mobility, in some aspects, may be associated with cell level measurement prediction. In some aspects, the AI/ML based mobility may be viewed as an extension of beam level measurement prediction to cell level measurement prediction for serving and candidate cells. The AI/ML based mobility, in some aspects, may include one of UE-side models or network-side models. The AI/ML models, in some aspects, may be associated with prediction of one or more measurement events, a radio link failure (RLF) prediction, or a handover failure (HOF) prediction.

AI/ML models may use a cell-based approach (e.g., may use measurement results related to one cell to predict the measurement of that cell) or a cluster-based approach (e.g., may use measurement results related to multiple cells to predict the measurement of one or more cells). In some aspects, the cluster-based approach may produce worse (e.g., less accurate) results for some predictions relating to a particular cell than a cell-based approach. Additionally, a cluster-based approach, in some aspects, may be associated with increased complexity. However, in some aspects, a cluster-based approach may produce better (e.g., more accurate) results for other predictions. The performance of cluster-based AI/ML RRM prediction (e.g., inter-frequency prediction) may depend on which cells are combined to form the cluster (e.g., which cells are measured in association with the cluster-based prediction). For example, if the cluster of cells for a cluster-based AI/ML model includes cells that use a same transmit power, are mounted at a same (or similar) height, have a same (or similar) beam arrangement, or have similar environments (similar distribution of obstructions), the accuracy of the cluster-based AI/ML model may be improved over a cluster-based AI model based on a cluster including all nearby cells or a cell-based AI/ML model.

Various aspects relate generally to forming clusters of neighboring cells specific for use in AI/ML mobility predictions and related signaling (e.g., how to form clusters for AI/ML-based predictions such as for RRM measurement prediction, measurement event prediction, RLF prediction, and handover failure prediction). The clusters may be formed, in some aspects, for measurement collection for AI/ML model training and/or for AI/ML predictions during inference. Some aspects more specifically relate to UE-side cluster formation (e.g., specification and/or identification) or network-side cluster formation. In some examples, a UE may be configured to receive, from a serving cell, first information regarding a plurality of cells, where the plurality of cells includes the serving cell and one or more neighboring cells, obtain, based on the first information regarding the plurality of cells, second information identifying a cell cluster including one or more cells of the plurality of cells, and perform, based on the second information, a task associated with a first ML model. In some examples, a network, a network node, a network function, a base station, or OAM function may be configured to transmit, for a first UE, first information regarding a plurality of cells, where the plurality of cells includes a serving cell and one or more neighboring cells, transmit, for the first UE, second information identifying a cell cluster including one or more cells of the plurality of cells, and transmit, for a ML model associated with a task to be performed by the first UE, a data collection configuration associated with the cell cluster.

Particular aspects of the subject matter described in this disclosure can be implemented to realize one or more of the following potential advantages. In some examples, by selecting the cells included in a cluster associated with a cluster-based AI/ML model, the described techniques can be used to improve the accuracy of predictions related to RRM and/or mobility such as one or more prediction(s) related to radio measurement, measurement events, radio link failure events, handover failure events, and other mobility related measurements or events.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

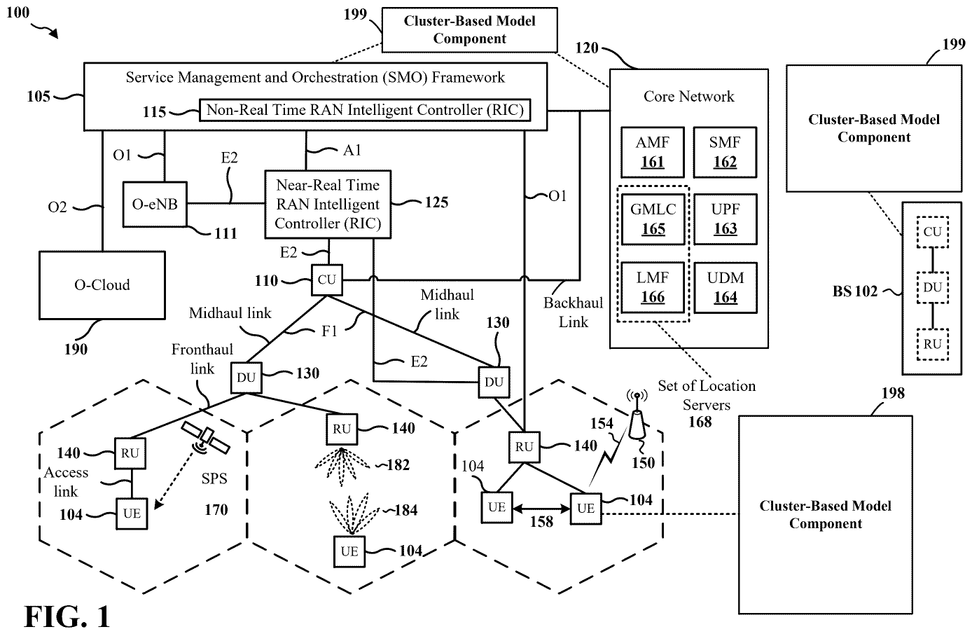

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHz-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHz-71 GHZ), FR4 (71 GHz-114.25 GHz), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may have a cluster-based model component 198 that may be configured to obtain, first information identifying a cell cluster comprising one or more cells of a plurality of cells, where the plurality of cells comprises a serving cell and one or more neighboring cells, and perform, based on the first information, a task associated with a ML model. In certain aspects, the base station 102 (or a component thereof), a component of the SMO framework 105, or a component of the core network 120 may have a cluster-based model component 199 that may be configured to transmit, for a UE, first information identifying a cell cluster comprising one or more cells of a plurality of cells, where the plurality of cells comprises a serving cell and one or more neighboring cells, and output, for a ML model associated with a task to be performed by the UE, a data collection configuration associated with the cell cluster. Although the following description may be focused on certain components of a 5G NR RAN, the concepts described herein may be applicable to other similar components associated with other similar networks associated with, e.g., LTE, LTE-A, CDMA, GSM, and other wireless technologies.

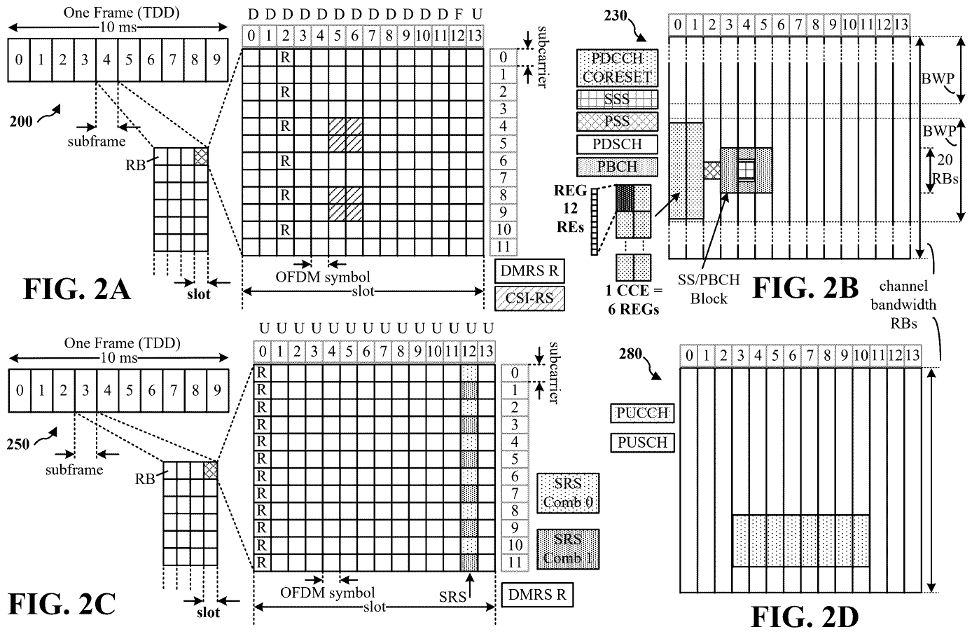

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | Cyclic |
|---|---|---|
| μ | Δf = 2^{μ} · 15[kHz] | prefix |
| 0 | 15 | Normal |
| 1 | 30 | Normal |
| 2 | 60 | Normal, Extended |
| 3 | 120 | Normal |
| 4 | 240 | Normal |
| 5 | 480 | Normal |
| 6 | 960 | Normal |

For normal CP (14 symbols/slot), different numerologies μ0 to 4 allow for 1, 2, 4, 8, and 16 slots, respectively, per subframe. For extended CP, the numerology 2 allows for 4 slots per subframe. Accordingly, for normal CP and numerology u, there are 14 symbols/slot and 24 slots/subframe. The subcarrier spacing may be equal to 2^{μ}*15 kHz, where μ is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

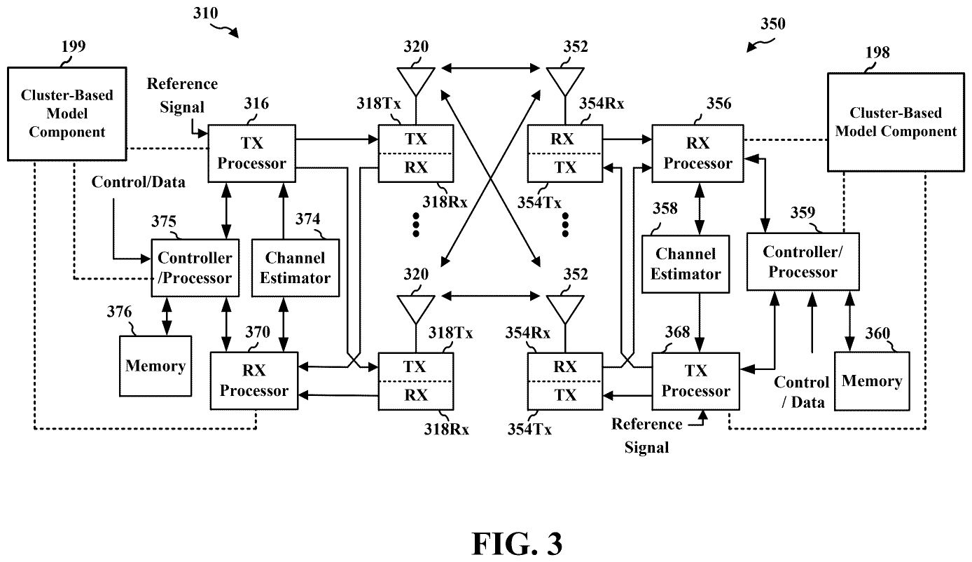

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the cluster-based model component 198 of FIG. 1.

At least one of the TX processor 316, the RX processor 370, and the controller/processor 375 may be configured to perform aspects in connection with the cluster-based model component 199 of FIG. 1.

In some aspects of wireless communication, a wireless device (e.g., a UE) may perform RRM operations. In some aspects, the RRM operations may be associated with AI/ML based mobility. The AI/ML based mobility, in some aspects, may be associated with cell level measurement prediction. In some aspects, the AI/ML based mobility may be viewed as an extension of beam level measurement prediction to cell level measurement prediction for serving and candidate cells. The AI/ML based mobility, in some aspects, may include one of UE-side models or network-side models. The AI/ML models, in some aspects, may be associated with prediction of one or more measurement events, a RLF prediction, a HOF prediction.

AI/ML models may use a cell-based approach (e.g., may use measurement results related to one cell to predict the measurement of that cell) or a cluster-based approach (e.g., may use measurement results related to multiple cells to predict the measurement of one or more cells). In some aspects, the cluster-based approach may produce worse (e.g., less accurate) results for some predictions relating to a particular cell than a cell-based approach. Additionally, a cluster-based approach, in some aspects, may be associated with increased complexity. However, in some aspects, a cluster-based approach may produce better (e.g., more accurate) results for other predictions. The performance of cluster-based AI/ML RRM prediction (e.g., inter-frequency prediction) may depend on which cells are combined to form the cluster (e.g., which cells are measured in association with the cluster-based prediction). For example, if the cluster of cells for a cluster-based AI/ML model includes cells that use a same transmit power, are mounted at a same (or similar) height, have a same (or similar) beam arrangement, or have similar environments (similar distribution of obstructions), the accuracy of the cluster-based AI/ML model may be improved over a cluster-based AI model based on a cluster including all nearby cells or a cell-based AI/ML model.

Various aspects relate generally to how to form clusters for AI/ML-based predictions (e.g., RRM measurement prediction, measurement event prediction, RLF prediction, and handover failure prediction). The clusters may be formed, in some aspects, for measurement collection for AI/ML model training and/or for AI/ML predictions during inference. Some aspects more specifically relate to UE-side cluster formation (e.g., specification and/or identification) or network-side cluster formation. In some examples, a UE may be configured to receive, from a serving cell, first information regarding a plurality of cells, where the plurality of cells includes the serving cell and one or more neighboring cells, obtain, based on the first information regarding the plurality of cells, second information identifying a cell cluster including one or more cells of the plurality of cells, and perform, based on the second information, a task associated with a first machine learning (ML) model. In some examples, a network, a network node, a network function, a base station, or OAM function may be configured to transmit, for a first UE, first information regarding a plurality of cells, where the plurality of cells includes a serving cell and one or more neighboring cells, transmit, for the first UE, second information identifying a cell cluster including one or more cells of the plurality of cells, and transmit, for a ML model associated with a task to be performed by the first UE, a data collection configuration associated with the cell cluster.

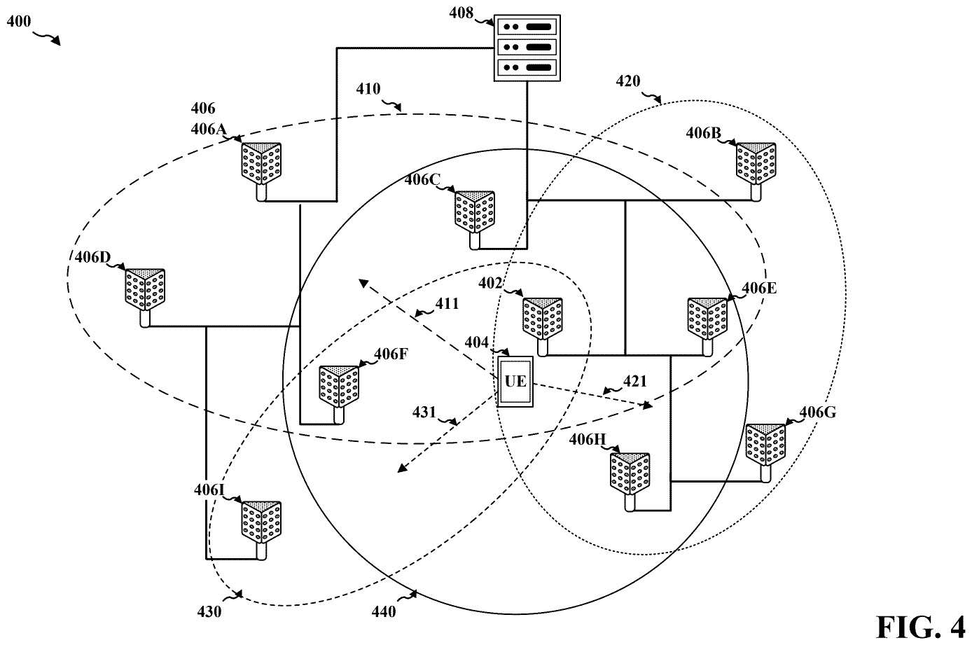

FIG. 4 is a diagram 400 illustrating a set of clusters that may be associated with RRM and mobility predictions in accordance with some aspects of the disclosure. Diagram 400 illustrates an environment including a base station 402, a UE 404, and a set of additional base stations (e.g., including base station 406A, base station 406B, base station 406C, base station 406D, base station 406E, base station 406F, base station 406G, base station 406H, and base station 406I, which may be referred to generically as a base station 406 or as base stations 406). The base stations 402 and 406A-406I, in some aspects, may be cells associated with a NG-RAN. In some aspects, the base station 402 may be a serving cell for the UE 404 and may provide an indication of a first cell cluster 410, a second cell cluster 420, and a third cell cluster 430. For example, the first cell cluster 410 may include base stations 402, 406A, 406C, 406D, 406E, and 406F as members, the second cell cluster 420 may include base stations 402, 406B, 406E, 406G, and 406H as members, and the third cell cluster 430 may include base stations 402, 406F, and 406I as members.

In some aspects, different cell clusters may be associated with different AI/ML models and/or predictions for RRM and/or mobility. As a non-limiting example, the first cluster 410 may be associated with an AI/ML model for mobility-related predictions (e.g., relating to a handover from base station 402 to another base station in the first cell cluster 410) associated with a movement of the UE 404 in the direction 411. Similarly, the second cell cluster 420 and the third cell cluster 430 may be associated with AI/ML models for mobility-related predictions associated with movements 421 and 431, respectively, of the UE 404. A fourth cluster 440, in some aspects, may be associated with a measurement event prediction (e.g., based on a current location of the UE 404). In some aspects, the different cell clusters may each be associated with a plurality of different AI/ML models for different aspects of RRM and/or mobility (e.g., RRM measurement predictions, measurement event prediction, RLF prediction, and HO/HOF prediction). In some aspects, different cell clusters may be associated with AI/ML models for predictions relating to different aspects of RRM and/or mobility. The cell clusters, in some aspects, may be determined by a network entity. The network entity, in some aspects, may be (1) one or more of the base stations 402 and/or 406A-406I, a (2) network function (NF) associated with the base stations 402 and/or 406A-406I (e.g., a network entity residing in, or associated with, a core network or a mobile network operator (MNO) network), (3) an OAM function associated with the base stations 402 and 406A-406I, or (4) the NG-RAN itself. In some aspects, the cell clusters may be determined by a UE or a UE-side network entity such as a UE-side server, or UE-side network function, associated with one or more UEs (e.g., UE 404). The network entity (e.g., the NF, the OAM function, or the UE-side server) may be implemented by, or on, a server 408 including one or more processors and memory. Although illustrated as a single entity, the processors and memory of the server 408 may be distributed across multiple physical locations and/or devices.

In some aspects, the clusters for AI/ML predictions (RRM measurements, measurement event prediction, and RLF/handover prediction) may be formed (e.g., determined, generated, specified, etc.) for one or more tasks and may be associated with, e.g., measurement collection (for training) and predictions (during inference). In some aspects determining the cluster membership at the UE-side, the UE may be provided with layout information of a serving cell and one or more neighboring cells (e.g., location, height, and/or orientation information for the serving cell and the one or more neighboring base stations or cells). The layout information may be provided as ‘objective’ information based on a reference frame, or may be pairwise information relating the layout of each neighboring cell to the serving cell. In some aspects, the layout information may be provided by the serving cell. The layout information, in some aspects, may be generated and/or compiled by a UE based on receiving system information from the serving cell and the one or more neighboring cells. In some aspects, grouping of the cells (e.g., generating the cell clusters) for mobility predictions may be based on inter-cell relationships. For AI/ML training and/or predictions, the cluster formation and/or grouping of the cells, in some aspects, may be performed without inter-cell relationship and/or layout information.

For example, in some aspects, a UE (or UE-side network entity) may determine the membership of the cell clusters based on layout information (e.g., complete/objective or pairwise layout information that may include IDs and/or explicit information) signaled to the UE. In some aspects, the UE (or UE-side network entity) may determine the membership of the cell clusters based on neighbor cell information (e.g., one or more of inter-frequency or intra-frequency information) signaled to the UE by the neighboring cell(s) (e.g., in one or more SIBs transmitted by the neighbor cell(s)). Where different physical properties (e.g., height, beam configurations, etc.) of the neighboring cells impact AI/ML prediction accuracy, the layout information may include information regarding the physical properties known to impact the AI/ML prediction accuracy. Alternatively, in some aspects, the network (e.g., any of the network entities described above) may indicate the cluster information (e.g., via the serving cell) to one or more UEs. The cluster information, in some aspects, may include one or more of a cluster membership, an area scope (e.g., cell IDs and/or frequency [absolute radio-frequency channel number (ARFCN)]) that may define the cells for measurement collection (for training) and predictions (during inference) for, or associated with, a particular task (e.g., a particular set of one or more RRM or mobility related predictions). In some aspects, base stations that are combined in, or members of, a cell cluster for measurement collection (for training) and predictions (during inference) may be provided with a same cluster ID, and the cluster ID may be signaled to the UE in RRC (e.g., via SI and/or dedicated configuration signaling).

In some aspects, in a geographical area, clusters may be determined based on one or more of, (1) geographical proximity and/or a neighboring cell list, (2) a physical configuration and/or environment, and/or (3) a related task (e.g., a particular prediction such as a measurement prediction, a measurement event prediction, a RLF failure prediction, etc.). In some aspects, the physical configuration and/or environment may include a transmission power, one or more beam configurations (e.g., codebook, antenna patters, beam width, etc.), height, being indoors, being outdoors, deployment purpose, carrier frequency/frequencies, infra-vendor information, or other physical characteristics that may affect the accuracy of an associated AI/ML model for prediction. For example, in some aspects, a cell cluster for data collection and/or predictions may include base stations transmitting at the same power, and having the same beam configurations, or may include base stations deployed for a particular purpose (e.g., for a high speed train (HST), a non-public network, a multicast-broadcast purpose, etc.).

Different clusters, in some aspects, may be formed (e.g., identified, determined, etc.) for different AI/ML prediction objective. For example, at a first UE, a first cell cluster determined for, and/or associated with, radio link failure event prediction may not include the same cells as a second cell cluster determined for, and/or associated with, measurement event predictions. In some aspects, a particular cell may belong to one or more cell clusters associated with different tasks and/or purposes (e.g., identified to, and used by, a particular UE for different tasks and/or purposes).

Some aspects and techniques as described herein may be implemented, at least in part, using an artificial intelligence (AI) program, such as a program that includes a machine learning (ML) or artificial neural network (ANN) model. An example ML model may include mathematical representations or define computing capabilities for making inferences from input data based on patterns or relationships identified in the input data. As used herein, the term “inferences” can include one or more decisions, predictions, determinations, or values, which may represent outputs of the ML model. The computing capabilities may be defined in terms of certain parameters of the ML model, such as weights and biases. Weights may indicate relationships between certain input data and certain outputs of the ML model, and biases are offsets that may indicate a starting point for the outputs of the ML model. An example ML model operating on input data may start at an initial output based on the biases and then update its output based on a combination of the input data and the weights.

In some aspects, an ML model may be configured to provide computing capabilities for wireless communications. Such an ML model may be configured with weights and biases to assist in decoding received transmissions, e.g., as described herein.

ML models may be deployed in one or more devices (for example, network entities and/or user equipment (UE)) and may be configured to enhance various aspects of a wireless communication system. For example, an ML model may be trained to identify patterns or relationships in data corresponding to a network, a device, an air interface, or the like. An ML model may support operational decisions relating to one or more aspects associated with wireless communications devices, networks, or services. For example, an ML model may be utilized for supporting or improving aspects such as signal coding/decoding, network routing, energy conservation, transceiver circuitry controls, frequency synchronization, timing synchronization, channel state estimation, channel equalization, channel state feedback, modulation, demodulation, device positioning, beamforming, load balancing, operations and management functions, security, etc.

ML models may be characterized in terms of types of learning that generate specific types of learned models that perform specific types of tasks. For example, different types of machine learning include supervised learning, unsupervised learning, semi-supervised learning, reinforcement learning, deep learning, etc. ML models may be used to perform different tasks, such as classification or regression, where classification refers to determining one or more discrete output values from a set of predefined output values, and regression refers to determining continuous values that are not bounded by predefined output values. Some example ML models configured for performing such tasks include ANNs such as convolutional neural networks (CNNs) and recurrent neural networks (RNNs), transformers, diffusion models, regression analysis models (such as statistical models), large language models (LLMs), decision tree learning (such as predictive models), support vector networks (SVMs), and probabilistic graphical models (such as a Bayesian network), etc.

The description herein illustrates, by way of some examples, how one or more tasks or problems in wireless communications may benefit from the application of one or more ML models for RRM and/or mobility related predictions (e.g., RRM measurement predictions, measurement event prediction, RLF prediction, and HO/HOF prediction). To facilitate the discussion, an ML model configured using an ANN is used, but other types of ML models may be used instead of an ANN. Hence, unless expressly recited, subject matter regarding an ML model is not intended to be limited to an ANN solution. Unless otherwise specifically stated, terms such “AI/ML model,” “ML model,” “trained ML mode,” “ANN,” “model,” “algorithm,” or the like are intended to be interchangeable.

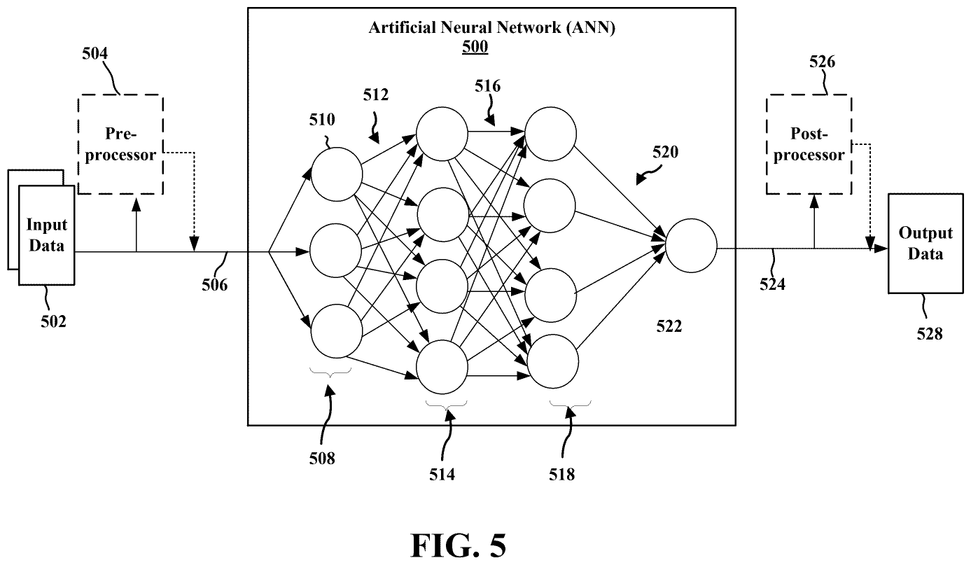

FIG. 5 is an illustrative block diagram of an example machine learning (ML) model represented by an artificial neural network (ANN) 500. ANN 500 may receive input data 506, which may include one or more bits of data 502, pre-processed data output from pre-processor 504 (optional), or some combination thereof. Here, data 502 may include training data, verification data, application-related data, or the like, based, for example, on the stage of deployment of ANN 500. Pre-processor 504 may be included within ANN 500 in some other implementations. Pre-processor 504 may, for example, process all or a portion of data 502, which may result in some of data 502 being changed, replaced, deleted, etc. In some implementations, pre-processor 504 may add additional data to data 502. In some implementations, the pre-processor 504 may be an ML model, such as an ANN. As an example, the input may include information based on measurements performed on each cell in a cluster of cells.

The ANN 500 includes at least one first layer 508 of artificial neurons 510 to process input data 506 and provide resulting first layer data via connections or “edges” such as edges 512 to at least a portion of at least one second layer 514. Second layer 514 processes data received via edges 512 and provides second layer output data via edges 516 to at least a portion of at least one third layer 518. Third layer 518 processes data received via edges 516 and provides third layer output data via edges 520 to at least a portion of a final layer 522, including one or more neurons to provide output data 524. All or part of output data 524 may be further processed in some manner by (optional) post-processor 526. Thus, in certain examples, ANN 500 may provide output data 528 that is based on output data 524, post-processed data output from post-processor 526, or some combination thereof. As an example, the output may include a prediction related to RRM and/or mobility (e.g., RRM measurement predictions, measurement event prediction, RLF prediction, and HO/HOF prediction).

Post-processor 526 may be included within ANN 500 in some other implementations. Post-processor 526 may, for example, process all or a portion of output data 524, which may result in output data 528 being different, at least in part, from output data 524, as a result of data being changed, replaced, deleted, etc. In some implementations, post-processor 526 may be configured to add additional data to output data 524. In this example, second layer 514 and third layer 518 represent intermediate or hidden layers that may be arranged in a hierarchical or other like structure. Although not explicitly shown, there may be one or more further intermediate layers between the second layer 514 and the third layer 518. In some implementations, the post-processor 526 may be an ML model, such as an ANN.

The structure and training of artificial neurons 510 in the various layers may be tailored to the specific conditions of an application. Within a given layer, such as first layer 508, second layer 514, or third layer 518 of ANN 500, some or all of the neurons may be configured to process information provided to the layer and output corresponding transformed information from the layer. For example, transformed information from a layer may represent a weighted sum of the input information associated with or otherwise based on a non-linear activation function or other activation function used to “activate” the artificial neurons of the next layer. Artificial neurons in such a layer may be activated by or be responsive to parameters such as the previously described weights and biases of ANN 500. The weights and biases of ANN 500 may be adjusted during a training process or during operation of ANN 500. The weights of the various artificial neurons may control the strength of connections between layers of artificial neurons, while the biases may control the direction of connections between the layers or artificial neurons. An activation function may select or determine whether an artificial neuron transmits its output to the next layer or not in response to its received data.

Different activation functions may be used to model different types of non-linear relationships. By introducing non-linearity into an ML model, an activation function allows the configuration for the ML model to change in response to identifying or detecting complex patterns and relationships in the input data 506. Some non-exhaustive example activation functions include a sigmoid based activation function, a hyperbolic tangent (tanh) based activation function, a convolutional activation function, up-sampling, pooling, and a rectified linear unit (ReLU) based activation function.

Training of an ML model, such as ANN 500, may be conducted using training data, e.g., as described herein. Training data may include one or more datasets that ANN 500 may use to identify patterns or relationships. Training data may represent various types of information, including written, visual, audio, environmental context, operational properties, etc. During training, the parameters (such as the weights and biases) of artificial neurons 510 may be changed, such as to minimize or otherwise reduce a loss function or a cost function. A training process may be repeated multiple times to fine-tune ANN 500 with each iteration.

Various ANN model structures are available for consideration. For example, in a feedforward ANN structure, each artificial neuron (of one or more artificial neurons 510) in layer 514 receives information from the previous layer (such as one or more artificial neurons 510 in layer 508) and produces information for the next layer (such as one or more artificial neurons 510 in layer 518). In a convolutional ANN structure, some layers may be organized into filters that extract features from data, such as the training data or the input data. In a recurrent ANN structure, some layers may have connections that allow for the processing of data across time, such as for processing information having a temporal structure, such as time series data forecasting.

In an autoencoder ANN structure, compact representations of data may be processed and the model trained to predict or potentially reconstruct original data from a reduced set of features. An autoencoder ANN structure may be useful for tasks related to dimensionality reduction and data compression.

A generative adversarial ANN structure may include a generator ANN and a discriminator ANN that are trained to compete with each other. Generative-adversarial networks (GANs) are ANN structures that may be useful for tasks relating to generating synthetic data or improving the performance of other models.

A transformer ANN structure makes use of attention mechanisms that may enable the model to process input sequences in a parallel and efficient manner. An attention mechanism allows the model to focus on different parts of the input sequence at different times. Attention mechanisms may be implemented using a series of layers known as attention layers to compute weighted sums of input features based on a similarity between different elements of the input sequence. A transformer ANN structure may include a series of feedforward ANN layers whose configurations may change in response to identifying non-linear relationships between the input and output sequences, which may also be referred to as a process of “learning” by the ANN layers. The output of a transformer ANN structure may be obtained by applying a linear transformation to the output of a final attention layer. A transformer ANN structure may be of particular use for tasks that involve sequence modeling, or other like processing.

Another example type of ANN structure is a model with one or more invertible layers. Models of this type may be inverted or “unwrapped” to reveal the input data that was used to generate the output of a layer. Other example types of ANN model structures include fully connected neural networks (FCNNs) and long short-term memory (LSTM) networks.

ANN 500 or other ML models may be implemented in various types of processing circuits along with memory and applicable instructions therein. For example, general-purpose hardware circuits, such as one or more central processing units (CPUs), one or more graphics processing units (GPUs), or suitable combinations thereof, may be employed to implement a model. In some implementations, one or more tensor processing units (TPUs), neural processing units (NPUs), or other special-purpose processors, field-programmable gate arrays (FPGAs), application-specific integrated circuits (ASICs), or the like may also be employed. In some implementations, the ML model may be implemented by an NPU or a TPU embedded in a system on chip (SoC) along with other components, such as one or more CPUs, GPUs, etc. A SoC includes several components manufactured on a shared semiconductor substrate. The NPU or TPU may be controlled by the one or more CPUs by configuring the ML model implemented by the NPU or TPU with weights and biases, providing certain training data to the ML model to configure the ML model, or providing input data to the ML model to obtain related inferences. The one or more CPUs may also receive the inferences and be configured to perform certain actions based on the inferences produced by the ML model. The actions performed by the one or more CPUs may include sending commands to other components of the SoC or components external to the SoC to perform certain actions. For example, the CPU may send commands to an RF transceiver based on the outputs or inferences obtained from an ML model to cause the RF transceiver to operate on a wireless network in accordance with the ML model.

In some examples, an ML model may be trained prior to, or at some point following, operation of the ML model, such as ANN 500, on input data. When training the ML model, information in the form of applicable training data may be gathered or otherwise created for use in training an ANN accordingly. For example, training data may be gathered or otherwise created regarding information associated with received/transmitted signal strengths, interference, and resource usage data, as well as any other relevant data that might be useful for training a model to address one or more problems or issues in a communication system. In certain instances, all or part of the training data may originate in a UE or other device in a wireless communication system, or one or more network entities, or aggregated from multiple sources (such as a UE and a network entity/entities, one or more other UEs, the Internet, or the like). For example, wireless network architectures, such as self-organizing networks (SON) or mobile drive test (MDT) networks, may be adapted to support the collection of data for ML model applications. In another example, training data may be generated or collected online, offline, or both online and offline by a UE, network entity, or other device(s), and all or part of such training data may be transferred or shared (in real or near-real time), such as through store and forward functions or the like.

Offline training may refer to creating and using a static training dataset, such as in a batched manner, whereas online training may refer to the real-time collection and use of training data. For example, an ML model at a network device (such as a UE) may be trained or fine-tuned using online or offline training. For offline training, data collection and training can occur in an offline manner at the network side (such as at a base station or other network entity) or at the UE side. For online training, the training of a UE-side ML model may be performed locally at the UE or by a server device (such as a server hosted by a UE vendor) in a real-time or near-real-time manner based on data provided to the server device from the UE. In certain instances, all or part of the training data may be shared within a wireless communication system or even shared (or obtained from) outside of the wireless communication system.

Once an ANN has been configured by setting parameters, including weights and biases, from training data, the ANN's performance may be evaluated. In some scenarios, evaluation/verification tests may use a validation dataset, which may include data not in the training data, to compare the model's performance to baseline or other benchmark information. The ANN configuration may be further refined, for example, by changing its architecture, retraining it on the data, or using different optimization techniques, etc.

As part of a training process, parameters affecting the functioning of the artificial neurons and layers may be adjusted. For example, backpropagation techniques may be used to train an ANN by iteratively adjusting weights or biases of certain artificial neurons associated with errors between a predicted output of the model and a desired output that may be known or otherwise deemed acceptable. Backpropagation may include a forward pass, a loss function, a backward pass, and a parameter update that may be performed in training iteration. The process may be repeated for a certain number of iterations for each set of training data until the weights of the artificial neurons/layers are adequately tuned.

Backpropagation techniques associated with a loss function may measure how well a model is able to predict a desired output for a given input. An optimization algorithm may be used during a training process to adjust weights and biases to reduce or minimize the loss function, which can improve the performance of the model. There are a variety of optimization algorithms that may be used along with backpropagation techniques or other training techniques. Some initial examples include a gradient descent based optimization algorithm and a stochastic gradient descent based optimization algorithm. A stochastic gradient descent technique may be used to adjust weights/biases in order to minimize or otherwise reduce a loss function. A mini-batch gradient descent technique, which is a variant of gradient descent, may involve updating weights/biases using a small batch of training data rather than the entire dataset. A momentum technique may accelerate an optimization process by adding a momentum term to update or otherwise affect certain weights/biases.

An adaptive learning rate technique may adjust the learning rate of an optimization algorithm associated with one or more characteristics of the training data. A batch normalization technique may be used to normalize inputs to a model in order to stabilize a training process and potentially improve the performance of the model. A “dropout” technique may be used to randomly drop out some of the artificial neurons from a model during a training process, for example, in order to reduce overfitting and potentially improve the generalization of the model. An “early stopping” technique may be used to stop an ongoing training process early, such as when a performance of the model using a validation dataset starts to degrade.

Another example technique includes data augmentation to generate additional training data by applying transformations to all or part of the training information. A transfer learning technique may be used which involves using a pre-trained model as a starting point for training a new model, which may be useful when training data is limited or when there are multiple tasks that are related to each other. A multi-task learning technique may be used which involves training a model to perform multiple tasks simultaneously to potentially improve the performance of the model on one or more of the tasks. Hyperparameters or the like may be input and applied during a training process in certain instances.

Another example technique that may be useful with regard to an ANN is a “pruning” technique. A pruning technique, which may be performed during a training process or after a model has been trained, involves the removal of unnecessary or less necessary, or possibly redundant features from a model. In certain instances, a pruning technique may reduce the complexity of a model or improve the efficiency of a model without undermining the intended performance of the model.

Pruning techniques may be particularly useful in the context of wireless communication, where the available resources (such as power and bandwidth) may be limited. Some example pruning techniques include a weight pruning technique, a neuron pruning technique, a layer pruning technique, a structural pruning technique, and a dynamic pruning technique. Pruning techniques may, for example, reduce the amount of data corresponding to a model that is transmitted or stored. Weight pruning techniques may involve removing some of the weights from a model. Neuron pruning techniques may involve removing some neurons from a model. Layer pruning techniques may involve removing some layers from a model. Structural pruning techniques may involve removing some connections between neurons in a model. Dynamic pruning techniques may involve adapting a pruning strategy of a model associated with one or more characteristics of the data or the environment. For example, in certain wireless communication devices, a dynamic pruning technique may more aggressively prune a model for use in a low-power or low-bandwidth environment and less aggressively prune the model for use in a high-power or high-bandwidth environment. In certain example implementations, pruning techniques may also be applied to training data, for example, to remove outliers. In some implementations, pre-processing techniques directed to all or part of a training dataset may improve model performance or promote faster convergence of a model. For example, training data may be pre-processed to change or remove unnecessary data, extraneous data, incorrect data, or otherwise identifiable data. Such pre-processed training data may, for example, lead to a reduction in potential overfitting or otherwise improve the performance of the trained model.

One or more of the example training techniques presented above may be employed as part of a training process. Some example training processes that may be used to train an ANN include supervised learning, unsupervised learning, semi-supervised learning, and reinforcement learning techniques. With supervised learning, a model is trained on a labeled training dataset, where the input data is accompanied by a correct or otherwise acceptable output. With unsupervised learning, a model is trained on an unlabeled training dataset, such that the model will learn to identify patterns and relationships in the data without the explicit guidance of a labeled training dataset. With semi-supervised learning, a model is trained using some combination of supervised and unsupervised learning processes, for example, when the amount of labeled data is somewhat limited. With reinforcement learning, a model may learn from interactions with its operation/environment, such as in the form of feedback akin to rewards or penalties. Reinforcement learning may be particularly beneficial when used to improve or attempt to optimize the behavior of a model deployed in a dynamically changing environment, such as a wireless communication network.

Distributed, shared, or collaborative learning techniques may be used for the training process. For example, techniques such as federated learning may be used to decentralize the training process and rely on multiple devices, network entities, or organizations for training various versions or copies of an ML model without relying on a centralized training mechanism. Federated learning may be particularly useful in scenarios where data is sensitive or subject to privacy constraints, or where it is impractical, inefficient, or expensive to centralize data. In the context of wireless communication, for example, federated learning may be used to improve performance by allowing an ANN to be trained on data collected from a wide range of devices and environments. For example, an ANN may be trained on data collected from a large number of wireless devices in a network, such as distributed wireless communication nodes, smartphones, or internet-of-things (IoT) devices, to improve the network's performance and efficiency. With federated learning, a UE or other device may receive a copy of all or part of a global or shared model and perform local training on the local model using locally available training data. The UE may provide updated information regarding the locally trained model to one or more other devices (such as a network entity or a server), where the updates from other-like devices (such as other UEs) may be aggregated and used to provide an update to the global or shared model. A federated learning process may be repeated iteratively until all or part of a model obtains a satisfactory level of performance. Federated learning may enable devices to protect the privacy and security of local data, while supporting collaboration regarding training and updating of all or part of a shared model.

In some implementations, one or more devices or services may support processes relating to an ML model's usage, maintenance, activation, reporting, or the like. In certain instances, all or part of a dataset or model may be shared across multiple devices to provide or otherwise augment or improve processing. In some examples, signaling mechanisms may be utilized at various nodes of wireless networks to signal the capabilities for performing specific functions related to ML models, support for specific ML models, capabilities for gathering, creating, and transmitting training data, or other ML related capabilities. ML models in wireless communication systems may, for example, be employed to support decisions or improve performance relating to wireless resource allocation or selection, wireless channel condition estimation, interference mitigation, beam management, positioning accuracy, energy savings, or modulation or coding schemes, etc. In some implementations, model deployment may occur jointly or separately at various network levels, such as a UE, a network entity such as a base station, or a disaggregated network entity such as a central unit (CU), a distributed unit (DU), a radio unit (RU), or the like.

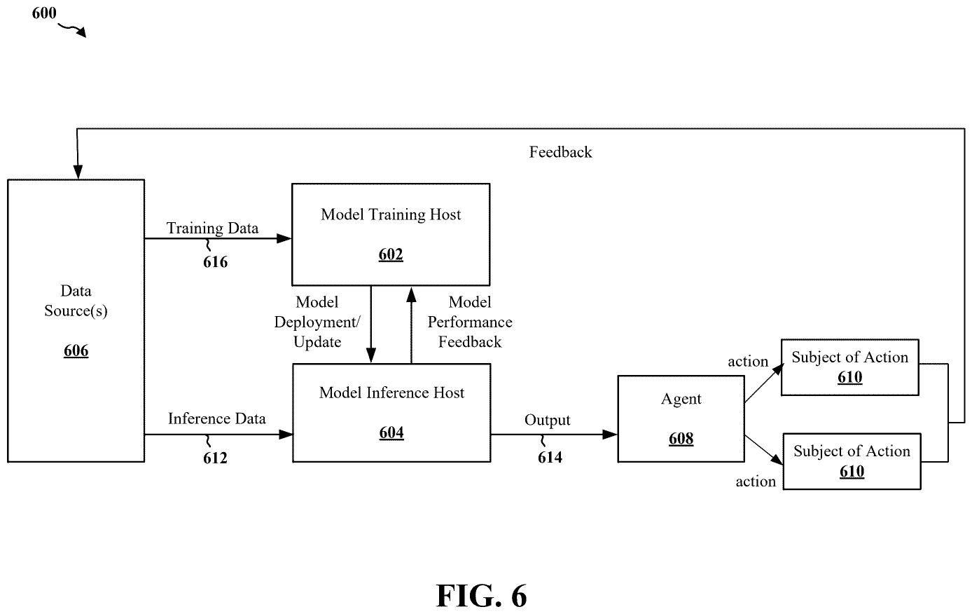

FIG. 6 is an illustrative block diagram of an example ML architecture 600 that may be used for wireless communications in any of the various implementations, processes, environments, networks, or use cases listed above. As illustrated, architecture 600 includes multiple logical entities, such as model training host 602, model inference host 604, data source(s) 606, and agent 608. Model inference host 604 is configured to run an ML model based on inference data 612 provided by data source(s) 606. Model inference host 604 may produce output 614, which may include a prediction or inference, such as a discrete or continuous value based on inference data 612, which may then be provided as input to the agent 608.

Agent 608 may represent an element or an entity of a wireless communication system including, for example, a radio access network (RAN), a wireless local area network, a device-to-device (D2D) communications system, etc. As an example, agent 608 may be a user equipment (such as UE 104, referring to FIG. 1, for example), a base station (such as base station 102, referring to FIG. 1, for example), or a disaggregated network entity (such as a CU 110, DU 130, or RU 140 in FIG. 1), an access point, a wireless station, a RAN intelligent controller (RIC) in a cloud-based RAN, among some examples. Additionally, agent 608 may also be a type of agent that depends on the type of tasks performed by model inference host 604, the type of inference data 612 provided to model inference host 604, or the type of output 614 produced by model inference host 604. As an example, the input may be information based on measurements performed on each cell in a cluster of cells, and the output may include a prediction related to RRM and/or mobility (e.g., RRM measurement predictions, measurement event prediction, RLF prediction, and HO/HOF prediction). A UE may then perform functions related to one or more of RRM or mobility based on the predictions related to RRM and/or mobility.

Agent 608 may perform one or more actions associated with receiving output 614 from model inference host 604, e.g., selection, use, and/or reporting regarding the predictions made related to RRM and/or mobility). Agent 608 may indicate the one or more actions performed to at least one subject of action 610. In some cases, agent 608 and the subject of action 610 are the same entity.

Data can be collected from data sources 606, and may be used as training data 616 for training an ML model, or as inference data 612 for feeding an ML model inference operation. Data sources 606 may collect data from various subject of action 610 entities (such as the UE or the network entity) and provide the collected data to a model training host 602 for ML model training. In some examples, if output 614 provided to agent 608 is inaccurate (or the accuracy is below an accuracy threshold), model training host 602 may provide feedback to model inference host 604 to modify or retrain the ML model used by model inference host 604, such as via an ML model deployment update.

Model training host 602 may be deployed at the same or a different entity than that in which model inference host 604 is deployed. For example, in order to offload model training processing, which can impact the performance of model inference host 604, model training host 602 may be deployed at a model server.

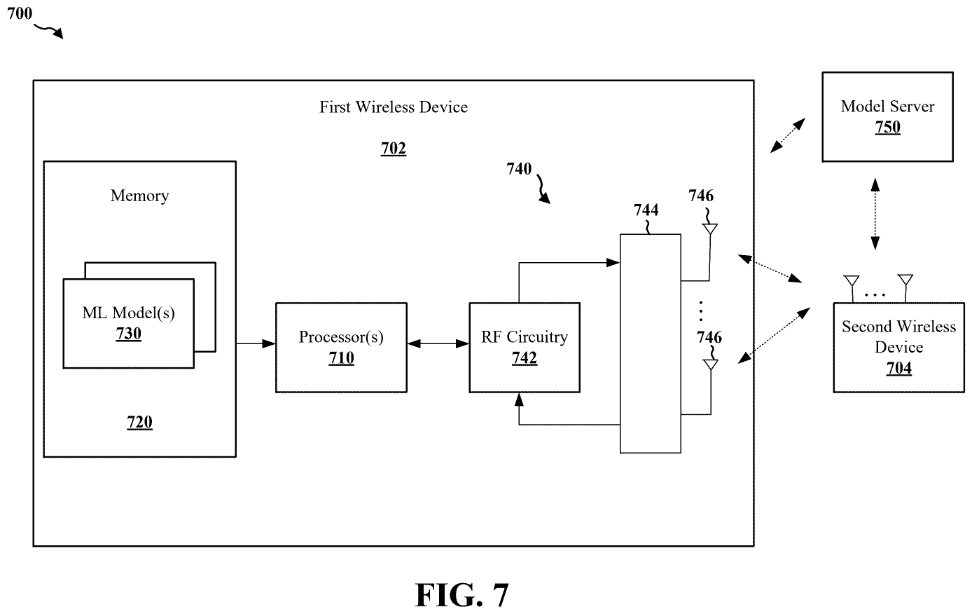

FIG. 7 is an illustrative block diagram 700 of an example ML architecture of first wireless device 702 in communication with second wireless device 704, in accordance with various aspects of the present disclosure. First wireless device 702 may be, or may include, a chip, system on chip (SoC), chipset, package or device that includes one or more processors, processing blocks or processing elements (collectively “processor 710”) and one or more memory blocks or elements (collectively “memory 720”). Processor 710 may be coupled to transceiver 740, which includes radio frequency (RF) circuitry 742 coupled to antennas 746 via interface 744, for transmitting or receiving signals.

One or more ML models 730 (collectively “ML model 730”) may be stored in memory 720 and accessible to processor(s) 710. Individual or groups of ML models 730 may be associated with respective model identifiers. In some aspects, different ML models 730, which may optionally be associated with different model identifiers, may have different characteristics. One or more ML models 730 may be selected based on respective features, characteristics, or applications, as well as characteristics or conditions of first wireless device 702 (such as, a power state, a mobility state, a battery reserve, a temperature, etc.). For example, ML models 730 may have different inference data and output pairings (such as, different types of inference data produce different types of output), different levels of accuracies associated with the predictions, different latencies associated with producing the predictions, different ML model sizes, different coefficients, different parameters, or the like.

Processor 710 may deploy ML models 730 to produce respective output data based on input data. For example, the ML models 730 may output predicted metric(s), such as predicted reference signal received power (RSRP) or other metrics associated with (RRM and/or mobility related) prediction target(s) based on measurements on the measurement resources. In some aspects, model server 750 may perform various ML management tasks for first wireless device 702 and/or second wireless device 704. For example, model server 750 may host various types and/or versions of ML models 730 for first wireless device 702 and/or second wireless device 704 to download. Model server 750 may monitor and evaluate the performance of ML model 730. Model server 750 may transmit signals or provide indications/instructions to activate or deactivate the use of a particular ML model at first wireless device 702 or second wireless device 704. Model server 750 may switch to a different ML model being used at first wireless device 702 or second wireless device 704, and model server 750 may provide such an instruction to the respective first wireless device 702 or second wireless device 704. Model server 750 may operate as a model training host (such as model training host 602) and update ML model 730 using training data. In some cases, the model server 750 may operate as a data source (such as data source 606) to collect and host training data, inference data, performance feedback, etc., associated with ML model 730.

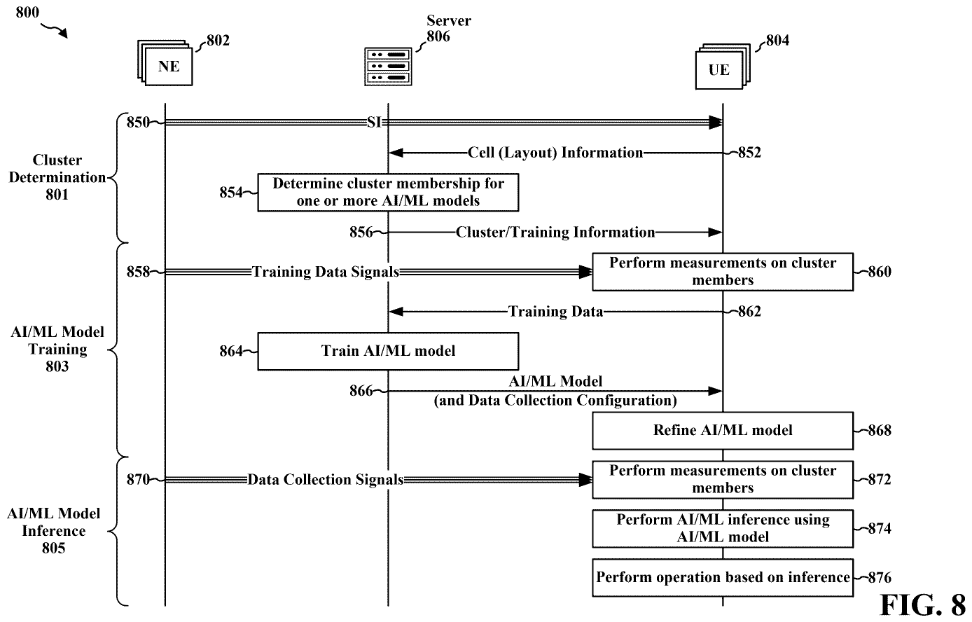

FIG. 8 is a call flow diagram 800 illustrating a method of wireless communication in accordance with some aspects of the disclosure. The method is illustrated in relation to a radio area network (e.g., an NG-RAN) including a set of network entities (NEs) 802 that may include one or more of (1) a set of base stations (e.g., as an example of a set of network devices or network nodes that may include one or more components of a disaggregated base station), (2) a network function, (3) a network-side server, or (4) an OAM entity. The set of NEs 802, may be in communication with a set of UEs 804 (e.g., as an example of one or more wireless devices associated with the RAN or NG-RAN). The description below may refer to an example NE or UE (e.g., in the singular) when describing actions taken by the set of NEs 802 or the set of UEs 804. The functions ascribed to the NEs 802 (or a NE in the set of NEs 802), in some aspects, may be performed by one or more components of a network entity, a network node, or a network device (a single network entity/node/device or a disaggregated network entity/node/device as described above in relation to FIG. 1). Similarly, the functions ascribed to the set of UEs 804 (or a UE in the set of UEs 804), in some aspects, may be performed by one or more components of a wireless device supporting communication with a network entity/node/device. Accordingly, references to “transmitting” in the description below may be understood to refer to a first component of the NE (or the UE) outputting (or providing) an indication of the content of the transmission to be transmitted by a different component of the NE (or the UE). Similarly, references to “receiving” in the description below may be understood to refer to a first component of the NE (or the UE) receiving a transmitted signal and outputting (or providing) the received signal (or information based on the received signal) to a different component of the NE (or the UE).

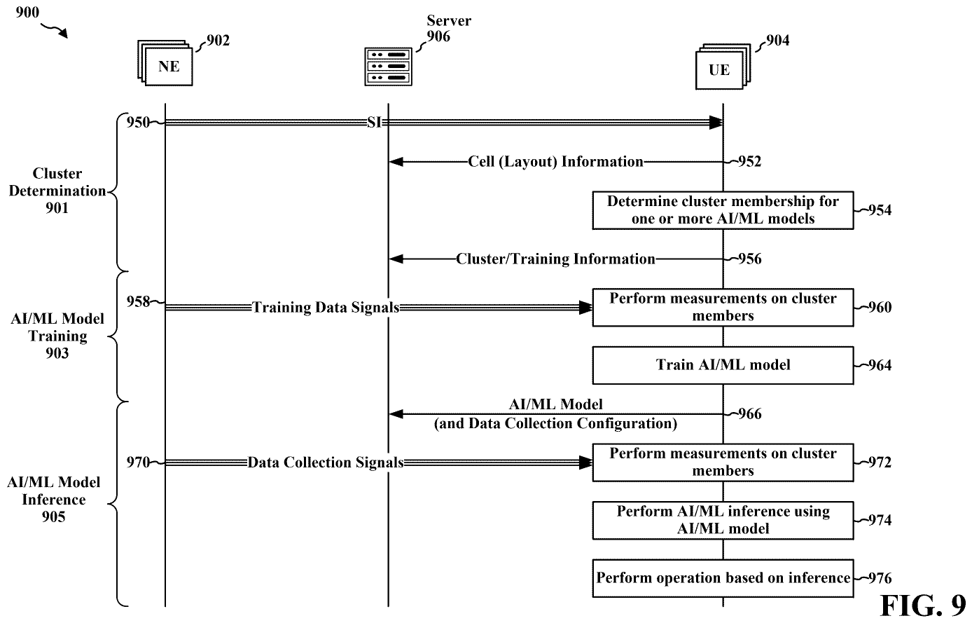

The call flow diagram 800 as illustrated includes a first set of operations associated with a determination of a cell cluster membership (e.g., cluster determination 801), a second set of operations associated with a training of an AI/ML model (e.g., AI/ML model training 803), and a third set of operations (e.g., AI/ML model inference 805) associated with using the AI/ML model to perform an inference, and perform one or more operations (e.g., a HO to a candidate cell) based on the inference (e.g., based on a predicted measurement event or RLF). In some aspects, performing the one or more operations may include refraining from performing one or more operations (e.g., not performing a HO to a candidate cell based on a predicted HOF). Similar corresponding sets of operations are illustrated in FIGS. 9-12 below and it is understood that, for example, a cluster determination (or AI/ML model training) illustrated in one call flow diagram may be replaced by a cluster determination (or AI/ML model training) illustrated in another call flow diagram in accordance with some aspects of the disclosure.

A UE (or each UE) in the set of UEs 804 may transmit, and the server 806 a UE capability indication. The UE capability indication may be received by the server 806. The UE capability indication may be an indication of support for performing a task associated with one or more AI/ML models for one or more cell clusters. For example, the UE may be capable of measuring a maximum number of cells, e.g., M cells, or a maximum number of carrier frequencies, e.g., N carrier frequencies, across a set of indicated and/or identified clusters or a maximum number of cells, e.g., X cells, or a maximum number of carrier frequencies, e.g., Y carrier frequencies, for each cluster up to a maximum number of clusters, e.g., Z clusters. In some aspects, the UE may be able to predict RRM measurement for a maximum number, K, of best cells, e.g., the top-K cells, or for a maximum number of frequencies, e.g., L predicted frequency measurements across a set of indicated and/or identified clusters. For example, if the UE uses one AI/ML model per cluster (e.g., to make one prediction or perform one inference per cluster), then the UE may be able to run a maximum number of clusters, e.g., L clusters. In some aspects, the indication of the support may be associated with one of a UE capability message, a UE assistance information message, or a radio resource control (RRC) message. The indication of the support, in some aspects, may include one or more of, a first indication of support for a first maximum number of measured cells for one of (i) each cell cluster in a plurality of identified cell clusters (e.g., a per-cluster maximum number of cells for measurement) or (ii) the plurality of identified cell clusters (e.g., across a set of one or more cell clusters identified for the UE), a second indication of support for a second maximum number of measured carrier frequencies for one of (i) each cell cluster in the plurality of identified cell clusters or (ii) the plurality of identified cell clusters; or a third indication of support for a third maximum number of predictions for one of (i) each cell cluster in the plurality of identified cell clusters or (ii) the plurality of identified cell clusters.

A UE (or each UE) in the set of UEs 804, may receive, and one or more NEs (e.g., base stations) in the set of NEs 802 may transmit, SI 850. While referred to as SI, the SI 850 may not be transmitted in a SIB and may be a dedicated transmission of neighboring cell information. In some aspects, the SI 850 may include transmissions from one or more serving cells and/or neighboring cells including information about the one or more serving cells and/or neighboring cells. The information may include information regarding physical properties of the one or more serving cells and/or neighboring cells (e.g., location, height, and/or orientation information for a serving cell and one or more neighboring base stations or cells). The information may be provided as ‘objective’ information based on a reference frame, or may be pairwise information relating each neighboring cell to the serving cell. In some aspects, the information regarding the physical properties of the one or more serving cells and/or neighboring cells may be referred to as layout information, network layout information, or network characteristic information. In some aspects, the SI 850 may be received by the UE from a serving cell of the UE and include information regarding a plurality of cells (e.g., the serving cell and the one or more neighboring cells) associated with the set of NEs 802. The layout information, in some aspects, may be generated and/or compiled by the UE based on receiving SI 850 from the serving cell and the one or more neighboring cells in the set of NEs 802.

The UEs in the set of UEs 804, in some aspects, may transmit, and a server 806 associated with the set of UEs 804 may receive, cell layout information 852 based on the SI 850 received by the set of UEs 804. As discussed above in relation to the SI 850, the cell layout information 852 may include information regarding the physical properties, or characteristics, of the one or more serving cells and/or neighboring cells. The information 852, in some aspects, may include the information received in SI 850, changes from previously transmitted cell layout information, or information (cell layout information) compiled and/or generated at the UEs in the set of UEs 804 based on the SI 850. The server 806 may receive the cell layout information from UEs in the set of UEs 804 served by different cells and associated with different locations and may, therefore have more complete information regarding the physical properties of the network entities (e.g., cells, base stations, beams, etc.) than any individual UE associated with the server 806.

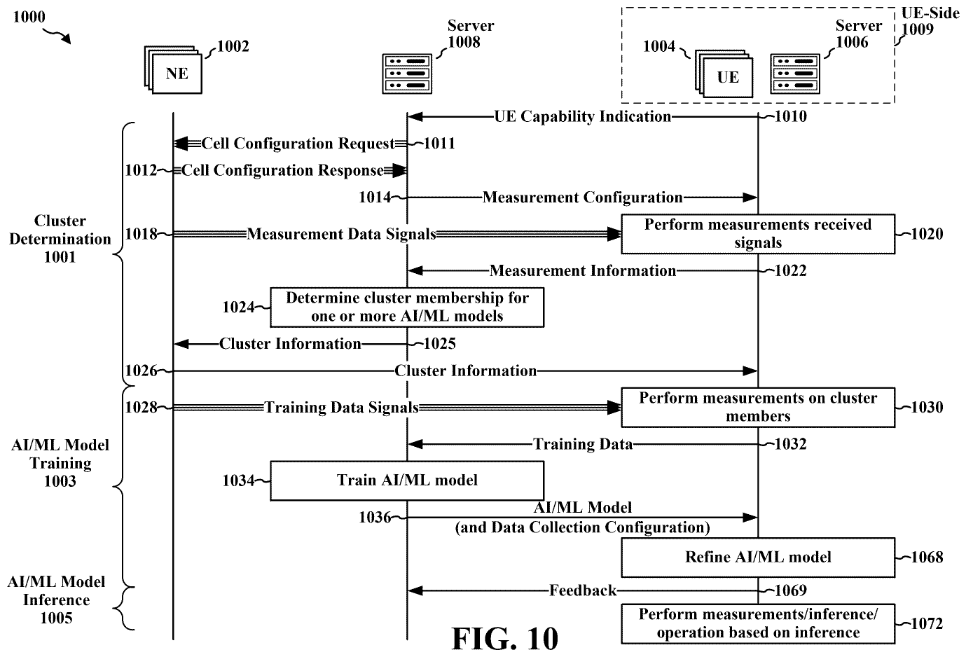

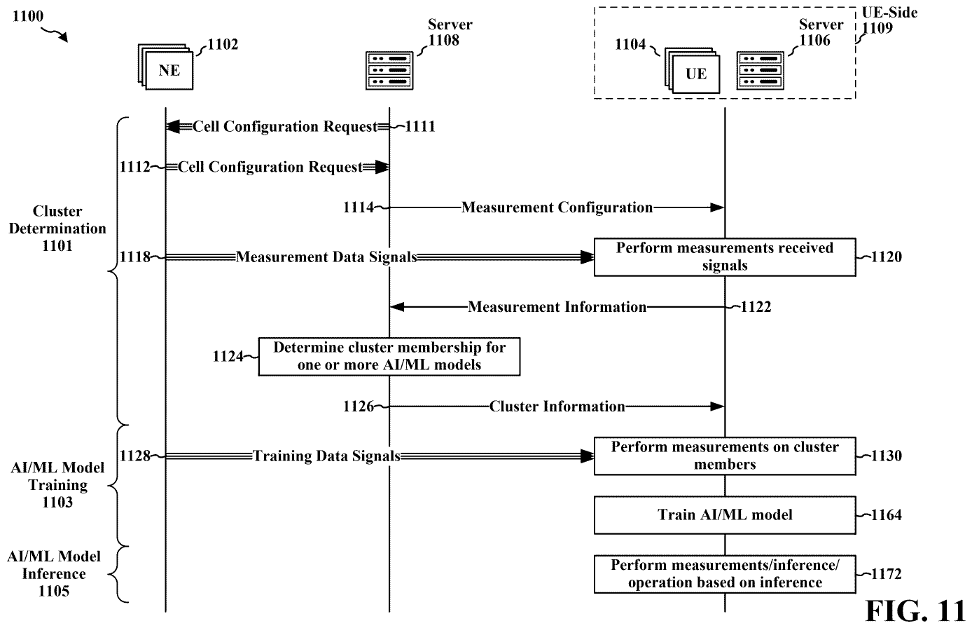

In some aspects, as discussed below in relation to FIGS. 10 and 11, the server 806 may transmit (or cause to be transmitted, e.g., by a serving cell in the set of NEs 802), and a UE (or each UE) in the set of UEs 804, may receive a measurement configuration. The measurement configuration, in some aspects, may indicate a set of cells (e.g., one or more cells associated with the set of NEs 802) and/or a set of measurements to perform on, or for, the set of cells. The measurement configuration, in some aspects, may configure the UE to report (e.g., directly via a non-access stratum (NAS) or a user-plane (UP) or indirectly via a base station or serving cell in the set of NEs 802) measurements (e.g., a signal to interference and noise ratio (SINR), a reference signal received power (RSRP), a RS received quality (RSRQ), etc.) regarding received signals or information associated with sensors, positioning, or other data available at the UE.

The NEs in the set of NEs 802, in some aspects, may transmit measurement data signals. The set of measurement data signals, in some aspects, may include one or more of reference signals, data transmissions, or other transmissions that may be measured by a UE in the set of UEs 804. Based on the measurement configuration, a UE in the set of UEs 804 may perform one or more measurements on the measurement data signals (e.g., may collect, based on the measurement data signals, data associated with one or more cells of a plurality of cells associated with the set of NEs 802). In some aspects, the measurements may be performed on a subset of the measurement data signals, e.g., the transmissions from a subset of the plurality of cells that are measurable by the UE and/or particular transmissions (e.g., one or more of RS, SSB, data, etc.).

The UE in the set of UEs 804, may transmit, and the server 806 may receive, measurement information. The measurement information, in some aspects, may be raw measurement data based on the measurements performed on the measurement data signals (e.g., the data associated with the one or more cells of the plurality of cells collected by the UE). In some aspects, the measurement information, may be summarized or processed by the UE before being transmitted to the server 806, where the processing may be indicated in the measurement configuration (e.g., in a reporting configuration associated with the measurement information, the measurement configuration, or the measurement data collection configuration).

Based on the cell layout information 852, the server 806 may determine, at 854, one or more cluster memberships for one or more AI/ML models and/or tasks (e.g., prediction objectives) associated with the AI/ML models. For example, in some aspects, the server 806 (e.g., a UE-side network entity) may determine the membership of the cell clusters based on the cell layout information 852 (e.g., complete/objective or pairwise layout information that may include IDs and/or explicit information for the one or more serving cells and neighboring cells) received by the server 806 (e.g., based on the SI 850 received by the set of UEs 804). Where different physical properties (e.g., height, beam configurations, etc.) of the neighboring cells impact AI/ML prediction accuracy, the cell layout information 852 may include information regarding the physical properties known to impact the AI/ML prediction accuracy.

In a geographical area, for example, clusters may be determined based on one or more of, (1) geographical proximity and/or a neighboring cell list, (2) a physical configuration and/or environment, and/or (3) a related task (e.g., a particular prediction such as a measurement prediction, a measurement event prediction, a RLF failure prediction, etc.). In some aspects, the physical properties (e.g., configuration, characteristics, and/or environment) may include a transmission power, one or more beam configurations (e.g., codebook, antenna patters, beam width, etc.), height, being indoors, being outdoors, deployment purpose, carrier frequency/frequencies, infra-vendor information, or other physical characteristics that may affect the accuracy of an associated AI/ML model for prediction. For example, in some aspects, a cell cluster for data collection and/or predictions may include base stations transmitting at the same power, and having the same beam configurations, or may include base stations for a HST environment.

The one or more cluster memberships determined for the one or more AI/ML models and/or tasks (e.g., functions, features, and/or feature groups) may include a cluster membership for a first cluster associated with multiple AI/ML models and/or tasks and/or different cluster memberships for each of a plurality of different clusters associated with a corresponding plurality of AI/ML models and/or tasks. For example, a first cell cluster determined for, and/or associated with, handover failure event predictions may not include the same cells as a second cell cluster determined for, and/or associated with, measurement event predictions.

In some aspects, the cluster membership for AI/ML models associated with a same task (or prediction objective) may be different for different locations of a UE (e.g., in different regions). A first cell cluster membership at a first location (e.g., at a northern cell edge) for a first cell cluster determined for, and/or associated with, RRM predictions, in some aspects, may be different from a second cell cluster membership for a second cell cluster determined for, and/or associated with, RRM predictions at a second location (e.g., not at a cell edge (NACE) or at a southern cell edge). For example, referring to FIG. 4, the membership of the fourth cluster 440 associated with the measurement event prediction may be based on the location of the UE 404 and may include one or more of the base stations 402, 406 (e.g., base station 406C, 406E, 406F, and 406H) that are within a certain distance from the UE 404, where the cluster membership may further be based on additional physical properties of the base stations and may not include all the candidates within the threshold distance. In some aspects, the cluster membership of the cluster associated with the measurement event prediction (e.g., illustrated as the fourth cluster 440) may change as the UE 404 changes location and the distance threshold includes and/or excludes different base stations. In some aspects, a particular cell may belong to one or more cell clusters associated with different tasks and/or purposes (e.g., identified for, and/or used by, a particular UE for different tasks and/or purposes), or for UEs in different locations and/or regions.

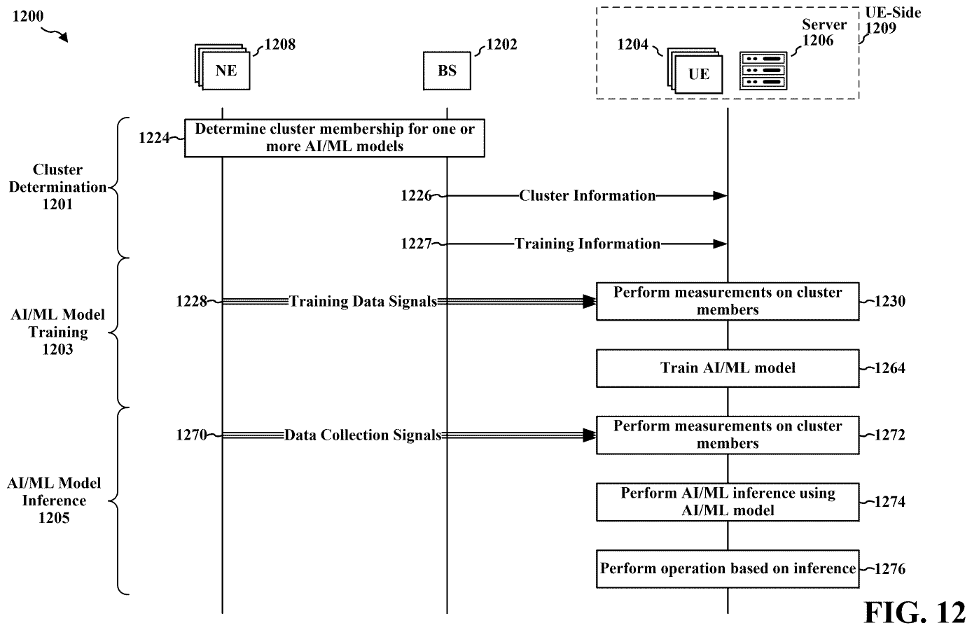

Based on the determination at 854, the server 806 may transmit, and a UE in the set of UEs 804 may receive, cluster information 856. In some aspects, cluster information 856 may include information identifying one or more cell clusters determined at 854. The information identifying a cell cluster, in some aspects, may be associated with one or more of an identifier of the cell cluster (e.g., a cluster ID); a home public land mobile network (HPLMN) identifier; information regarding one or more AI/ML enabled tasks, features, feature groups, or functions associated with the cell cluster; or information regarding an area scope associated with the cell cluster. The area scope of a particular cell cluster, in some aspects, may include one or more of an identification of the specific cell(s) in the particular cell cluster and parameters and/or characteristics (e.g., frequencies, beam directions, quantities to be measured, etc.) associated with one or more measurements associated with the specific cell(s) in the cell cluster. The information regarding the area scope associated with the cell cluster, in some aspects, may include one or more of a PCI, cell IDs, frequency information. In some aspects, the cluster information 856 may include training information, a training configuration, or a data collection configuration indicating the type of measurements to perform and/or data to collect (and/or report) for training at least one AI/ML model associated with the identified cluster. The cluster information 856 (or the training information) may include at least one threshold for at least one corresponding key performance indicator (KPI) associated with an AI/ML model associated with an identified cell cluster. In some aspects, a single cluster may be associated with different tasks and/or prediction objectives and the training information may include different indications of different types of measurements to perform and/or data to collect for the different tasks and/or prediction objectives. While in FIG. 8 (and FIGS. 9-11 discussed below), the cluster information is illustrated without a separate transmission of training configuration to conserve space, in some aspects, the training information/configuration may be transmitted separately from the cluster information 856 (e.g., in FIG. 12 below, cluster information 1226 may be transmitted separately from training information 1227).

The cluster memberships for the different clusters determined at 854, in some aspects, may be stored at the server 806 for providing the cluster information to UEs for which the cluster information becomes relevant. For example, one or more stored cluster memberships determined and/or identified for a particular region (and one or more prediction objectives) may be provided to a UE entering the region. In some aspects, the cluster determination 801 may be considered complete (for the purposes of this discussion) and the AI/ML model training 803 may begin at this point. The cluster determination 801, in some aspects, may be performed periodically, as new cell layout information is received, and/or when changes to one or more characteristics included in the cell layout information 852 are detected (e.g., when, for a particular characteristic, a reported value changes more than an associated threshold from a previously reported value).

The NEs in the set of NEs 802, in some aspects, may transmit training data signals 858. The set of training data signals 858, in some aspects, may include one or more of reference signals, data transmissions, or other transmissions that may be measured by a UE in the set of UEs 804. Based on the cluster information 856 (e.g., the training information/configuration or data collection configuration), a UE in the set of UEs 804 may, at 860, perform one or more measurements on the training data signals 858 (e.g., may collect, based on the data collection configuration, data associated with one or more cells of a cell cluster identified in the cluster information 856). In some aspects, the measurements may be performed on a subset of the training data signals 858, e.g., the transmissions from the cells identified as belonging to the one or more clusters indicated in the cluster information 856 and/or particular transmissions (e.g., one or more of RS, SSB, data, etc.).

The UE in the set of UEs 804, may transmit, and the server 806 may receive, training data 862. The training data 862, in some aspects, may be raw measurement data based on the measurements performed at 860 on the training data signals 858 (e.g., the data associated with the one or more cells of the cell cluster collected by the UE). In some aspects, the training data 862, may be summarized or processed by the UE before being transmitted to the server 806, where the processing may be indicated in the cluster information 856 (e.g., in a reporting configuration associated with the training information, the training configuration, or the data collection configuration). At 864, the server 806 may train one or more AI/ML models for the one or more cell clusters based on the training data 862. In some aspects, the AI/ML model training may identify one or more cluster members for which training data does not improve the accuracy of a prediction by the AI/ML model and the cluster membership determined at 854 may be adjusted. The cluster membership, in some aspects, may not be updated and the data associated with the redundant and/or irrelevant cluster member may be ignored (e.g., not included in the input to the AI/ML model, or be associated with zero, or near-zero, weights, in the trained AI/ML model) while maintaining the same cluster membership. The training of the AI/ML may be associated with the aspects described in relation to at least FIGS. 5 and 6. In some aspects, the server 806 may store the trained AI/ML models for one or more of additional training (e.g., refinement) as additional training data is received and/or for subsequent provision to additional UEs. For example, the server 806 may provide a trained and stored AI/ML model for a particular region and a particular prediction objective to UEs entering the particular region and associated with the particular prediction objective.

After training the one or more AI/ML models for the one or more cell clusters, the server 806 may provide a trained AI/ML model 866 to the UE in the set of UEs 804. The trained AI/ML model, in some aspects, may include a measurement configuration, or data collection configuration, indicating the measurements associated with inputs to the AI/ML model and/or preprocessing associated with the AI/ML model. As discussed above, if the AI/ML training leads to an adjusted cluster membership, providing the AI/ML model 866 may include providing an indication of the adjusted cluster membership (e.g., an indication of one or more cells to add or remove a cell from the cell cluster and/or to begin, or refrain from, measuring). The measurement configuration (and the signals to be measured and/or the data to be collected for the inference), in some aspects, may be different from the training information, the training configuration, and/or the data collection configuration (and the signals to be measured and/or the data to be collected for training). In some aspects, the measurement configuration may be transmitted in a separate transmission/message associated with the trained AI/ML model 866. In some aspects, the UE may, at 868, refine the AI/ML model based on local data not available (e.g., not transmitted) to the server 806. In some aspects, the AI/ML model training 803 may be considered complete (for the purposes of this discussion) and the AI/ML model inference 805 may begin at this point. The AI/ML model training 803, and specifically the AI/ML model refinement at 868, in some aspects, may be performed periodically, as new cell layout or cluster membership information is received, new training and/or measurement data is collected, and/or when a prediction accuracy falls below a threshold.

The cells in the cell cluster associated with the AI/ML model 866, may transmit one or more data collection signals 870. The one or more data collection signals 870, in some aspects, may include one or more of reference signals, data transmissions, or other transmissions that may be measured by a UE in the set of UEs 804. Based on the AI/ML model 866 (e.g., the measurement configuration), a UE in the set of UEs 804 may, at 872, perform one or more measurements on the data collection signals 870 (e.g., may collect, based on the measurement configuration, data associated with one or more cells of a cell cluster identified in the cluster information 856 and/or associated with the AI/ML model 866). In some aspects, the measurements may be performed on a subset of the data collection signals 870, e.g., the transmissions from the cells identified as belonging to the one or more clusters indicated in the cluster information 856 (or associated with the AI/ML model 866) and/or particular transmissions (e.g., one or more of RS, SSB, data, etc.).

Based on the measurements performed at 872, the UE in the set of UEs 804 may, at 874, perform an AI/ML inference using the AI/ML model. For example, the UE may generate, based on the measurement data, a prediction for one or more AI/ML enabled features, feature groups, or functions associated with the cell cluster using the AI/ML model. In some aspects, the UE may, at 876, perform an operation based on the inference (e.g., the prediction) performed at 874.

FIG. 9 is a call flow diagram 900 illustrating a method of wireless communication in accordance with some aspects of the disclosure. The method is illustrated in relation to a radio area network (e.g., an NG-RAN) including a set of network entities (NEs) 902 that may include one or more of (1) a set of base stations (e.g., as an example of a set of network devices or network nodes that may include one or more components of a disaggregated base station), (2) a network function, (3) a network-side server, or (4) an OAM entity. The set of NEs 902, may be in communication with a set of UEs 904 (e.g., as an example of one or more wireless devices associated with the RAN or NG-RAN). The description below may refer to an example NE or UE (e.g., in the singular) when describing actions taken by the set of NEs 902 or the set of UEs 904. The functions ascribed to the NEs 902 (or a NE in the set of NEs 902), in some aspects, may be performed by one or more components of a network entity, a network node, or a network device (a single network entity/node/device or a disaggregated network entity/node/device as described above in relation to FIG. 1). Similarly, the functions ascribed to the set of UEs 904 (or a UE in the set of UEs 904), in some aspects, may be performed by one or more components of a wireless device supporting communication with a network entity/node/device. Accordingly, references to “transmitting” in the description below may be understood to refer to a first component of the NE (or the UE) outputting (or providing) an indication of the content of the transmission to be transmitted by a different component of the NE (or the UE). Similarly, references to “receiving” in the description below may be understood to refer to a first component of the NE (or the UE) receiving a transmitted signal and outputting (or providing) the received signal (or information based on the received signal) to a different component of the NE (or the UE).

The call flow diagram 900 as illustrated includes a first set of operations associated with a determination of a cell cluster membership (e.g., cluster determination 901), a second set of operations associated with a training of an AI/ML model (e.g., AI/ML model training 903), and a third set of operations (e.g., AI/ML model inference 905) associated with using the AI/ML model to perform an inference, and perform one or more operations (e.g., a HO to a candidate cell) based on the inference (e.g., based on a predicted measurement event or RLF). In some aspects, performing the one or more operations may include refraining from performing one or more operations (e.g., not performing a HO to a candidate cell based on a predicted HOF). Similar corresponding sets of operations are illustrated in FIGS. 8 and 10-12 and it is understood that, for example, a cluster determination (or AI/ML model training) illustrated in one call flow diagram may be replaced by a cluster determination (or AI/ML model training) illustrated in another call flow diagram in accordance with some aspects of the disclosure.

A UE (or each UE) in the set of UEs 904 may transmit, and the server 906 may receive, a UE capability indication. The UE capability indication may be received by the server 906. The UE capability indication may be an indication of support for performing a task associated with one or more AI/ML models for one or more cell clusters. For example, the UE may be capable of measuring a maximum number of cells, e.g., M cells, or a maximum number of carrier frequencies, e.g., N carrier frequencies, across a set of indicated and/or identified clusters or a maximum number of cells, e.g., X cells, or a maximum number of carrier frequencies, e.g., Y carrier frequencies, for each cluster up to a maximum number of clusters, e.g., Z clusters. In some aspects, the UE may be able to predict RRM measurement for a maximum number, K, of best cells, e.g., the top-K cells, or for a maximum number of frequencies, e.g., L predicted frequency measurements across a set of indicated and/or identified clusters. For example, if the UE uses one AI/ML model per cluster (e.g., to make one prediction or perform one inference per cluster), then the UE may be able to run a maximum number of clusters, e.g., L clusters. In some aspects, the indication of the support may be associated with one of a UE capability message, a UE assistance information message, or a radio resource control (RRC) message. The indication of the support, in some aspects, may include one or more of, a first indication of support for a first maximum number of measured cells for one of (i) each cell cluster in a plurality of identified cell clusters (e.g., a per-cluster maximum number of cells for measurement) or (ii) the plurality of identified cell clusters (e.g., across a set of one or more cell clusters identified for the UE), a second indication of support for a second maximum number of measured carrier frequencies for one of (i) each cell cluster in the plurality of identified cell clusters or (ii) the plurality of identified cell clusters; or a third indication of support for a third maximum number of predictions for one of (i) each cell cluster in the plurality of identified cell clusters or (ii) the plurality of identified cell clusters.

A UE (or each UE) in the set of UEs 904, may receive, and one or more NEs (e.g., base stations) in the set of NEs 902 may transmit, SI 950. While referred to as SI, the SI 950 may not be transmitted in a SIB and may be a dedicated transmission of neighboring cell information. In some aspects, the SI 950 may include transmissions from one or more serving cells and/or neighboring cells including information about the one or more serving cells and/or neighboring cells. The information may include information regarding physical properties of the one or more serving cells and/or neighboring cells (e.g., location, height, and/or orientation information for a serving cell and one or more neighboring base stations or cells). The information may be provided as ‘objective’ information based on a reference frame, or may be pairwise information relating each neighboring cell to the serving cell. In some aspects, the information regarding the physical properties of the one or more serving cells and/or neighboring cells may be referred to as layout information, network layout information, or network characteristic information. In some aspects, the SI 950 may be received by the UE from a serving cell of the UE and include information regarding a plurality of cells (e.g., the serving cell and the one or more neighboring cells) associated with the set of NEs 902. The layout information, in some aspects, may be generated and/or compiled by the UE based on receiving SI 950 from the serving cell and the one or more neighboring cells in the set of NEs 902.

The UEs in the set of UEs 904, in some aspects, may transmit, and a server 906 associated with the set of UEs 904 may receive, cell layout information 952 based on the SI 950 received by the set of UEs 904. As discussed above in relation to the SI 950, the cell layout information 952 may include information regarding the physical properties, or characteristics, of the one or more serving cells and/or neighboring cells. The information 952, in some aspects, may include the information received in SI 950, changes from previously transmitted cell layout information, or information (cell layout information) compiled and/or generated at the UEs in the set of UEs 904 based on the SI 950. The server 906 may receive the cell layout information from UEs in the set of UEs 904 served by different cells and associated with different locations and may, therefore have more complete information regarding the physical properties of the network entities (e.g., cells, base stations, beams, etc.) than any individual UE associated with the server 906.

In some aspects, as discussed below in relation to FIGS. 10 and 11, the server 906 may transmit (or cause to be transmitted, e.g., by a serving cell in the set of NEs 902), and a UE (or each UE) in the set of UEs 904, may receive a measurement configuration. The measurement configuration, in some aspects, may indicate a set of cells (e.g., one or more cells associated with the set of NEs 902) and/or a set of measurements to perform on, or for, the set of cells. The measurement configuration, in some aspects, may configure the UE to report (e.g., directly via a NAS or a UP or indirectly via a base station or serving cell in the set of NEs 902) measurements (e.g., a SINR, a RSRP, a RSRQ, etc.) regarding received signals or information associated with sensors, positioning, or other data available at the UE.

The NEs in the set of NEs 902, in some aspects, may transmit measurement data signals. The set of measurement data signals, in some aspects, may include one or more of reference signals, data transmissions, or other transmissions that may be measured by a UE in the set of UEs 904. Based on the measurement configuration, a UE in the set of UEs 904 may perform one or more measurements on the measurement data signals (e.g., may collect, based on the measurement data signals, data associated with one or more cells of a plurality of cells associated with the set of NEs 902). In some aspects, the measurements may be performed on a subset of the measurement data signals, e.g., the transmissions from a subset of the plurality of cells that are measurable by the UE and/or particular transmissions (e.g., one or more of RS, SSB, data, etc.).

The UE in the set of UEs 904, may transmit, and the server 906 may receive, measurement information. The measurement information, in some aspects, may be raw measurement data based on the measurements performed on the measurement data signals (e.g., the data associated with the one or more cells of the plurality of cells collected by the UE). In some aspects, the measurement information, may be summarized or processed by the UE before being transmitted to the server 906, where the processing may be indicated in the measurement configuration (e.g., in a reporting configuration associated with the measurement information, the measurement configuration, or the measurement data collection configuration).

Based on the SI 950 (and the measurement information), a UE in the set of UEs 904 may determine, at 954, one or more cluster memberships for one or more AI/ML models and/or tasks (e.g., prediction objectives) associated with the AI/ML models. For example, in some aspects, the UE in the set of UEs 904 may determine the membership of the cell clusters based on the SI 950 (e.g., complete/objective or pairwise layout information that may include IDs and/or explicit information for the one or more serving cells and neighboring cells) received by the UE in the set of UEs 904. Where different physical properties (e.g., height, beam configurations, etc.) of the neighboring cells impact AI/ML prediction accuracy, the SI 950 may include information regarding the physical properties known to impact the AI/ML prediction accuracy.

In a geographical area, for example, clusters may be determined based on one or more of, (1) geographical proximity and/or a neighboring cell list, (2) a physical configuration and/or environment, and/or (3) a related task (e.g., a particular prediction such as a measurement prediction, a measurement event prediction, a RLF failure prediction, etc.). In some aspects, the physical properties (e.g., configuration, characteristics, and/or environment) may include a transmission power, one or more beam configurations (e.g., codebook, antenna patters, beam width, etc.), height, being indoors, being outdoors, deployment purpose, carrier frequency/frequencies, infra-vendor information, or other physical characteristics that may affect the accuracy of an associated AI/ML model for prediction. For example, in some aspects, a cell cluster for data collection and/or predictions may include base stations transmitting at the same power, and having the same beam configurations, or may include base stations for a HST environment.

The one or more cluster memberships determined for the one or more AI/ML models and/or tasks may include a cluster membership for a first cluster associated with multiple AI/ML models and/or tasks and/or different cluster memberships for each of a plurality of different clusters associated with a corresponding plurality of AI/ML models and/or tasks. For example, a first cell cluster determined for, and/or associated with, RRM predictions may not include the same cells as a second cell cluster determined for, and/or associated with, measurement event predictions.

In some aspects, the cluster membership for AI/ML models associated with a same task (or prediction objective) may be different for different locations of a UE (e.g., in different regions). A first cell cluster membership at a first location (e.g., at a northern cell edge) for a first cell cluster determined for, and/or associated with, RRM predictions, in some aspects, may be different from a second cell cluster membership for a second cell cluster determined for, and/or associated with, RRM predictions at a second location (e.g., not at a cell edge (NACE) or at a southern cell edge). For example, referring to FIG. 4, the membership of the fourth cluster 440 associated with the measurement event prediction may be based on the location of the UE 404 and may include one or more of the base stations 402, 406C, 406E, 406F, and 406H that are within a certain distance from the UE 404, where the cluster membership may further be based on additional physical properties of the base stations and may not include all the candidates within the threshold distance. In some aspects, the cluster membership of the cluster associated with the measurement event prediction (e.g., illustrated as the fourth cluster 440) may change as the UE 404 changes location and the distance threshold includes and/or excludes different base stations. In some aspects, a particular cell may belong to one or more cell clusters associated with different tasks and/or purposes (e.g., identified for, and/or used by, a particular UE for different tasks and/or purposes), or for UEs in different locations and/or regions.

Based on the determination at 954, the UE in the set of UEs 904 may transmit, and the server 906 may receive, cluster information 956. In some aspects, cluster information 956 may include information identifying one or more cell clusters determined at 954. The information identifying a cell cluster, in some aspects, may be associated with one or more of an identifier of the cell cluster (e.g., a cluster ID); a HPLMN identifier; information regarding one or more AI/ML enabled features, feature groups, or functions associated with the cell cluster; or information regarding an area scope associated with the cell cluster. The information regarding the area scope associated with the cell cluster, in some aspects, may include one or more of a PCI, cell IDs, frequency information. In some aspects, the cluster information 956 may include training information, a training configuration, or a data collection configuration indicating the type of measurements to perform and/or data to collect (and/or report) for training at least one AI/ML model associated with the identified cluster. In some aspects, a single cluster may be associated with different tasks and/or prediction objectives and the training information may include different indications of different types of measurements to perform and/or data to collect for the different tasks and/or prediction objectives.

The cluster memberships for the different clusters determined at 954, in some aspects, may be transmitted to, and/or stored at, the server 906 for providing the cluster information to UEs for which the cluster information becomes relevant. For example, one or more stored cluster memberships determined and/or identified for a particular region (and one or more prediction objectives) may be provided to a UE entering the region. In some aspects, the cluster determination 901 may be considered complete (for the purposes of this discussion) and the AI/ML model training 903 may begin at this point. The cluster determination 901, in some aspects, may be performed periodically, as new cell layout information is received, and/or when changes to one or more characteristics included in the cell layout information 952 are detected (e.g., when, for a particular characteristic, a reported value changes more than an associated threshold from a previously reported value).

The NEs in the set of NEs 902, in some aspects, may transmit training data signals 958. The set of training data signals 958, in some aspects, may include one or more of reference signals, data transmissions, or other transmissions that may be measured by a UE in the set of UEs 904. Based on the cluster information 956 (e.g., the training information/configuration or data collection configuration), a UE in the set of UEs 904 may, at 960, perform one or more measurements on the training data signals 958 (e.g., may collect, based on the data collection configuration, data associated with one or more cells of a cell cluster identified in the cluster information 956). In some aspects, the measurements may be performed on a subset of the training data signals 958, e.g., the transmissions from the cells identified as belonging to the one or more clusters indicated in the cluster information 956 and/or particular transmissions (e.g., one or more of RS, SSB, data, etc.).

At 964, the UE in the set of UEs 904 may train one or more AI/ML models for the one or more cell clusters based on the one or more measurements on the training data signals 958 (e.g., the data collected based on the data collection configuration and/or data associated with one or more cells of a cell cluster identified by the UE in the set of UEs 904). In some aspects, the AI/ML model training may identify one or more cluster members for which training data does not improve the accuracy of a prediction by the AI/ML model and the cluster membership determined at 954 may be adjusted. The cluster membership, in some aspects, may not be updated and the data associated with the redundant and/or irrelevant cluster member may be ignored (e.g., not included in the input to the AI/ML model, or be associated with zero, or near-zero, weights, in the trained AI/ML model) while maintaining the same cluster membership. The training of the AI/ML may be associated with the aspects described in relation to at least FIGS. 5 and 6. In some aspects, the UE in the set of UEs 904 may store (and/or may, as described below, provide the trained AI/ML model to the server 906 which may store) the trained AI/ML models for one or more of additional training (e.g., refinement) as additional training data is received and/or for subsequent provision to additional UEs. For example, the UE in the set of UEs 904 and/or the server 906 may provide a trained and stored AI/ML model for a particular region and a particular prediction objective to UEs entering the particular region and associated with the particular prediction objective.

After training the one or more AI/ML models for the one or more cell clusters, the UE in the set of UEs 904 may provide server 906 with a trained AI/ML model 966 and may implement the trained AI/ML model 966 locally, (e.g., at the UE in the set of UEs 904). The trained AI/ML model, in some aspects, may be associated with a measurement configuration indicating the measurements associated with inputs to the AI/ML model and/or preprocessing associated with the AI/ML model. The measurement configuration (and the signals to be measured and/or the data to be collected for the inference), in some aspects, may be different from the training information, the training configuration, and/or the data collection configuration (and the signals to be measured and/or the data to be collected for training). In some aspects, the measurement configuration may be provided to the server 906 in one of a single transmission/message along with the trained AI/ML model 966 or in a separate transmission/message associated with the trained AI/ML model 966. In some aspects, the UE may refine the AI/ML model as additional information and/or data is collected (as described in relation to refining the AI/ML model at 868 of FIG. 8). In some aspects, the AI/ML model training 903 may be considered complete (for the purposes of this discussion) and the AI/ML model inference 905 may begin at this point. The AI/ML model training 903, and specifically the AI/ML model refinement, in some aspects, may be performed periodically, as new cell layout or cluster membership information is received, new training and/or measurement data is collected, and/or when a prediction accuracy falls below a threshold.

While FIGS. 8 and 9 assume a same entity performs both the cluster determination (e.g., 801/901) and the AI/ML model training (e.g., 803/903), in some aspects, the cluster determination may be performed by one of the server or the UE and the AI/ML model training may be performed by the other of the server or the UE (e.g., the cluster determination 801 may be followed by the AI/ML model training 903, or the cluster determination 901 may be followed by the AI/ML model training 803). If, for example, the cluster determination 901 is followed by the AI/ML model training 803, the cluster information 956 may indicate the cluster membership, and based on the cluster membership of an identified cluster, the server may transmit, and the UE may receive, training information as described in relation to cluster information 856. In some aspects, the server may store information regarding any of the clusters or trained AI/ML models (e.g., including an associated training configuration for AI/ML model training and/or a measurement configuration for an AI/ML model inference).

The cells in the cell cluster associated with the AI/ML model 966, may transmit one or more data collection signals 970. The one or more data collection signals 970, in some aspects, may include one or more of reference signals, data transmissions, or other transmissions that may be measured by a UE in the set of UEs 904. Based on the AI/ML model (e.g., the measurement configuration), a UE in the set of UEs 904 may, at 972, perform one or more measurements on the data collection signals 970 (e.g., may collect, based on the measurement configuration, data associated with one or more cells of an identified cell cluster and/or associated with the trained AI/ML model). In some aspects, the measurements may be performed on a subset of the data collection signals 970, e.g., the transmissions from the cells identified as belonging to the one or more clusters (or associated with the trained AI/ML model) and/or particular transmissions (e.g., one or more of RS, SSB, data, etc.).

Based on the measurements performed at 972, the UE in the set of UEs 904 may, at 974, perform an AI/ML inference using the AI/ML model. For example, the UE may generate, based on the measurement data, a prediction for one or more AI/ML enabled features, feature groups, or functions associated with the cell cluster using the AI/ML model. In some aspects, the UE may, at 976, perform an operation based on the inference (e.g., the prediction) performed at 974.

FIG. 10 is a call flow diagram 1000 illustrating a method of wireless communication in accordance with some aspects of the disclosure. The method is illustrated in relation to a radio area network (e.g., an NG-RAN) including a set of network entities (NEs) 1002 that may include a set of base stations (e.g., as an example of a set of network devices or network nodes that may include one or more components of a disaggregated base station) and a server 1008 representing a network function, a network-side server, or an OAM entity. The server 1008, in some aspects, may be implemented in a distributed manner, and is illustrated as a single server in FIG. 10 for clarity and convenience without placing limits on the performance of any associated operations or actions to a single physical entity. The set of NEs 1002, may be in communication with a set of UE-side entities 1009, such as a set of UEs 1004 (e.g., as an example of one or more wireless devices associated with the RAN or NG-RAN) and a UE-side server 1006. The UE-side server 1006, in some aspects, may be implemented in a distributed manner, and is illustrated as a single server in FIG. 10 for clarity and convenience without placing limits on the performance of any associated operations or actions to a single physical entity. The description below may refer to an example NE or UE (e.g., in the singular) when describing actions taken by the set of NEs 1002 or the set of UEs 1004. The functions ascribed to the NEs 1002 (or a NE in the set of NEs 1002), in some aspects, may be performed by one or more components of a network entity, a network node, or a network device (a single network entity/node/device or a disaggregated network entity/node/device as described above in relation to FIG. 1). Similarly, the functions ascribed to the set of UEs 1004 (or a UE in the set of UEs 1004), in some aspects, may be performed by one or more components of a wireless device supporting communication with a network entity/node/device. Accordingly, references to “transmitting” in the description below may be understood to refer to a first component of the NE (or the UE) outputting (or providing) an indication of the content of the transmission to be transmitted by a different component of the NE (or the UE). Similarly, references to “receiving” in the description below may be understood to refer to a first component of the NE (or the UE) receiving a transmitted signal and outputting (or providing) the received signal (or information based on the received signal) to a different component of the NE (or the UE).

The call flow diagram 1000 as illustrated includes a first set of operations associated with a determination of a cell cluster membership (e.g., cluster determination 1001), a second set of operations associated with a training of an AI/ML model (e.g., AI/ML model training 1003), and a third set of operations (e.g., AI/ML model inference 1005) associated with using the AI/ML model to perform an inference, and perform one or more operations (e.g., a HO to a candidate cell) based on the inference (e.g., based on a predicted measurement event or RLF). In some aspects, performing the one or more operations may include refraining from performing one or more operations (e.g., not performing a HO to a candidate cell based on a predicted HOF). Similar corresponding sets of operations are illustrated in FIGS. 8, 9, 11, and 12 and it is understood that, for example, a cluster determination (or AI/ML model training) illustrated in one call flow diagram may be replaced by a cluster determination (or AI/ML model training) illustrated in another call flow diagram in accordance with some aspects of the disclosure.

A UE (or each UE) in the set of UEs 1004 may transmit a UE capability indication 1010. The UE capability indication 1010 may be received by the server 1008 directly via a NAS or a UP as illustrated, or via a NE (e.g., a serving cell) in the set of NEs 1002. The UE capability indication 1010 may be an indication of support for performing a task associated with one or more AI/ML models for one or more cell clusters. For example, the UE may be capable of measuring a maximum number of cells, e.g., M cells, or a maximum number of carrier frequencies, e.g., N carrier frequencies, across a set of indicated and/or identified clusters or a maximum number of cells, e.g., X cells, or a maximum number of carrier frequencies, e.g., Y carrier frequencies, for each cluster up to a maximum number of clusters, e.g., Z clusters. In some aspects, the UE may be able to predict RRM measurement for a maximum number, K, of best cells, e.g., the top-K cells, or for a maximum number of frequencies, e.g., L predicted frequency measurements across a set of indicated and/or identified clusters. For example, if the UE uses one AI/ML model per cluster (e.g., to make one prediction or perform one inference per cluster), then the UE may be able to run a maximum number of clusters, e.g., L clusters. In some aspects, the indication of the support may be associated with one of a UE capability message, a UE assistance information message, or a radio resource control (RRC) message. The indication of the support, in some aspects, may include one or more of, a first indication of support for a first maximum number of measured cells for one of (i) each cell cluster in a plurality of identified cell clusters (e.g., a per-cluster maximum number of cells for measurement) or (ii) the plurality of identified cell clusters (e.g., across a set of one or more cell clusters identified for the UE), a second indication of support for a second maximum number of measured carrier frequencies for one of (i) each cell cluster in the plurality of identified cell clusters or (ii) the plurality of identified cell clusters; or a third indication of support for a third maximum number of predictions for one of (i) each cell cluster in the plurality of identified cell clusters or (ii) the plurality of identified cell clusters

The server 1008 may transmit, and a NE (or each NE) in the set of NEs 1002 may receive, a cell configuration request 1011. The cell configuration request 1011, in some aspects, may include a request for cell information (e.g., cell configuration information) regarding the NE and/or its neighboring cells. The requested cell information, in some aspects, may include information regarding physical properties of the cell (e.g., antenna height, beam configuration, etc.). Based on the cell configuration request 1011, the NE (or each NE) in the set of NEs 1002 may transmit, and the server 1008 may receive, cell configuration response 1012. The cell configuration response 1012, in some aspects, may include the requested cell information indicated in the cell configuration request 1011.

In some aspects, the cell configuration response 1012 may include transmissions from one or more serving cells and/or neighboring cells associated with a UE in the set of UEs 1004 and may include information about the one or more serving cells and/or neighboring cells. The information may include information regarding physical properties of the one or more serving cells and/or neighboring cells (e.g., location, height, and/or orientation information for a serving cell and one or more neighboring base stations or cells). The information may be provided as ‘objective’ information based on a reference frame, or may be pairwise information relating each neighboring cell to the serving cell. In some aspects, the information regarding the physical properties of the one or more serving cells and/or neighboring cells may be referred to as layout information, network layout information, or network characteristic information.

The server 1008 may transmit (or cause to be transmitted, e.g., by a serving cell in the set of NEs 1002), and a UE (or each UE) in the set of UEs 1004, may receive a measurement configuration 1014. The measurement configuration 1014, in some aspects, may indicate a set of cells (e.g., one or more cells associated with the set of NEs 1002) and/or a set of measurements to perform on, or for, the set of cells. The measurement configuration 1014, in some aspects, may configure the UE to report (e.g., directly via a NAS or a UP or indirectly via a base station or serving cell in the set of NEs 1002) measurements (e.g., a SINR, a RSRP, a RSRQ, etc.) regarding received signals or information associated with sensors, positioning, or other data available at the UE.

The NEs in the set of NEs 1002, in some aspects, may transmit measurement data signals 1018. The set of measurement data signals 1018, in some aspects, may include one or more of reference signals, data transmissions, or other transmissions that may be measured by a UE in the set of UEs 1004. Based on the measurement configuration 1014, a UE in the set of UEs 1004 may, at 1020, perform one or more measurements on the measurement data signals 1018 (e.g., may collect, based on the measurement data signals 1018, data associated with one or more cells of a plurality of cells associated with the set of NEs 1002). In some aspects, the measurements may be performed on a subset of the measurement data signals 1018, e.g., the transmissions from a subset of the plurality of cells that are measurable by the UE and/or particular transmissions (e.g., one or more of RS, SSB, data, etc.).

The UE in the set of UEs 1004, may transmit, and the server 1008 may receive, measurement information 1022. The measurement information 1022, in some aspects, may be raw measurement data based on the measurements performed at 1020 on the measurement data signals 1018 (e.g., the data associated with the one or more cells of the plurality of cells collected by the UE). In some aspects, the measurement information 1022, may be summarized or processed by the UE before being transmitted to the server 1008, where the processing may be indicated in the measurement configuration 1014 (e.g., in a reporting configuration associated with the measurement information, the measurement configuration, or the measurement data collection configuration).

The server 1008 may receive the cell configuration response 1012 (e.g., cell layout information) and the measurement information 1022 from UEs in the set of UEs 1004 served by different cells and associated with different locations and may, therefore have more complete information regarding the physical properties of the network entities (e.g., cells, base stations, beams, etc.) than any individual UE associated with the server 1008.

Based on the UE capability indication 1010 (or a set of different potential UE capabilities), the cell configuration response 1012, and the measurement information 1022, the server 1008 may determine, at 1024, one or more cluster memberships for one or more AI/ML models and/or tasks (e.g., prediction objectives) associated with the AI/ML models. For example, in some aspects, the server 1008 (e.g., a NW-side network entity such as an NF or OAM) may determine the membership of the cell clusters based on the cell configuration response 1012 and the measurement information 1022 (e.g., complete/objective or pairwise layout information that may include IDs and/or explicit information for the one or more serving cells and neighboring cells) received by the server 1008 for each of a set of assumed UE capabilities (e.g., assuming a maximum cluster membership, or maximum number of measurements per cluster, from a range of values that may be indicated by a UE). Where different physical properties (e.g., height, beam configurations, etc.) of the neighboring cells impact AI/ML prediction accuracy, the cell configuration response 1012 may include information regarding the physical properties known to impact the AI/ML prediction accuracy.

In a geographical area, for example, clusters may be determined based on one or more of, (1) geographical proximity and/or a neighboring cell list, (2) a physical configuration and/or environment, and/or (3) a related task (e.g., a particular prediction such as a measurement prediction, a measurement event prediction, a RLF failure prediction, etc.). In some aspects, the physical properties (e.g., configuration, characteristics, and/or environment) may include a transmission power, one or more beam configurations (e.g., codebook, antenna patters, beam width, etc.), height, being indoors, being outdoors, deployment purpose, carrier frequency/frequencies, infra-vendor information, or other physical characteristics that may affect the accuracy of an associated AI/ML model for prediction. For example, in some aspects, a cell cluster for data collection and/or predictions may include base stations transmitting at the same power, and having the same beam configurations, or may include base stations for a HST environment.

The one or more cluster memberships determined for the one or more AI/ML models, the one or more tasks, and the one or more UE capabilities may include a cluster membership for a first cluster associated with multiple AI/ML models and/or tasks and/or different cluster memberships for each of a plurality of different clusters associated with a corresponding plurality of AI/ML models and/or tasks. For example, a first cell cluster determined for, and/or associated with, radio measurement predictions may not include the same cells as a second cell cluster determined for, and/or associated with, measurement event predictions.

In some aspects, the cluster membership for AI/ML models associated with a same task (or prediction objective) may be different for different locations (or capabilities) of a UE (e.g., in different regions or with a different maximum number of measurements that may be made). A first cell cluster membership at a first location (e.g., at a northern cell edge) for a first cell cluster determined for, and/or associated with, RRM predictions, in some aspects, may be different from a second cell cluster membership for a second cell cluster determined for, and/or associated with, RRM predictions at a second location (e.g., not at a cell edge (NACE) or at a southern cell edge). For example, referring to FIG. 4, the membership of the fourth cluster 440 associated with the measurement event prediction may be based on the location of the UE 404 and may include one or more of the base stations 402, 406C, 406E, 406F, and 406H that are within a certain distance from the UE 404, where the cluster membership may further be based on additional physical properties of the base stations and may not include all the candidates within the threshold distance. In some aspects, the cluster membership of the cluster associated with the measurement event prediction (e.g., illustrated as the fourth cluster 440) may change as the UE 404 changes location and the distance threshold includes and/or excludes different base stations. In some aspects, a particular cell may belong to one or more cell clusters associated with different tasks and/or purposes (e.g., identified for, and/or used by, a particular UE for different tasks and/or purposes), or for UEs in different locations and/or regions.

Based on the determination at 1024, the server 1008 may transmit, and a NE in the set of NEs 1002 may receive, cluster information 1025. The NE in the set of NEs 1002 may transmit (or forward), and a UE in the set of UEs 1004 may receive, cluster information 1026. In some aspects, the cluster information 1026 may be transmitted and/or received via one of system information (SI) or dedicated signaling. The server 1008, in some aspects, may transmit the cluster information 1025/1026 to the UE in the set of UEs 1004. In some aspects, cluster information 1025/1026 may include information identifying one or more cell clusters determined at 1024. The information identifying a cell cluster, in some aspects, may be associated with one or more of an identifier of the cell cluster (e.g., a cluster ID); a HPLMN identifier; information regarding one or more AI/ML enabled features, feature groups, or functions associated with the cell cluster; or information regarding an area scope associated with the cell cluster. The information regarding the area scope associated with the cell cluster, in some aspects, may include one or more of a PCI, cell IDs, frequency information. In some aspects, the cluster information 1025/1026 may include training information, a training configuration, or a data collection configuration indicating the type of measurements to perform and/or data to collect (and/or report) for training at least one AI/ML model associated with the identified cluster. In some aspects, a single cluster may be associated with different tasks and/or prediction objectives and the training information may include different indications of different types of measurements to perform and/or data to collect for the different tasks and/or prediction objectives. While in FIG., the cluster information is illustrated without a separate transmission of training configuration to conserve space, in some aspects, the training information/configuration may be transmitted separately from the cluster information 1026 (e.g., in FIG. 12 below, cluster information 1226 may be transmitted separately from training information 1227).

The cluster memberships for the different clusters determined at 1024, in some aspects, may be stored at the server 1008 for providing the cluster information to UEs for which the cluster information becomes relevant. For example, one or more stored cluster memberships determined and/or identified for a particular region (and one or more prediction objectives) may be provided to a UE entering the region. In some aspects, the cluster determination 1001 may be considered complete (for the purposes of this discussion) and the AI/ML model training 1003 may begin at this point. The cluster determination 1001, in some aspects, may be performed periodically, as new cell layout information is received, when feedback is received from a UE in the set of UEs 1004, and/or when changes to one or more characteristics included in the cell configuration response 1012 or the measurement information 1022 are detected (e.g., when, for a particular characteristic, a reported value changes more than an associated threshold from a previously reported value).

The NEs in the set of NEs 1002, in some aspects, may transmit training data signals 1028. The set of training data signals 1028, in some aspects, may include one or more of reference signals, data transmissions, or other transmissions that may be measured by a UE in the set of UEs 1004. Based on the cluster information 1026 (e.g., the training information/configuration or data collection configuration), a UE in the set of UEs 1004 may, at 1030, perform one or more measurements on the training data signals 1028 (e.g., may collect, based on the data collection configuration, data associated with one or more cells of a cell cluster identified in the cluster information 1026). In some aspects, the measurements may be performed on a subset of the training data signals 1028, e.g., the transmissions from the cells identified as belonging to the one or more clusters indicated in the cluster information 1026 and/or particular transmissions (e.g., one or more of RS, SSB, data, etc.).

The UE in the set of UEs 1004, may transmit, and the server 1008 may receive, training data 1032. The training data 1032, in some aspects, may be raw measurement data based on the measurements performed at 1030 on the training data signals 1028 (e.g., the data associated with the one or more cells of the cell cluster collected by the UE). In some aspects, the training data 1032, may be summarized or processed by the UE before being transmitted to the server 1008, where the processing may be indicated in the cluster information 1026 (e.g., in a reporting configuration associated with the training information, the training configuration, or the data collection configuration).

At 1034, the server 1008 may train one or more AI/ML models for the one or more cell clusters based on the training data 1032. In some aspects, the AI/ML model training may identify one or more cluster members for which training data does not improve the accuracy of a prediction by the AI/ML model and the cluster membership determined at 1024 may be adjusted. The cluster membership, in some aspects, may not be updated and the data associated with the redundant and/or irrelevant cluster member may be ignored (e.g., not included in the input to the AI/ML model, or be associated with zero, or near-zero, weights, in the trained AI/ML model) while maintaining the same cluster membership. The training of the AI/ML may be associated with the aspects described in relation to at least FIGS. 5 and 6. In some aspects, the server 1008 may store the trained AI/ML models for one or more of additional training (e.g., refinement) as additional training data is received and/or for subsequent provision to additional UEs. For example, the server 1008 may provide a trained and stored AI/ML model for a particular region and a particular prediction objective to UEs entering the particular region and associated with the particular prediction objective.

After training the one or more AI/ML models for the one or more cell clusters, the server 1008 may provide a trained AI/ML model 1036 to the UE in the set of UEs 1004. The trained AI/ML model, in some aspects, may include a measurement configuration, or data collection configuration, indicating the measurements associated with inputs to the AI/ML model and/or preprocessing associated with the AI/ML model. As discussed above, if the AI/ML training leads to an adjusted cluster membership, providing the AI/ML model 1036 may include providing an indication of the adjusted cluster membership (e.g., an indication of one or more cells to add or remove a cell from the cell cluster and/or to begin, or refrain from, measuring). The measurement configuration (and the signals to be measured and/or the data to be collected for the inference), in some aspects, may be different from the training information, the training configuration, and/or the data collection configuration (and the signals to be measured and/or the data to be collected for training). In some aspects, the measurement configuration may be transmitted in a separate transmission/message associated with the trained AI/ML model 1036. In some aspects, the UE may, at 1068, refine the AI/ML model based on local data not available (e.g., not transmitted) to the server 1008. In some aspects, the AI/ML model training 1003 may be considered complete (for the purposes of this discussion) and the AI/ML model inference 1005 may begin at this point. The AI/ML model training 1003, and specifically the AI/ML model refinement at 1068, in some aspects, may be performed periodically, as new cell layout or cluster membership information is received, new training and/or measurement data is collected, and/or when a prediction accuracy falls below a threshold. In some aspects, the UE in the set of UEs 1004 may transmit, and the server 1008 may receive, feedback 1069 based on the AI/ML refinement at 1068. In some aspects, the feedback 1069 may include one or more of a set of cluster IDs/information and a set of AI/ML prediction KPIs (e.g., a RRM measurement prediction error, an X dB Mean absolute error [MAE]) based on the current cluster membership; a set of cluster IDs/information, an indication of one or more added cell(s), and a set of AI/ML prediction KPI(s) based on a modified cluster membership adding the indicated one or more cell(s) (e.g., a RRM measurement prediction error, a Y dB MAE); or a set of cluster IDs/information, an indication of one or more removed/ignored cell(s), and a set of AI/ML prediction KPI(s) (e.g., a RRM measurement prediction error, Z dB MAE). Based on the received feedback 1069, the server 1008 may update a cluster membership (e.g., at 1024) as described in relation to the (periodic or event-triggered) repetition of cluster determination 1001 and proceed as described above.

The cells in the cell cluster associated with the AI/ML model 1036, may transmit one or more measurement data signals. The one or more measurement data signals, in some aspects, may include one or more of reference signals, data transmissions, or other transmissions that may be measured by a UE in the set of UEs 1004. The UE in the set of UEs 1004 may, at 1072, perform one or more measurements on the measurement data signals, perform an AI/ML inference using the AI/ML mode, and perform an operation based on the inference (e.g., the prediction). For example, based on the AI/ML model 1036 (e.g., the measurement configuration), a UE in the set of UEs 1004 may, at 1072, perform one or more measurements on the measurement data signals (e.g., may collect, based on the measurement configuration, data associated with one or more cells of a cell cluster identified in the cluster information 1026 and/or associated with the AI/ML model 1036). In some aspects, the measurements may be performed on a subset of the measurement data signals, e.g., the transmissions from the cells identified as belonging to the one or more clusters indicated in the cluster information 1026 (or associated with the AI/ML model 1036) and/or particular transmissions (e.g., one or more of RS, SSB, data, etc.).

Based on the measurements performed at 1072, the UE in the set of UEs 1004 may, at 1072, further perform an AI/ML inference using the AI/ML model. For example, the UE may generate, based on the measurement data, a prediction for one or more AI/ML enabled features, feature groups, or functions associated with the cell cluster using the AI/ML model. In some aspects, the UE may, at 1072, further perform an operation based on the inference (e.g., the prediction).

FIG. 11 is a call flow diagram 1100 illustrating a method of wireless communication in accordance with some aspects of the disclosure. The method is illustrated in relation to a radio area network (e.g., an NG-RAN) including a set of network entities (NEs) 1102 that may include a set of base stations (e.g., as an example of a set of network devices or network nodes that may include one or more components of a disaggregated base station) and a server 1108 representing a network function, a network-side server, or an OAM entity. The server 1108, in some aspects, may be implemented in a distributed manner, and is illustrated as a single server in FIG. 11 for clarity and convenience without placing limits on the performance of any associated operations or actions to a single physical entity. The set of NEs 1102, may be in communication with a set of UE-side entities 1109, such as a set of UEs 1104 (e.g., as an example of one or more wireless devices associated with the RAN or NG-RAN) and a UE-side server 1106. The UE-side server 1106, in some aspects, may be implemented in a distributed manner, and is illustrated as a single server in FIG. 11 for clarity and convenience without placing limits on the performance of any associated operations or actions to a single physical entity. The description below may refer to an example NE or UE (e.g., in the singular) when describing actions taken by the set of NEs 1102 or the set of UEs 1104. The functions ascribed to the NEs 1102 (or a NE in the set of NEs 1102), in some aspects, may be performed by one or more components of a network entity, a network node, or a network device (a single network entity/node/device or a disaggregated network entity/node/device as described above in relation to FIG. 1). Similarly, the functions ascribed to the set of UEs 1104 (or a UE in the set of UEs 1104), in some aspects, may be performed by one or more components of a wireless device supporting communication with a network entity/node/device. Accordingly, references to “transmitting” in the description below may be understood to refer to a first component of the NE (or the UE) outputting (or providing) an indication of the content of the transmission to be transmitted by a different component of the NE (or the UE). Similarly, references to “receiving” in the description below may be understood to refer to a first component of the NE (or the UE) receiving a transmitted signal and outputting (or providing) the received signal (or information based on the received signal) to a different component of the NE (or the UE).

The call flow diagram 1100 as illustrated includes a first set of operations associated with a determination of a cell cluster membership (e.g., cluster determination 1101), a second set of operations associated with a training of an AI/ML model (e.g., AI/ML model training 1103), and a third set of operations (e.g., AI/ML model inference 1105) associated with using the AI/ML model to perform an inference, and perform one or more operations (e.g., a HO to a candidate cell) based on the inference (e.g., based on a predicted measurement event or RLF). In some aspects, performing the one or more operations may include refraining from performing one or more operations (e.g., not performing a HO to a candidate cell based on a predicted HOF). Similar corresponding sets of operations are illustrated in FIGS. 8, 9, 11, and 12 and it is understood that, for example, a cluster determination (or AI/ML model training) illustrated in one call flow diagram may be replaced by a cluster determination (or AI/ML model training) illustrated in another call flow diagram in accordance with some aspects of the disclosure.

A UE (or each UE) in the set of UEs 1104 may transmit a UE capability indication. The UE capability indication may be received by the server 1108 directly via a NAS or a UP as illustrated, or via a NE (e.g., a serving cell) in the set of NEs 1102. The UE capability indication may be an indication of support for performing a task associated with one or more AI/ML models for one or more cell clusters. For example, the UE may be capable of measuring a maximum number of cells, e.g., M cells, or a maximum number of carrier frequencies, e.g., N carrier frequencies, across a set of indicated and/or identified clusters or a maximum number of cells, e.g., X cells, or a maximum number of carrier frequencies, e.g., Y carrier frequencies, for each cluster up to a maximum number of clusters, e.g., Z clusters. In some aspects, the UE may be able to predict RRM measurement for a maximum number, K, of best cells, e.g., the top-K cells, or for a maximum number of frequencies, e.g., L predicted frequency measurements across a set of indicated and/or identified clusters. For example, if the UE uses one AI/ML model per cluster (e.g., to make one prediction or perform one inference per cluster), then the UE may be able to run a maximum number of clusters, e.g., L clusters. In some aspects, the indication of the support may be associated with one of a UE capability message, a UE assistance information message, or a radio resource control (RRC) message. The indication of the support, in some aspects, may include one or more of, a first indication of support for a first maximum number of measured cells for one of (i) each cell cluster in a plurality of identified cell clusters (e.g., a per-cluster maximum number of cells for measurement) or (ii) the plurality of identified cell clusters (e.g., across a set of one or more cell clusters identified for the UE), a second indication of support for a second maximum number of measured carrier frequencies for one of (i) each cell cluster in the plurality of identified cell clusters or (ii) the plurality of identified cell clusters; or a third indication of support for a third maximum number of predictions for one of (i) each cell cluster in the plurality of identified cell clusters or (ii) the plurality of identified cell clusters

The server 1108 may transmit, and a NE (or each NE) in the set of NEs 1102 may receive, a cell configuration request 1111. The cell configuration request 1111, in some aspects, may include a request for cell information (e.g., cell configuration information) regarding the NE and/or its neighboring cells. The requested cell information, in some aspects, may include information regarding physical properties of the cell (e.g., antenna height, beam configuration, etc.). Based on the cell configuration request 1111, the NE (or each NE) in the set of NEs 1102 may transmit, and the server 1108 may receive, cell configuration response 1112. The cell configuration response 1112, in some aspects, may include the requested cell information indicated in the cell configuration request 1111.

In some aspects, the cell configuration response 1112 may include transmissions from one or more serving cells and/or neighboring cells associated with a UE in the set of UEs 1104 and may include information about the one or more serving cells and/or neighboring cells. The information may include information regarding physical properties of the one or more serving cells and/or neighboring cells (e.g., location, height, and/or orientation information for a serving cell and one or more neighboring base stations or cells). The information may be provided as ‘objective’ information based on a reference frame, or may be pairwise information relating each neighboring cell to the serving cell. In some aspects, the information regarding the physical properties of the one or more serving cells and/or neighboring cells may be referred to as layout information, network layout information, or network characteristic information. In some aspects, an explicit cell configuration request 1111 and the cell configuration response 1112, may be omitted if the server 1008 is already configured to receive the information used to determine cluster memberships.

The server 1108 may transmit (or cause to be transmitted, e.g., by a serving cell in the set of NEs 1102), and a UE (or each UE) in the set of UEs 1104, may receive a measurement configuration 1114. The measurement configuration 1114, in some aspects, may indicate a set of cells (e.g., one or more cells associated with the set of NEs 1102) and/or a set of measurements to perform on, or for, the set of cells. The measurement configuration 1114, in some aspects, may configure the UE to report (e.g., directly via a NAS or a UP or indirectly via a base station or serving cell in the set of NEs 1102) measurements (e.g., a SINR, a RSRP, a RSRQ, etc.) regarding received signals or information associated with sensors, positioning, or other data available at the UE.

The NEs in the set of NEs 1102, in some aspects, may transmit measurement data signals 1118. The set of measurement data signals 1118, in some aspects, may include one or more of reference signals, data transmissions, or other transmissions that may be measured by a UE in the set of UEs 1104. Based on the measurement configuration 1114, a UE in the set of UEs 1104 may, at 1120, perform one or more measurements on the measurement data signals 1118 (e.g., may collect, based on the measurement data signals 1118, data associated with one or more cells of a plurality of cells associated with the set of NEs 1102). In some aspects, the measurements may be performed on a subset of the measurement data signals 1118, e.g., the transmissions from a subset of the plurality of cells that are measurable by the UE and/or particular transmissions (e.g., one or more of RS, SSB, data, etc.).

The UE in the set of UEs 1104, may transmit, and the server 1108 may receive, measurement information 1122. The measurement information 1122, in some aspects, may be raw measurement data based on the measurements performed at 1120 on the measurement data signals 1118 (e.g., the data associated with the one or more cells of the plurality of cells collected by the UE). In some aspects, the measurement information 1122, may be summarized or processed by the UE before being transmitted to the server 1108, where the processing may be indicated in the measurement configuration 1114 (e.g., in a reporting configuration associated with the measurement information, the measurement configuration, or the measurement data collection configuration).

The server 1108 may receive the cell configuration response 1112 (e.g., cell layout information) and the measurement information 1122 from UEs in the set of UEs 1104 served by different cells and associated with different locations and may, therefore have more complete information regarding the physical properties of the network entities (e.g., cells, base stations, beams, etc.) than any individual UE associated with the server 1108.

Based on the UE capability indication (or a set of different potential UE capabilities), the cell configuration response 1112, and the measurement information 1122, the server 1108 may determine, at 1124, one or more cluster memberships for one or more AI/ML models and/or tasks (e.g., prediction objectives) associated with the AI/ML models. For example, in some aspects, the server 1108 (e.g., a NW-side network entity such as an NF or OAM) may determine the membership of the cell clusters based on the cell configuration response 1112 and the measurement information 1122 (e.g., complete/objective or pairwise layout information that may include IDs and/or explicit information for the one or more serving cells and neighboring cells) received by the server 1108 (e.g., based on SI received by the set of UEs 1104) for each of a set of assumed UE capabilities (e.g., assuming a maximum cluster membership, or maximum number of measurements per cluster, from a range of values that may be indicated by a UE). Where different physical properties (e.g., height, beam configurations, etc.) of the neighboring cells impact AI/ML prediction accuracy, the cell configuration response 1112 may include information regarding the physical properties known to impact the AI/ML prediction accuracy.

In a geographical area, for example, clusters may be determined based on one or more of, (1) geographical proximity and/or a neighboring cell list, (2) a physical configuration and/or environment, and/or (3) a related task (e.g., a particular prediction such as a measurement prediction, a measurement event prediction, a RLF failure prediction, etc.). In some aspects, the physical properties (e.g., configuration, characteristics, and/or environment) may include a transmission power, one or more beam configurations (e.g., codebook, antenna patters, beam width, etc.), height, being indoors, being outdoors, deployment purpose, carrier frequency/frequencies, infra-vendor information, or other physical characteristics that may affect the accuracy of an associated AI/ML model for prediction. For example, in some aspects, a cell cluster for data collection and/or predictions may include base stations transmitting at the same power, and having the same beam configurations, or may include base stations for a HST environment.

The one or more cluster memberships determined for the one or more AI/ML models, the one or more tasks, and the one or more UE capabilities may include a cluster membership for a first cluster associated with multiple AI/ML models and/or tasks and/or different cluster memberships for each of a plurality of different clusters associated with a corresponding plurality of AI/ML models and/or tasks. For example, a first cell cluster determined for, and/or associated with, RRM predictions may not include the same cells as a second cell cluster determined for, and/or associated with, measurement event predictions.

In some aspects, the cluster membership for AI/ML models associated with a same task (or prediction objective) may be different for different locations (or capabilities) of a UE (e.g., in different regions or with a different maximum number of measurements that may be made). A first cell cluster membership at a first location (e.g., at a northern cell edge) for a first cell cluster determined for, and/or associated with, RRM predictions, in some aspects, may be different from a second cell cluster membership for a second cell cluster determined for, and/or associated with, RRM predictions at a second location (e.g., not at a cell edge (NACE) or at a southern cell edge). For example, referring to FIG. 4, the membership of the fourth cluster 440 associated with the measurement event prediction may be based on the location of the UE 404 and may include one or more of the base stations 402, 406C, 406E, 406F, and 406H that are within a certain distance from the UE 404, where the cluster membership may further be based on additional physical properties of the base stations and may not include all the candidates within the threshold distance. In some aspects, the cluster membership of the cluster associated with the measurement event prediction (e.g., illustrated as the fourth cluster 440) may change as the UE 404 changes location and the distance threshold includes and/or excludes different base stations. In some aspects, a particular cell may belong to one or more cell clusters associated with different tasks and/or purposes (e.g., identified for, and/or used by, a particular UE for different tasks and/or purposes), or for UEs in different locations and/or regions.

Based on the determination at 1124, the server 1108 may transmit, and a UE in the set of UEs 1104 may receive, cluster information 1126. The server 1108, in some aspects, may transmit the cluster information 1126 to the UE in the set of UEs 1104. In some aspects, cluster information 1126 may include information identifying one or more cell clusters determined at 1124. The information identifying a cell cluster, in some aspects, may be associated with one or more of an identifier of the cell cluster (e.g., a cluster ID); a HPLMN identifier; information regarding one or more AI/ML enabled features, feature groups, or functions associated with the cell cluster; or information regarding an area scope associated with the cell cluster. The information regarding the area scope associated with the cell cluster, in some aspects, may include one or more of a PCI, cell IDs, frequency information. In some aspects, the cluster information 1126 may include training information, a training configuration, or a data collection configuration indicating the type of measurements to perform and/or data to collect (and/or report) for training at least one AI/ML model associated with the identified cluster. In some aspects, a single cluster may be associated with different tasks and/or prediction objectives and the training information may include different indications of different types of measurements to perform and/or data to collect for the different tasks and/or prediction objectives. While in FIG., the cluster information is illustrated without a separate transmission of training configuration to conserve space, in some aspects, the training information/configuration may be transmitted separately from the cluster information 1126 (e.g., in FIG. 12 below, cluster information 1226 may be transmitted separately from training information 1227). The cluster memberships for the different clusters determined at 1124, in some aspects, may be stored at the server 1108 for providing the cluster information to UEs for which the cluster information becomes relevant. For example, one or more stored cluster memberships determined and/or identified for a particular region (and one or more prediction objectives) may be provided to a UE entering the region. In some aspects, the cluster determination 1101 may be considered complete (for the purposes of this discussion) and the AI/ML model training 1103 may begin at this point. The cluster determination 1101, in some aspects, may be performed periodically, as new cell layout information is received, when feedback is received from a UE in the set of UEs 1104, and/or when changes to one or more characteristics included in the cell configuration response 1112 or the measurement information 1122 are detected (e.g., when, for a particular characteristic, a reported value changes more than an associated threshold from a previously reported value).

The NEs in the set of NEs 1102, in some aspects, may transmit training data signals 1128. The set of training data signals 1128, in some aspects, may include one or more of reference signals, data transmissions, or other transmissions that may be measured by a UE in the set of UEs 1104. Based on the cluster information 1126 (e.g., the training information/configuration or data collection configuration), a UE in the set of UEs 1104 may, at 1130, perform one or more measurements on the training data signals 1128 (e.g., may collect, based on the data collection configuration, data associated with one or more cells of a cell cluster identified in the cluster information 1126). In some aspects, the measurements may be performed on a subset of the training data signals 1128, e.g., the transmissions from the cells identified as belonging to the one or more clusters indicated in the cluster information 1126 and/or particular transmissions (e.g., one or more of RS, SSB, data, etc.).

The UE in the set of UEs 1104, may transmit, and the server 1108 may receive, training data. The training data, in some aspects, may be raw measurement data based on the measurements performed at 1130 on the training data signals 1128 (e.g., the data associated with the one or more cells of the cell cluster collected by the UE). In some aspects, the training data, may be summarized or processed by the UE before being transmitted to the server 1108, where the processing may be indicated in the cluster information 1126 (e.g., in a reporting configuration associated with the training information, the training configuration, or the data collection configuration). At 1164, the server 1108 may train one or more AI/ML models for the one or more cell clusters based on the measurements performed at 1130 on the training data signals 1128 (e.g., the data associated with the one or more cells of the cell cluster collected by the UE). In some aspects, the AI/ML model training may identify one or more cluster members for which training data does not improve the accuracy of a prediction by the AI/ML model and the UE may provide feedback for updating the cluster membership. The cluster membership, in some aspects, may not be updated and the data associated with the redundant and/or irrelevant cluster member may be ignored (e.g., not included in the input to the AI/ML model, or be associated with zero, or near-zero, weights, in the trained AI/ML model) while maintaining the same cluster membership. The training of the AI/ML may be associated with the aspects described in relation to at least FIGS. 5 and 6. In some aspects, the UE may provide the trained AI/ML model to the server 1008 and the UE and/or the server 1108 may store the trained AI/ML models for one or more of additional training (e.g., refinement) as additional training data is received and/or for subsequent provision to additional UEs. For example, the server 1108 may provide a trained and stored AI/ML model for a particular region and a particular prediction objective to UEs entering the particular region and associated with the particular prediction objective.

After training the one or more AI/ML models for the one or more cell clusters, the UE in the set of UEs 1104 may provide a trained AI/ML model to the server 1108. The trained AI/ML model, in some aspects, may include a measurement configuration indicating the measurements associated with inputs to the AI/ML model and/or preprocessing associated with the AI/ML model. The measurement configuration (and the signals to be measured and/or the data to be collected for the inference), in some aspects, may be different from the training information, the training configuration, and/or the data collection configuration (and the signals to be measured and/or the data to be collected for training). In some aspects, the measurement configuration may be transmitted in a separate transmission/message associated with the trained AI/ML model. In some aspects, the UE may refine the AI/ML model as additional information and/or data is collected (as described in relation to refining the AI/ML model at 868 of FIG. 8). In some aspects, the AI/ML model training 1103 may be considered complete (for the purposes of this discussion) and the AI/ML model inference 1105 may begin at this point. The AI/ML model training 1103, and specifically the AI/ML model refinement, in some aspects, may be performed periodically, as new cell layout or cluster membership information is received, new training and/or measurement data is collected, and/or when a prediction accuracy falls below a threshold. In some aspects, the UE in the set of UEs 1104 may transmit, and the server 1108 may receive, feedback (e.g., as described in relation to feedback 1069 of FIG. 10) based on the AI/ML refinement. Based on the received feedback, the server 1108 may update a cluster membership (e.g., at 1124) as described in relation to the (periodic or event-triggered) repetition of cluster determination 1101 and proceed as described above.

The cells in the cell cluster associated with the AI/ML model, may transmit one or more measurement data signals. The one or more measurement data signals, in some aspects, may include one or more of reference signals, data transmissions, or other transmissions that may be measured by a UE in the set of UEs 1104. The UE in the set of UEs 1104 may, at 1172, perform one or more measurements on the measurement data signals, perform an AI/ML inference using the AI/ML mode, and perform an operation based on the inference (e.g., the prediction). For example, based on the AI/ML model (e.g., the measurement configuration), a UE in the set of UEs 1104 may, at 1172, perform one or more measurements on the measurement data signals (e.g., may collect, based on the measurement configuration, data associated with one or more cells of a cell cluster identified in the cluster information 1126 and/or associated with the AI/ML model). In some aspects, the measurements may be performed on a subset of the measurement data signals, e.g., the transmissions from the cells identified as belonging to the one or more clusters indicated in the cluster information 1126 (or associated with the AI/ML model) and/or particular transmissions (e.g., one or more of RS, SSB, data, etc.).

Based on the measurements performed at 1172, the UE in the set of UEs 1104 may, at 1172, further perform an AI/ML inference using the AI/ML model. For example, the UE may generate, based on the measurement data, a prediction for one or more AI/ML enabled features, feature groups, or functions associated with the cell cluster using the AI/ML model. In some aspects, the UE may, at 1172, further perform an operation based on the inference (e.g., the prediction).

FIG. 12 is a call flow diagram 1200 illustrating a method of wireless communication in accordance with some aspects of the disclosure. The method is illustrated in relation to a radio area network (e.g., an NG-RAN) including a set of network entities (NEs) 1208 and a serving cell 1202 that may include a set of base stations (e.g., as an example of a set of network devices or network nodes that may include one or more components of a disaggregated base station) which may be associated with a network function, a network-side server, or an OAM entity. The set of NEs 1208 and the serving cell 1202, may be in communication with a set of UE-side entities 1209, such as a set of UEs 1204 (e.g., as an example of one or more wireless devices associated with the RAN or NG-RAN) and a UE-side server 1206. The UE-side server 1206, in some aspects, may be implemented in a distributed manner, and is illustrated as a single server in FIG. 12 for clarity and convenience without placing limits on the performance of any associated operations or actions to a single physical entity. The description below may refer to an example NE or UE (e.g., in the singular) when describing actions taken by the set of NEs 1208 or the set of UEs 1204. The functions ascribed to the NEs 1208 (or a NE in the set of NEs 1208), in some aspects, may be performed by one or more components of a network entity, a network node, or a network device (a single network entity/node/device or a disaggregated network entity/node/device as described above in relation to FIG. 1). Similarly, the functions ascribed to the set of UEs 1204 (or a UE in the set of UEs 1204), in some aspects, may be performed by one or more components of a wireless device supporting communication with a network entity/node/device. Accordingly, references to “transmitting” in the description below may be understood to refer to a first component of the NE (or the UE) outputting (or providing) an indication of the content of the transmission to be transmitted by a different component of the NE (or the UE). Similarly, references to “receiving” in the description below may be understood to refer to a first component of the NE (or the UE) receiving a transmitted signal and outputting (or providing) the received signal (or information based on the received signal) to a different component of the NE (or the UE).

The call flow diagram 1200 as illustrated includes a first set of operations associated with a determination of a cell cluster membership (e.g., cluster determination 1201), a second set of operations associated with a training of an AI/ML model (e.g., AI/ML model training 1203), and a third set of operations (e.g., AI/ML model inference 1205) associated with using the AI/ML model to perform an inference, and perform one or more operations (e.g., a HO to a candidate cell) based on the inference (e.g., based on a predicted measurement event or RLF). In some aspects, performing the one or more operations may include refraining from performing one or more operations (e.g., not performing a HO to a candidate cell based on a predicted HOF). Similar corresponding sets of operations are illustrated in FIGS. 8-11 and it is understood that, for example, a cluster determination (or AI/ML model training) illustrated in one call flow diagram may be replaced by a cluster determination (or AI/ML model training) illustrated in another call flow diagram in accordance with some aspects of the disclosure.

A UE (or each UE) in the set of UEs 1204 may transmit, and the serving cell 1202 may receive, a UE capability indication. The UE capability indication may be an indication of support for performing a task associated with one or more AI/ML models for one or more cell clusters. For example, the UE may be capable of measuring a maximum number of cells, e.g., M cells, or a maximum number of carrier frequencies, e.g., N carrier frequencies, across a set of indicated and/or identified clusters or a maximum number of cells, e.g., X cells, or a maximum number of carrier frequencies, e.g., Y carrier frequencies, for each cluster up to a maximum number of clusters, e.g., Z clusters. In some aspects, the UE may be able to predict RRM measurement for a maximum number, K, of best cells, e.g., the top-K cells, or for a maximum number of frequencies, e.g., L predicted frequency measurements across a set of indicated and/or identified clusters. For example, if the UE uses one AI/ML model per cluster (e.g., to make one prediction or perform one inference per cluster), then the UE may be able to run a maximum number of clusters, e.g., L clusters. In some aspects, the indication of the support may be associated with one of a UE capability message, a UE assistance information message, or a radio resource control (RRC) message. The indication of the support, in some aspects, may include one or more of, a first indication of support for a first maximum number of measured cells for one of (i) each cell cluster in a plurality of identified cell clusters (e.g., a per-cluster maximum number of cells for measurement) or (ii) the plurality of identified cell clusters (e.g., across a set of one or more cell clusters identified for the UE), a second indication of support for a second maximum number of measured carrier frequencies for one of (i) each cell cluster in the plurality of identified cell clusters or (ii) the plurality of identified cell clusters; or a third indication of support for a third maximum number of predictions for one of (i) each cell cluster in the plurality of identified cell clusters or (ii) the plurality of identified cell clusters.

The serving cell 1202 may exchange, with the set of NEs 1208, cell information. The cell information (e.g., cell configuration information) may include information regarding the serving cell 1202 and the set of NEs 1208 (e.g., neighboring cells). The exchanged cell information, in some aspects, may include information regarding physical properties of the cell (e.g., antenna height, beam configuration, etc.). For example, the exchanged cell information may include information regarding physical properties of the serving cell 1202 and/or the set of NEs 1208 (e.g., location, height, and/or orientation information for a serving cell and one or more neighboring base stations or cells). The information may be provided as ‘objective’ information based on a reference frame, or may be pairwise information relating each neighboring cell to the serving cell. In some aspects, the information regarding the physical properties of the one or more serving cells and/or neighboring cells may be referred to as layout information, network layout information, or network characteristic information.

The serving cell 1202 may transmit, and a UE (or each UE) in the set of UEs 1204, may receive a measurement configuration as described in relation to FIGS. 10 and 11. The measurement configuration, in some aspects, may indicate a set of cells (e.g., one or more cells associated with the serving cell 1202 and the set of NEs 1208) and/or a set of measurements to perform on, or for, the set of cells. The measurement configuration, in some aspects, may configure the UE to perform measurements (e.g., a SINR, a RSRP, a RSRQ, etc.) regarding received signals or information associated with sensors, positioning, or other data available at the UE.

The serving cell 1202 and the NEs in the set of NEs 1208, in some aspects, may transmit measurement data signals as described in relation to FIGS. 10 and 11. The set of measurement data signals, in some aspects, may include one or more of reference signals, data transmissions, or other transmissions that may be measured by a UE in the set of UEs 1204. Based on the measurement configuration, a UE in the set of UEs 1204 may perform one or more measurements on the measurement data signals (e.g., may collect, based on the measurement data signals, data associated with one or more cells of a plurality of cells associated with the serving cell 1202 and the set of NEs 1208). In some aspects, the measurements may be performed on a subset of the measurement data signals, e.g., the transmissions from a subset of the plurality of cells that are measurable by the UE and/or particular transmissions (e.g., one or more of RS, SSB, data, etc.).

The UE in the set of UEs 1204, may transmit, and the serving cell 1202 may receive, measurement information as described in relation to FIGS. 10 and 11. The measurement information, in some aspects, may be raw measurement data based on the measurements performed at on the measurement data signals (e.g., the data associated with the one or more cells of the plurality of cells collected by the UE). In some aspects, the measurement information, may be summarized or processed by the UE before being transmitted to the serving cell 1202, where the processing may be indicated in the measurement configuration (e.g., in a reporting configuration associated with the measurement information, the measurement configuration, or the measurement data collection configuration).

The serving cell 1202 may receive the cell information form the set of NEs 1208 and the measurement information from UEs in the set of UEs 1204 associated with different cells and associated with different locations and may, therefore have more complete information regarding the physical properties of the network entities (e.g., cells, base stations, beams, etc.) than any individual UE associated with the serving cell 1202.

Based on the UE capability indication (or a set of different potential UE capabilities), the cell information, and the measurement information, the serving cell 1202 and the set of NEs 1208 may determine, at 1224, one or more cluster memberships for one or more AI/ML models and/or tasks (e.g., prediction objectives) associated with the AI/ML models. For example, in some aspects, the serving cell 1202 and/or the set of NEs 1208 may determine the membership of the cell clusters based on the cell information and the measurement information (e.g., complete/objective or pairwise layout information that may include IDs and/or explicit information for the one or more serving cells and neighboring cells) for each of a set of assumed UE capabilities (e.g., assuming a maximum cluster membership, or maximum number of measurements per cluster, from a range of values that may be indicated by a UE). Where different physical properties (e.g., height, beam configurations, etc.) of the neighboring cells impact AI/ML prediction accuracy, the cell information may include information regarding the physical properties known to impact the AI/ML prediction accuracy.

In a geographical area, for example, clusters may be determined based on one or more of, (1) geographical proximity and/or a neighboring cell list, (2) a physical configuration and/or environment, and/or (3) a related task (e.g., a particular prediction such as a measurement prediction, a measurement event prediction, a RLF failure prediction, etc.). In some aspects, the physical properties (e.g., configuration, characteristics, and/or environment) may include a transmission power, one or more beam configurations (e.g., codebook, antenna patters, beam width, etc.), height, being indoors, being outdoors, deployment purpose, carrier frequency/frequencies, infra-vendor information, or other physical characteristics that may affect the accuracy of an associated AI/ML model for prediction. For example, in some aspects, a cell cluster for data collection and/or predictions may include base stations transmitting at the same power, and having the same beam configurations, or may include base stations for a HST environment.

The one or more cluster memberships determined for the one or more AI/ML models, the one or more tasks, and the one or more UE capabilities may include a cluster membership for a first cluster associated with multiple AI/ML models and/or tasks and/or different cluster memberships for each of a plurality of different clusters associated with a corresponding plurality of AI/ML models and/or tasks. For example, a first cell cluster determined for, and/or associated with, mobility related measurement predictions may not include the same cells as a second cell cluster determined for, and/or associated with, measurement event predictions.

In some aspects, the cluster membership for AI/ML models associated with a same task (or prediction objective) may be different for different locations (or capabilities) of a UE (e.g., in different regions or with a different maximum number of measurements that may be made). A first cell cluster membership at a first location (e.g., at a northern cell edge) for a first cell cluster determined for, and/or associated with, RRM predictions, in some aspects, may be different from a second cell cluster membership for a second cell cluster determined for, and/or associated with, RRM predictions at a second location (e.g., not at a cell edge (NACE) or at a southern cell edge). For example, referring to FIG. 4, the membership of the fourth cluster 440 associated with the measurement event prediction may be based on the location of the

UE 404 and may include one or more of the base stations 402, 406C, 406E, 406F, and 406H that are within a certain distance from the UE 404, where the cluster membership may further be based on additional physical properties of the base stations and may not include all the candidates within the threshold distance. In some aspects, the cluster membership of the cluster associated with the measurement event prediction (e.g., illustrated as the fourth cluster 440) may change as the UE 404 changes location and the distance threshold includes and/or excludes different base stations. In some aspects, a particular cell may belong to one or more cell clusters associated with different tasks and/or purposes (e.g., identified for, and/or used by, a particular UE for different tasks and/or purposes), or for UEs in different locations and/or regions.

Based on the determination at 1224, the serving cell 1202 may transmit, and a UE in the set of UEs 1204 may receive, cluster information 1226. The serving cell 1202, in some aspects, may transmit the cluster information 1226 to the UE in the set of UEs 1204. In some aspects, cluster information 1226 may include information identifying one or more cell clusters determined at 1224. The information identifying a cell cluster, in some aspects, may be associated with one or more of an identifier of the cell cluster (e.g., a cluster ID); a HPLMN identifier; information regarding one or more AI/ML enabled features, feature groups, or functions associated with the cell cluster; or information regarding an area scope associated with the cell cluster. The information regarding the area scope associated with the cell cluster, in some aspects, may include one or more of a PCI, cell IDs, frequency information. In some aspects, the serving cell 1202 may transmit, and the UE in the set of UEs 1204 may receive, training information 1227 (e.g., a training configuration or a data collection configuration) indicating the type of measurements to perform and/or data to collect (and/or report) for training at least one AI/ML model associated with the identified cluster. In some aspects, a single cluster may be associated with different tasks and/or prediction objectives and the training information 1227 may include different indications of different types of measurements to perform and/or data to collect for the different tasks and/or prediction objectives.

The cluster memberships for the different clusters determined at 1224, in some aspects, may be stored at the serving cell 1202 for providing the cluster information to UEs for which the cluster information becomes relevant. For example, one or more stored cluster memberships determined and/or identified for a particular region (and one or more prediction objectives) may be provided to a UE entering the region. In some aspects, the cluster determination 1201 may be considered complete (for the purposes of this discussion) and the AI/ML model training 1203 may begin at this point. The cluster determination 1201, in some aspects, may be performed periodically, as new cell layout information is received, when feedback is received from a UE in the set of UEs 1204, and/or when changes to one or more characteristics included in the cell information or the measurement information are detected (e.g., when, for a particular characteristic, a reported value changes more than an associated threshold from a previously reported value).

The NEs in the set of NEs 1208, in some aspects, may transmit training data signals 1228. The set of training data signals 1228, in some aspects, may include one or more of reference signals, data transmissions, or other transmissions that may be measured by a UE in the set of UEs 1204. Based on the cluster information 1226 (e.g., the training information 1227, a training configuration or data collection configuration), a UE in the set of UEs 1204 may, at 1230, perform one or more measurements on the training data signals 1228 (e.g., may collect, based on the data collection configuration, data associated with one or more cells of a cell cluster identified in the cluster information 1226). In some aspects, the measurements may be performed on a subset of the training data signals 1228, e.g., the transmissions from the cells identified as belonging to the one or more clusters indicated in the cluster information 1226 and/or particular transmissions (e.g., one or more of RS, SSB, data, etc.).

At 1264, the UE in the set of UEs 1204 (or the UE-side server 1206) may train one or more AI/ML models for the one or more cell clusters based on the measurements performed at 1230 on the training data signals 1228 (e.g., the data associated with the one or more cells of the cell cluster collected by the UE). In some aspects, the AI/ML model training may identify one or more cluster members for which training data does not improve the accuracy of a prediction by the AI/ML model and the UE may provide feedback for updating the cluster membership. The cluster membership, in some aspects, may not be updated and the data associated with the redundant and/or irrelevant cluster member may be ignored (e.g., not included in the input to the AI/ML model, or be associated with zero, or near-zero, weights, in the trained AI/ML model) while maintaining the same cluster membership. The training of the AI/ML may be associated with the aspects described in relation to at least FIGS. 5 and 6. In some aspects, the UE may provide the trained AI/ML model to the serving cell 1202 and the set of NEs 1208 and the UE and/or the serving cell 1202 (or the set of NEs 1208) may store the trained AI/ML models for one or more of additional training (e.g., refinement) as additional training data is received and/or for subsequent provision to additional UEs. For example, the serving cell 1202 may provide a trained and stored AI/ML model for a particular region and a particular prediction objective to UEs entering the particular region and associated with the particular prediction objective.

After training the one or more AI/ML models for the one or more cell clusters, the UE in the set of UEs 1204 may provide a trained AI/ML model to the serving cell 1202. The trained AI/ML model, in some aspects, may include a measurement configuration indicating the measurements associated with inputs to the AI/ML model and/or preprocessing associated with the AI/ML model. The measurement configuration (and the signals to be measured and/or the data to be collected for the inference), in some aspects, may be different from the training information, the training configuration, and/or the data collection configuration (and the signals to be measured and/or the data to be collected for training). In some aspects, the measurement configuration may be transmitted in a separate transmission/message associated with the trained AI/ML model. In some aspects, the UE may refine the AI/ML model as additional information and/or data is collected (as described in relation to refining the AI/ML model at 868 of FIG. 8). In some aspects, the AI/ML model training 1203 may be considered complete (for the purposes of this discussion) and the AI/ML model inference 1205 may begin at this point. The AI/ML model training 1203, and specifically the AI/ML model refinement, in some aspects, may be performed periodically, as new cell layout or cluster membership information is received, new training and/or measurement data is collected, and/or when a prediction accuracy falls below a threshold. In some aspects, the UE in the set of UEs 1204 may transmit, and the serving cell 1202 may receive, feedback (e.g., as described in relation to feedback 1069 of FIG. 10) based on the AI/ML refinement. Based on the received feedback, the serving cell 1202 may update a cluster membership (e.g., at 1224) as described in relation to the (periodic or event-triggered) repetition of cluster determination 1201 and proceed as described above.

If the serving cell 1202 and/or the set of NEs 1208 is responsible for training the AI/ML, the UE in the set of UEs 1204, may transmit, and the serving cell 1202 may receive, training data. The training data, in some aspects, may be raw measurement data based on the measurements performed at 1230 on the training data signals 1228 (e.g., the data associated with the one or more cells of the cell cluster collected by the UE). In some aspects, the training data, may be summarized or processed by the UE before being transmitted to the server 1206, where the processing may be indicated in the cluster information 1226 or the training information 1227 (e.g., in a reporting configuration associated with the training information, the training configuration, or the data collection configuration).

The cells in the cell cluster associated with the AI/ML model, may transmit one or more data collection signals 1270. The one or more measurement data signals, in some aspects, may include one or more of reference signals, data transmissions, or other transmissions that may be measured by a UE in the set of UEs 1204. Based on the AI/ML model (e.g., the measurement configuration), a UE in the set of UEs 1204 may, at 1272, perform one or more measurements on the data collection signals 1270 (e.g., may collect, based on the measurement configuration, data associated with one or more cells of a cell cluster identified in the cluster information 1226 and/or associated with the AI/ML model). In some aspects, the measurements may be performed on a subset of the data collection signals 1270, e.g., the transmissions from the cells identified as belonging to the one or more clusters indicated in the cluster information 1226 (or associated with the AI/ML model) and/or particular transmissions (e.g., one or more of RS, SSB, data, etc.).

Based on the measurements performed at 1272, the UE in the set of UEs 1204 may, at 1274, perform an AI/ML inference using the AI/ML model. For example, the UE may generate, based on the measurement data, a prediction for one or more AI/ML enabled features, feature groups, or functions associated with the cell cluster using the AI/ML model. In some aspects, the UE may, at 1276, perform an operation based on the inference (e.g., the prediction) performed at 1274.

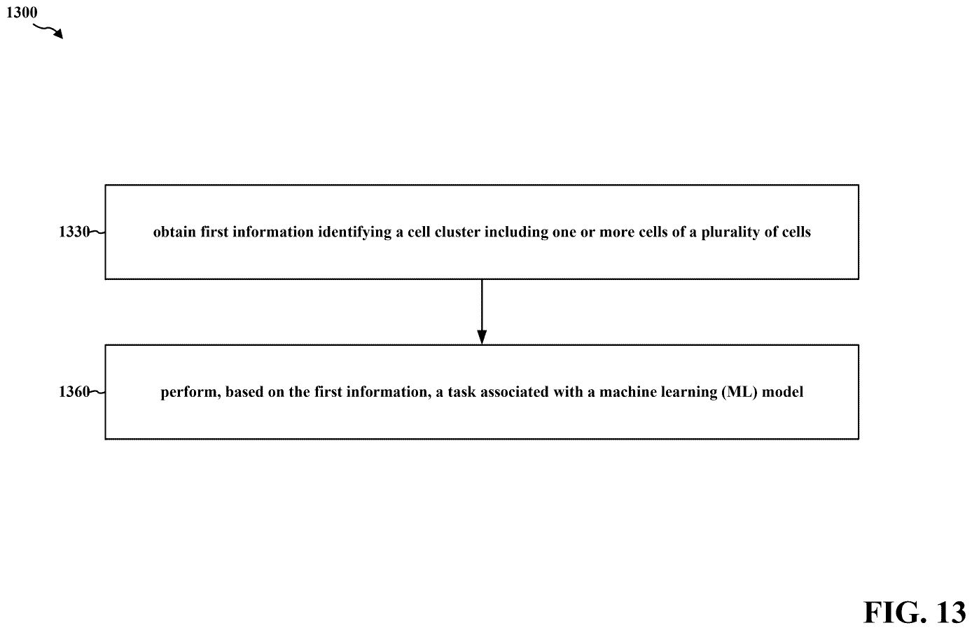

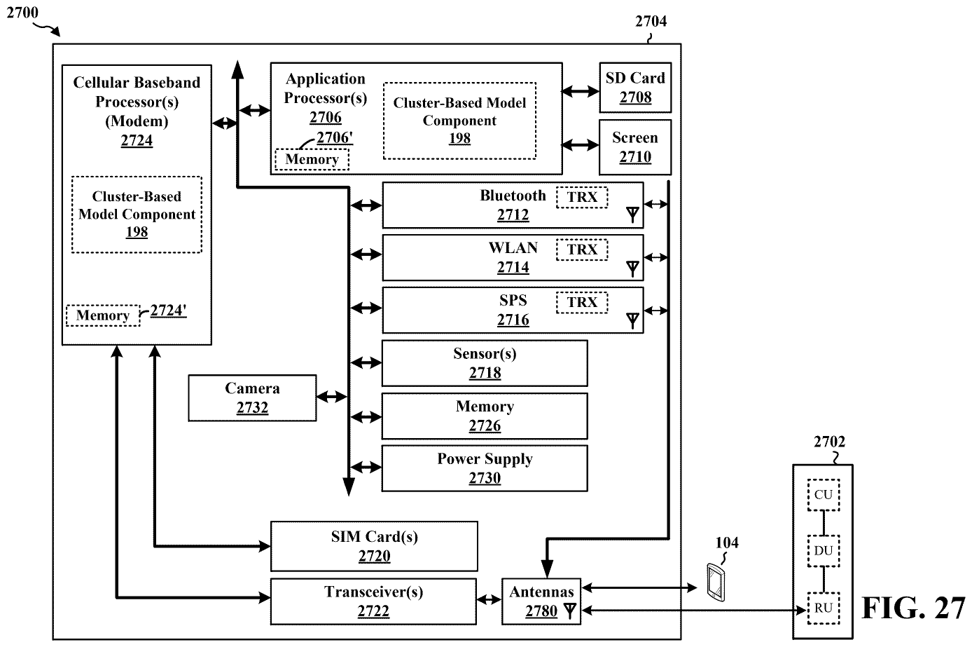

FIG. 13 is a flowchart 1300 of a method of wireless communication. The method may be performed by a UE (e.g., the UE 104, 404; the first wireless device 702; a UE in the set of UEs 804, 904, 1004, 1104, 1204; the apparatus 2704). At 1330, the UE may obtain first information identifying a cell cluster including one or more cells of a plurality of cells. In some aspects, the plurality of cells includes a serving cell and one or more neighboring cells. For example, 1330 may be performed by application processor(s) 2706, cellular baseband processor(s) 2724, transceiver(s) 2722, antenna(s) 2780, and/or cluster-based model component 198 of FIG. 27. In some aspects, the UE may have previously received, e.g., from the serving cell, second information regarding the plurality of cells, and where obtaining the first information identifying the cell cluster at 1330 may include generating the first information identifying the cell cluster based on the second information. Obtaining the first information identifying the cell cluster at 1330 may include receiving, from a server (e.g., a UE-side network entity) associated with a plurality of UEs, the first information identifying the cell cluster, where the plurality of UEs includes the UE, or receiving, from a network entity, the first information identifying the cell cluster. In some aspects, first information (e.g., the first information identifying a cell cluster) may include a data collection configuration. The first information identifying the cell cluster, in some aspects, may be associated with, or include, one or more of an identifier of the cell cluster, a HPLMN identifier, a third information regarding one or more ML enabled features, feature groups, or functions associated with the cell cluster (e.g., implemented, or associated with, one or more AI/ML models or ML models), or fourth information regarding an area scope (e.g., cell IDs and/or frequency [ARFCN]) associated with the cell cluster. In some aspects, may include at least one threshold for at least one corresponding KPI (e.g., related to a prediction accuracy) associated with an ML model associated with an identified cell cluster. For example, referring to FIGS. 8-12, a UE in a set of UEs (804/904/1004/1104/1204) may receive cluster information 856/1026/1126/1226 or determine a cluster membership at 954. At 1360, the UE may perform, based on the first information, a task associated with a machine ML model (e.g., an AI/ML model). In some aspects, performing the task associated with the ML model at 1360 may include one or more of training the ML model based on data associated with at least one cell of the cell cluster and/or generating, based on the data, a prediction for one or more ML enabled features, feature groups, or functions associated with the cell cluster using the ML model. Performing the task associated with the ML model at 1360, in some aspects, may include updating the ML model based on additional data (e.g., additional data collected while training the ML model and/or generating the prediction). For example, 1360 may be performed by application processor(s) 2706, cellular baseband processor(s) 2724, transceiver(s) 2722, antenna(s) 2780, and/or cluster-based model component 198 of FIG. 27. Referring to FIGS. 8-12, for example, a UE in a set of UEs (804/904/1004/1104/1204) may train an AI/ML model at 964/1164/1264, refine an AI/ML model at 868/1068, and/or perform an AI/ML inference using the AI/ML model at 874/974/1072/1172/1274.

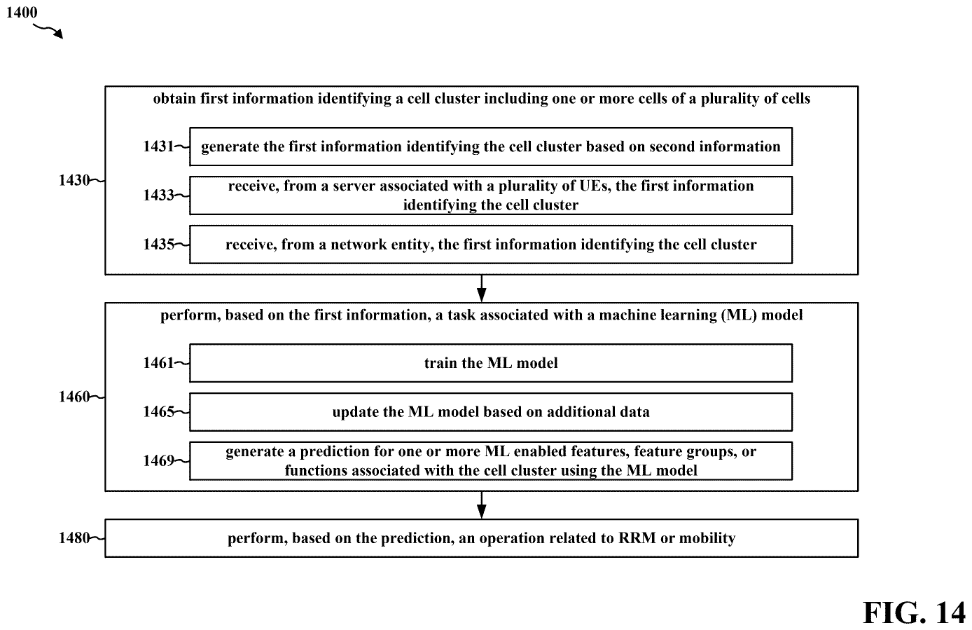

FIG. 14 is a flowchart 1400 of a method of wireless communication. The method may be performed by a UE (e.g., the UE 104, 404; the first wireless device 702; a UE in the set of UEs 804, 904, 1004, 1104, 1204; the apparatus 2704). At 1430, the UE may obtain first information identifying a cell cluster including one or more cells of a plurality of cells. In some aspects, the plurality of cells includes a serving cell and one or more neighboring cells. In some aspects, the UE may have previously received, e.g., from the serving cell, second information regarding the plurality of cells, and where obtaining the first information identifying the cell cluster at 1430 may include generating, at 1431, the first information identifying the cell cluster based on the second information. Obtaining the first information identifying the cell cluster at 1430 may include receiving, at 1433, from a server (e.g., a UE-side network entity) associated with a plurality of UEs, the first information identifying the cell cluster, where the plurality of UEs includes the UE, or receiving, at 1435, from a network entity, the first information identifying the cell cluster. For example, 1430, 1431, 1433, and 1435, may be performed by application processor(s) 2706, cellular baseband processor(s) 2724, transceiver(s) 2722, antenna(s) 2780, and/or cluster-based model component 198 of FIG. 27. The first information identifying the cell cluster, in some aspects, may be associated with, or include, one or more of an identifier of the cell cluster, a HPLMN identifier, a third information regarding one or more ML enabled features, feature groups, or functions associated with the cell cluster (e.g., implemented, or associated with, one or more AI/ML models or ML models), or fourth information regarding an area scope (e.g., cell IDs and/or frequency [absolute radio-frequency channel number (ARFCN)]) associated with the cell cluster. In some aspects, may include at least one threshold for at least one corresponding KPI (e.g., related to a prediction accuracy) associated with an ML model associated with an identified cell cluster. For example, referring to FIGS. 8-12, a UE in a set of UEs (804/904/1004/1104/1204) may receive cluster information 856/1026/1126/1226 or determine a cluster membership at 954.

At 1460, the UE may perform, based on the first information, a task associated with a machine ML model (e.g., an AI/ML model). In some aspects, performing the task associated with the ML model at 1460 may include one or more of training, at 1461, the ML model based on data associated with at least one cell of the cell cluster and/or generating, at 1469, based on the data, a prediction for one or more ML enabled features, feature groups, or functions associated with the cell cluster using the ML model. Performing the task associated with the ML model at 1460, in some aspects, may include updating, at 1465, the ML model based on additional data (e.g., additional data collected while training the ML model and/or generating the prediction). For example, 1460, 1461, 1465, and 1469 may be performed by application processor(s) 2706, cellular baseband processor(s) 2724, transceiver(s) 2722, antenna(s) 2780, and/or cluster-based model component 198 of FIG. 27. Referring to FIGS. 8-12, for example, a UE in a set of UEs (804/904/1004/1104/1204) may train an AI/ML model at 964/1164/1264, refine an AI/ML model at 868/1068, and/or perform an AI/ML inference using the AI/ML model at 874/974/1072/1172/1274.

At 1480, the UE may perform, based on the prediction, an operation related to RRM or mobility. In some aspects, the UE may perform a mobility operation such as a handover based on the prediction, or may identify a candidate cell for a handover and transmit a report and/or indication of the candidate cell for the handover to a current serving cell. For example, 1480 may be performed by application processor(s) 2706, cellular baseband processor(s) 2724, transceiver(s) 2722, antenna(s) 2780, and/or cluster-based model component 198 of FIG. 27. Referring to FIGS. 8-12, for example, a UE in a set of UEs (804/904/1004/1104/1204) may, at 876/976/1072/1172/1276, perform an operation based on the inference (e.g., the prediction) performed at 874/974/1072/1172/1274.

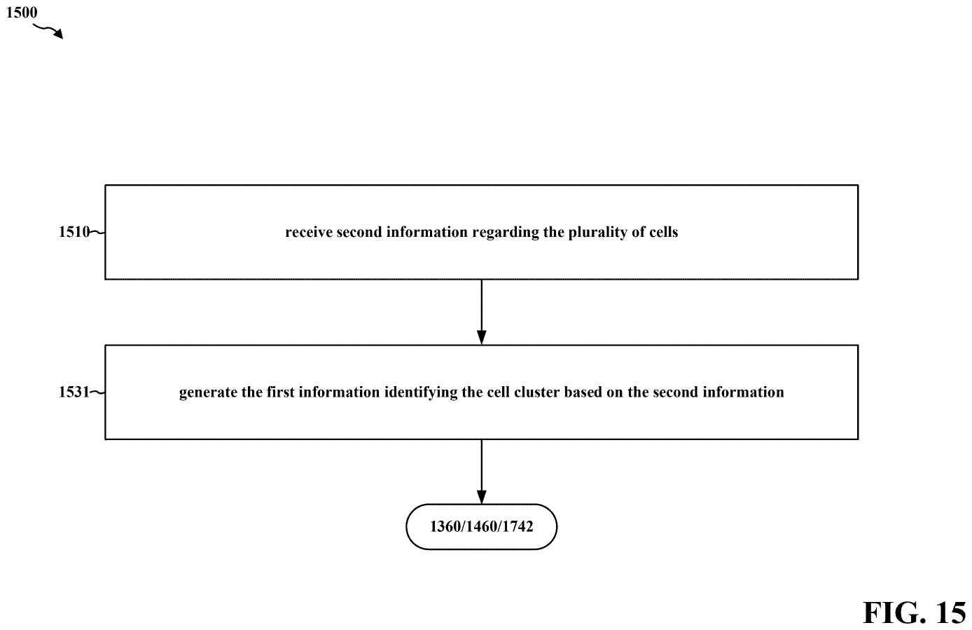

FIG. 15 is a flowchart 1500 of a method of wireless communication. The method may be performed by a UE (e.g., the UE 104, 404; the first wireless device 702; a UE in the set of UEs 804, 904, 1004, 1104, 1204; the apparatus 2704). At 1510, the UE may receive, from (at least) the serving cell, second information regarding the plurality of cells. For example, 1510 may be performed by application processor(s) 2706, cellular baseband processor(s) 2724, transceiver(s) 2722, antenna(s) 2780, and/or cluster-based model component 198 of FIG. 27. The second information, in some aspects, may be received, at least in part, via SI from the serving cell. In some aspects, the second information may, in part be received from one or more neighboring cells (e.g., via SI transmitted by the neighboring cells and received at the UE at 1510). For example, referring to FIGS. 8 and 9, a UE in a set of UEs (804/904) may receive SI 850/950.

At 1531, the UE may generate the first information identifying the cell cluster based on the second information. In some aspects, the plurality of cells comprises a serving cell and one or more neighboring cells. For example, 1531 may be performed by application processor(s) 2706, cellular baseband processor(s) 2724, transceiver(s) 2722, antenna(s) 2780, and/or cluster-based model component 198 of FIG. 27. In some aspects, generating the first information at 1531 may correspond to generating the first information at 1331 or 1431 of FIGS. 13 and 14. For example, referring to FIG. 9, a UE in a set of UEs (904) may determine a cluster membership at 954. The method illustrated in flowchart 1500, e.g., generating the first information at 1531, may be followed by one of 1360, 1460, or 1742 of FIGS. 13, 14, and 17, respectively.

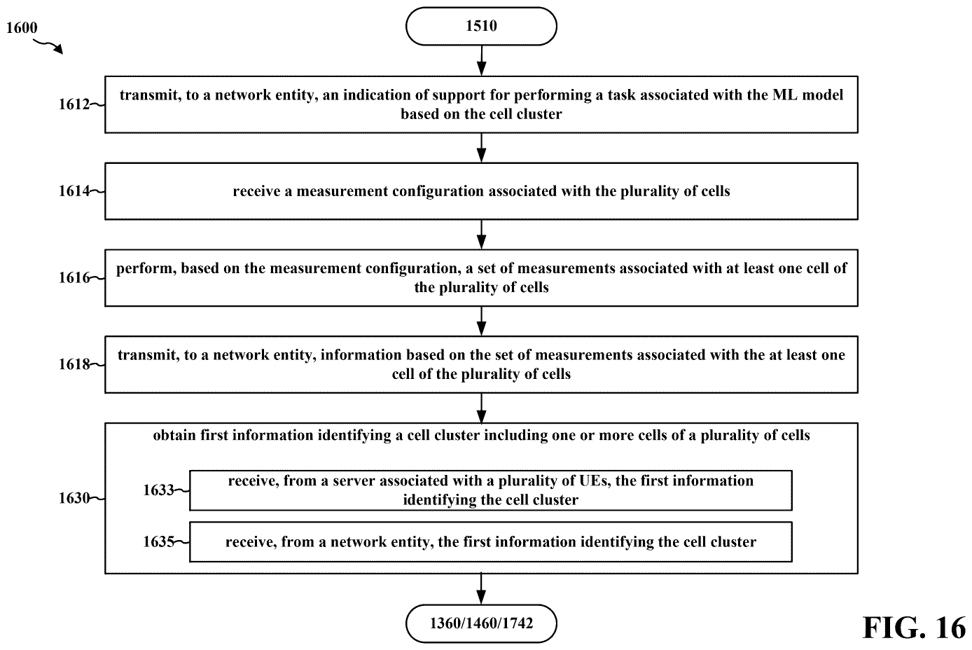

FIG. 16 is a flowchart 1600 of a method of wireless communication. The method may be performed by a UE (e.g., the UE 104, 404; the first wireless device 702; a UE in the set of UEs 804, 904, 1004, 1104, 1204; the apparatus 2704). The flowchart 1600, in some aspects, may follow after receiving, from (at least) the serving cell, second information regarding the plurality of cells at 1510 of FIG. 15. At 1612, the UE may transmit, to a network entity, an indication of support for performing (e.g., at 1360/1460/1461/1465/1469/1760/1761/1769/1860/1865/1869 of FIGS. 13, 16, 17, and 18) the task associated with the ML model based on the cell cluster. The indication of the support may be associated with, or transmitted via, one of a UE capability message, a UE assistance information message, or a RRC message. For example, 1612 may be performed by application processor(s) 2706, cellular baseband processor(s) 2724, transceiver(s) 2722, antenna(s) 2780, and/or cluster-based model component 198 of FIG. 27. The indication of the support, in some aspects, may include one or more of: a first indication of support for a first maximum number of measured cells for one of (i) each cell cluster in a plurality of identified cell clusters or (ii) the plurality of identified cell clusters; a second indication of support for a second maximum number of measured carrier frequencies for one of (i) each cell cluster in the plurality of identified cell clusters or (ii) the plurality of identified cell clusters; or a third indication of support for a third maximum number of predictions for one of (i) each cell cluster in the plurality of identified cell clusters or (ii) the plurality of identified cell clusters. In some aspects, first information (e.g., the first information obtained at 1330/1430) identifying a cell cluster including one or more cells of a plurality of cells may be based on the indication of the support. For example, referring to FIG. 10, a UE in the set of UEs 1004 may transmit the UE capability indication 1010.

At 1614, the UE may receive a measurement configuration associated with the plurality of cells. In some aspects, the plurality of cells includes a serving cell and one or more neighboring cells. For example, 1614 may be performed by application processor(s) 2706, cellular baseband processor(s) 2724, transceiver(s) 2722, antenna(s) 2780, and/or cluster-based model component 198 of FIG. 27. In some aspects, the measurement configuration may be received from a network entity (e.g., one of a UE-side network entity such as a UE-side server, or a network-side network entity such as one of a network function, an OAM entity, a base station, or a RAN (or NG RAN) node). Referring to FIGS. 10 and 11, a UE in a set of UEs (1004/1104) may receive a measurement configuration 1014/1114.

At 1616, the UE may perform, based on the measurement configuration, a set of measurements associated with at least one cell of the plurality of cells. For example, 1616 may be performed by application processor(s) 2706, cellular baseband processor(s) 2724, transceiver(s) 2722, antenna(s) 2780, and/or cluster-based model component 198 of FIG. 27. Referring to FIGS. 10 and 11, a UE in a set of UEs (1004/1104) may, at 1020/1120, perform one or more measurements on the measurement data signals 1018/1118.

At 1618, the UE may transmit, to a network entity, information based on the set of measurements associated with the at least one cell of the plurality of cells. For example, 1618 may be performed by application processor(s) 2706, cellular baseband processor(s) 2724, transceiver(s) 2722, antenna(s) 2780, and/or cluster-based model component 198 of FIG. 27. Referring to FIGS. 10 and 11, a UE in a set of UEs (1004/1104) may transmit measurement information 1022/1122 to a server 1008/1108 or a NE in the set of NEs 1002/1102 (or a UE in a set of UEs 804 may transmit measurement information to a server 806).

At 1630, the UE may obtain first information identifying a cell cluster including one or more cells of a plurality of cells. In some aspects, the plurality of cells includes a serving cell and one or more neighboring cells. In some aspects, obtaining the first information identifying the cell cluster at 1630 may include receiving, at 1633, from a server (e.g., a UE-side network entity) associated with a plurality of UEs, the first information identifying the cell cluster, where the plurality of UEs includes the UE, or receiving, at 1635, from a network entity, the first information identifying the cell cluster. For example, 1630, 1633, and 1635, may be performed by application processor(s) 2706, cellular baseband processor(s) 2724, transceiver(s) 2722, antenna(s) 2780, and/or cluster-based model component 198 of FIG. 27. The first information identifying the cell cluster, in some aspects, may be associated with, or include, one or more of an identifier of the cell cluster, a HPLMN identifier, a third information regarding one or more ML enabled features, feature groups, or functions associated with the cell cluster (e.g., implemented, or associated with, one or more AI/ML models or ML models), or fourth information regarding an area scope (e.g., cell IDs and/or frequency [ARFCN]) associated with the cell cluster. In some aspects, may include at least one threshold for at least one corresponding KPI (e.g., related to a prediction accuracy) associated with an ML model associated with an identified cell cluster. For example, referring to FIGS. 8 and 10-12, a UE in a set of UEs (804/1004/1104/1204) may receive cluster information 856/1026/1126/1226. The method illustrated in flowchart 1600, e.g., obtaining the first information at 1630, may be followed by one of 1360, 1460, or 1742 of FIGS. 13, 14, and 17, respectively.

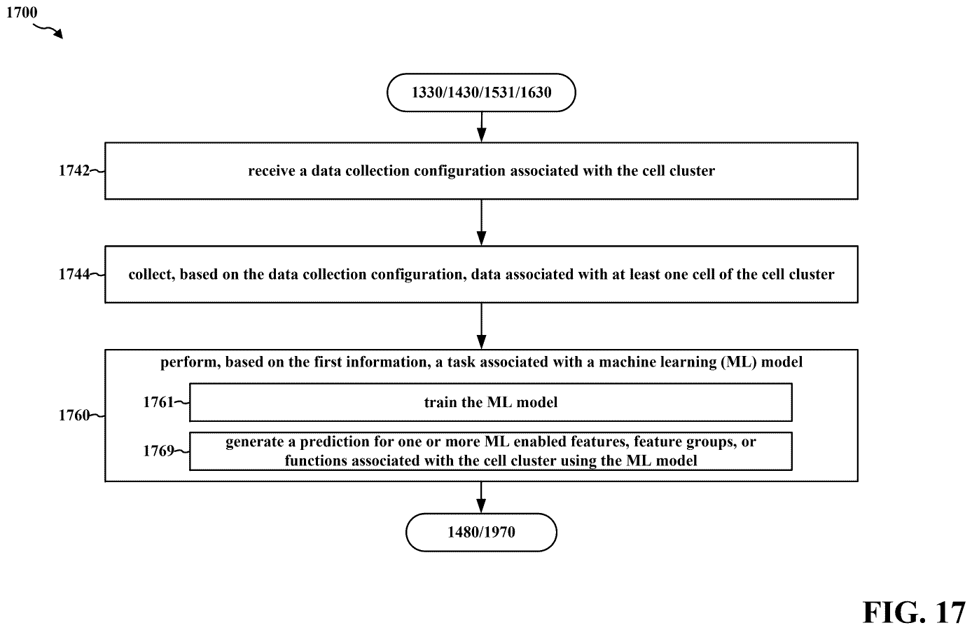

FIG. 17 is a flowchart 1700 of a method of wireless communication. The method may be performed by a UE (e.g., the UE 104, 404; the first wireless device 702; a UE in the set of UEs 804, 904, 1004, 1104, 1204; the apparatus 2704). The flowchart 1700, in some aspects, may follow obtaining the first information at 1330/1430/1531/1630 of FIGS. 13, 14, 15, and 16. At 1742, the UE may receive a data collection configuration associated with the cell cluster. For example, 1742 may be performed by application processor(s) 2706, cellular baseband processor(s) 2724, transceiver(s) 2722, antenna(s) 2780, and/or cluster-based model component 198 of FIG. 27. In some aspects, the data collection configuration may be received from a network entity (e.g., one of a UE-side network entity such as a UE-side server, or a network-side network entity such as one of a network function, an OAM entity, a base station, or a RAN (or NG RAN) node). Referring to FIGS. 8 and 10-12, for example, a UE in a set of UEs (804/1004/1104/1204) may receive cluster information 856/1026/1126 (including a data collection configuration), a trained AI/ML model 866/1036 (including a data collection configuration), or training information 1227 (including a data collection configuration).

At 1744, the UE may collect, based on the data collection configuration, data associated with at least one cell of the cell cluster. For example, 1744 may be performed by application processor(s) 2706, cellular baseband processor(s) 2724, transceiver(s) 2722, antenna(s) 2780, and/or cluster-based model component 198 of FIG. 27. Referring to FIGS. 8 and 10-12, for example, a UE in a set of UEs (804/1004/1104/1204) may, at 860/1030/1130/1230, perform one or more measurements on the training data signals 858/1028/1128/1228, or may, at 872/1072/1172/1272, perform one or more measurements on the data collection signals 870/1270.

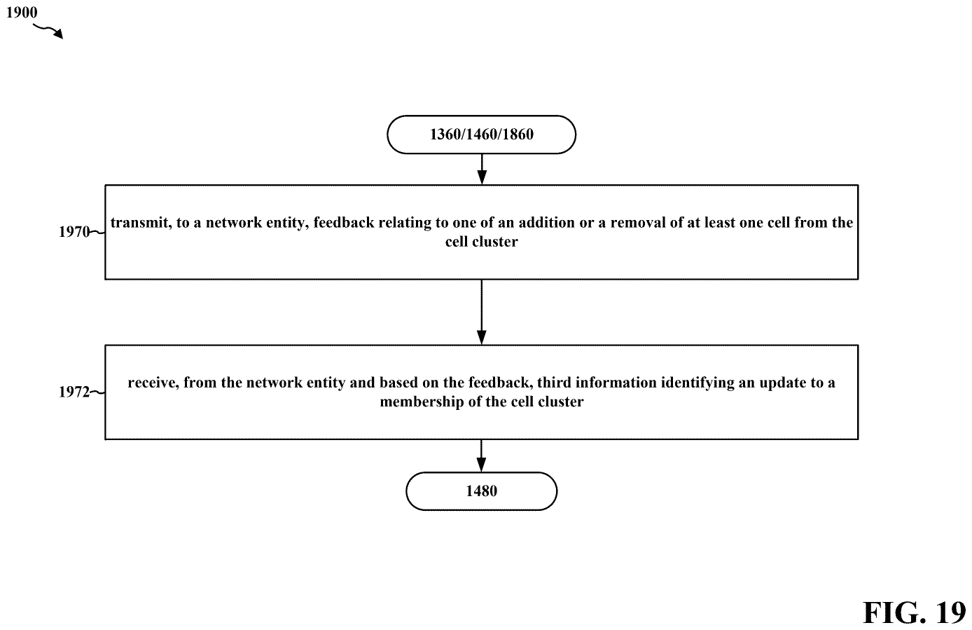

At 1760, the UE may perform, based on the first information, a task associated with a machine ML model (e.g., an AI/ML model). In some aspects, performing the task associated with the ML model at 1760 may include one or more of training, at 1761, the ML model based on data associated with at least one cell of the cell cluster (e.g., the data collected at 1744) and/or generating, at 1769, based on the data, a prediction for one or more ML enabled features, feature groups, or functions associated with the cell cluster using the ML model. For example, 1760, 1761, and 1769 may be performed by application processor(s) 2706, cellular baseband processor(s) 2724, transceiver(s) 2722, antenna(s) 2780, and/or cluster-based model component 198 of FIG. 27. Referring to FIGS. 8 and 10-12, for example, a UE in a set of UEs (804/1004/1104/1204) may train an AI/ML model at 1164/1264 and/or perform an AI/ML inference using the AI/ML model at 874/1072/1172/1274. The method illustrated in flowchart 1700, e.g., performing the task associated with the ML model at 1760, may be followed by one of 1480 or 1970 of FIGS. 14 and 19, respectively.

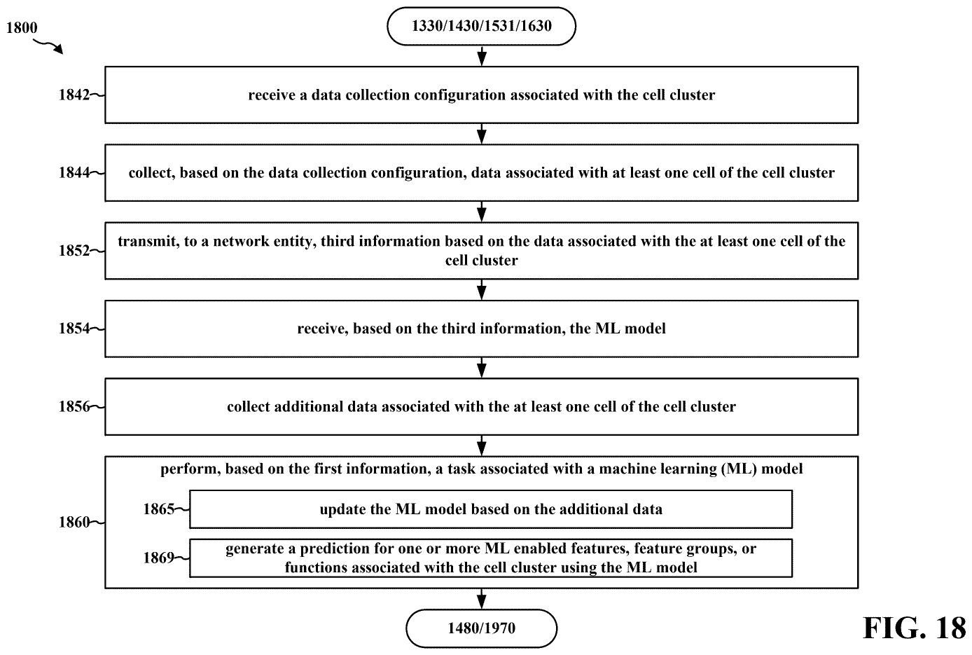

FIG. 18 is a flowchart 1800 of a method of wireless communication. The method may be performed by a UE (e.g., the UE 104, 404; the first wireless device 702; a UE in the set of UEs 804, 904, 1004, 1104, 1204; the apparatus 2704). The flowchart 1800, in some aspects, may follow obtaining the first information at 1330/1430/1531/1630 of FIGS. 13, 14, 15, and 16. At 1842, the UE may receive a data collection configuration associated with the cell cluster. For example, 1842 may be performed by application processor(s) 2706, cellular baseband processor(s) 2724, transceiver(s) 2722, antenna(s) 2780, and/or cluster-based model component 198 of FIG. 27. In some aspects, the data collection configuration may be received from a network entity (e.g., one of a UE-side network entity such as a UE-side server, or a network-side network entity such as one of a network function, an OAM entity, a base station, or a RAN (or NG RAN) node). Referring to FIGS. 8 and 10, for example, a UE in a set of UEs (804/1004) may receive cluster information 856/1026/(including a data collection configuration).

At 1844, the UE may collect, based on the data collection configuration, data associated with at least one cell of the cell cluster. For example, 1844 may be performed by application processor(s) 2706, cellular baseband processor(s) 2724, transceiver(s) 2722, antenna(s) 2780, and/or cluster-based model component 198 of FIG. 27. Referring to FIGS. 8 and 10, for example, a UE in a set of UEs (804/1004) may, at 860/1030, perform one or more measurements on the training data signals 858/1028.

At 1852, the UE may transmit, to a network entity, third information based on the data associated with the at least one cell of the cell cluster. For example, 1852 may be performed by application processor(s) 2706, cellular baseband processor(s) 2724, transceiver(s) 2722, antenna(s) 2780, and/or cluster-based model component 198 of FIG. 27. Referring to FIGS. 8 and 10, for example, a UE in a set of UEs (804/1004) may transmit training data 862/1032.

At 1854, the UE may receive, based on the third information, the ML model. For example, 1854 may be performed by application processor(s) 2706, cellular baseband processor(s) 2724, transceiver(s) 2722, antenna(s) 2780, and/or cluster-based model component 198 of FIG. 27. Referring to FIGS. 8 and 10, for example, a UE in a set of UEs (804/1004) may receive trained AI/ML model 866/1036.

At 1856, the UE may collect additional data associated with the at least one cell of the cell cluster. For example, 1856 may be performed by application processor(s) 2706, cellular baseband processor(s) 2724, transceiver(s) 2722, antenna(s) 2780, and/or cluster-based model component 198 of FIG. 27. Referring to FIGS. 8 and 10, for example, a UE in a set of UEs (804/1004) may, at 872/1072, perform one or more measurements on the data collection signals 870.

At 1860, the UE may perform, based on the first information, a task associated with a machine ML model (e.g., an AI/ML model). In some aspects, performing the task associated with the ML model at 1860 may include one or more of updating, at 1865, the ML model based on the additional data (e.g., additional data collected at 1856 while training the ML model and/or generating the prediction) and/or generating, at 1869, based on the data, a prediction for one or more ML enabled features, feature groups, or functions associated with the cell cluster using the ML model. For example, 1860, 1865, and 1869 may be performed by application processor(s) 2706, cellular baseband processor(s) 2724, transceiver(s) 2722, antenna(s) 2780, and/or cluster-based model component 198 of FIG. 27. Referring to FIGS. 8 and 10, for example, a UE in a set of UEs (804/1004) may refine an AI/ML model at 868/1068, and/or perform an AI/ML inference using the AI/ML model at 874/1072. The method illustrated in flowchart 1800, e.g., performing the task associated with the ML model at 1860, may be followed by one of 1480 or 1970 of FIGS. 14 and 19, respectively.

FIG. 19 is a flowchart 1900 of a method of wireless communication. The method may be performed by a UE (e.g., the UE 104, 404; the first wireless device 702; a UE in the set of UEs 804, 904, 1004, 1104, 1204; the apparatus 2704). The flowchart 1900, in some aspects, may follow performing the task associated with the ML model at 1360/1460/1860 of FIGS. 13, 14, and 18. At 1970, the UE may transmit, to a network entity, feedback relating to one of an addition or a removal of at least one cell from the cell cluster. In some aspects, the feedback is based on the at least one threshold for the at least one corresponding KPI (e.g., included in the first information obtained at 1330/1430/1860). For example, 1970 may be performed by application processor(s) 2706, cellular baseband processor(s) 2724, transceiver(s) 2722, antenna(s) 2780, and/or cluster-based model component 198 of FIG. 27. Referring to FIG. 10, for example, a UE in a set of UEs 1004 may transmit feedback 1069 (e.g., based on the AI/ML refinement at 1068).

At 1972, the UE may receive, from the network entity and based on the feedback, third information identifying an update to a membership of the cell cluster. For example, 1972 may be performed by application processor(s) 2706, cellular baseband processor(s) 2724, transceiver(s) 2722, antenna(s) 2780, and/or cluster-based model component 198 of FIG. 27. Referring to FIG. 10, for example, the server 1008 may update a cluster membership (e.g., at 1024) as described in relation to the (periodic or event-triggered) repetition of cluster determination 1001 and a UE in a set of UEs 1004 may receive updated cluster information 1026. The method illustrated in flowchart 1900, e.g., performing the task associated with the ML model at 1972, may be followed by one of 1480 of FIG. 14.

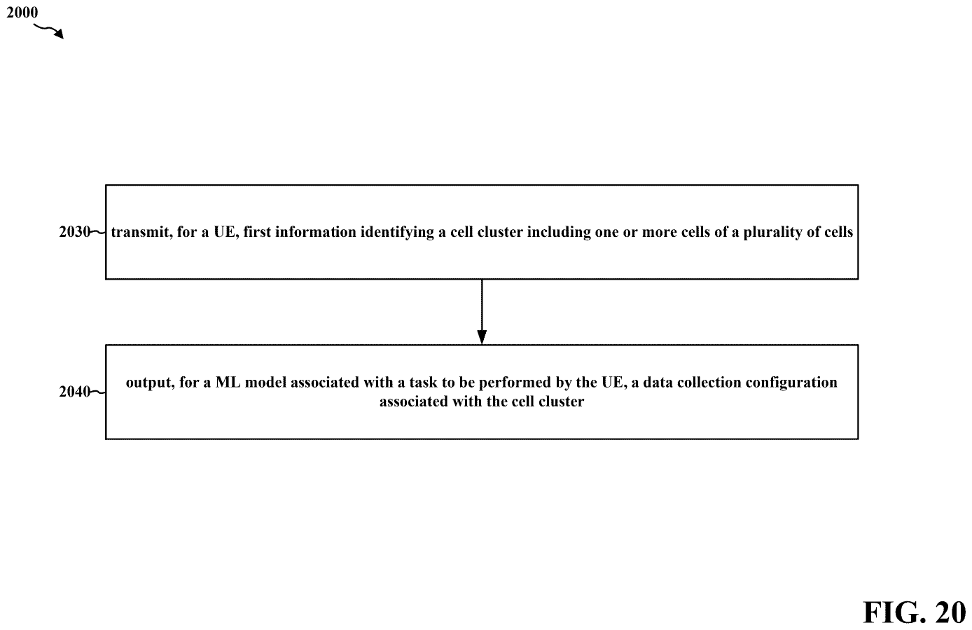

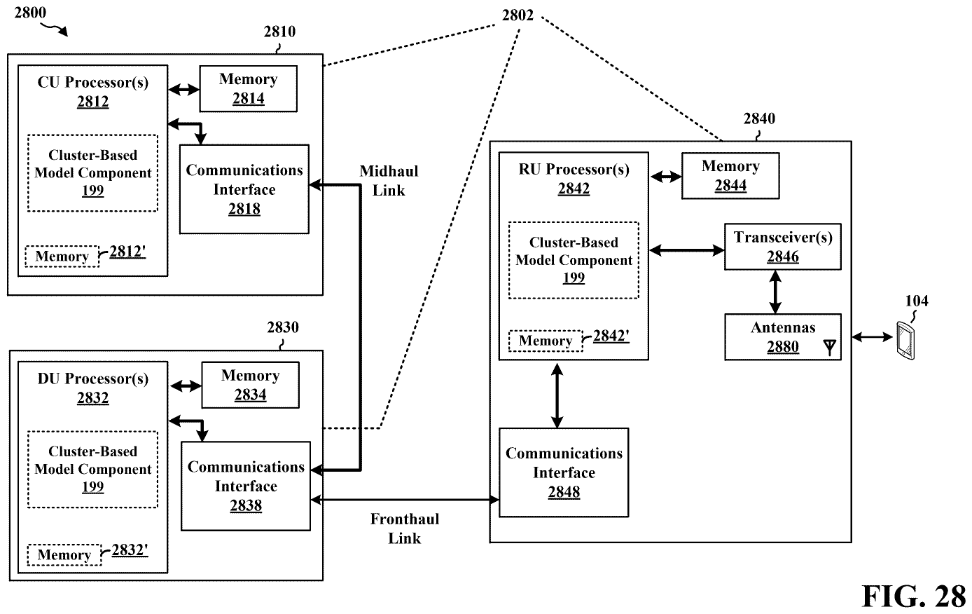

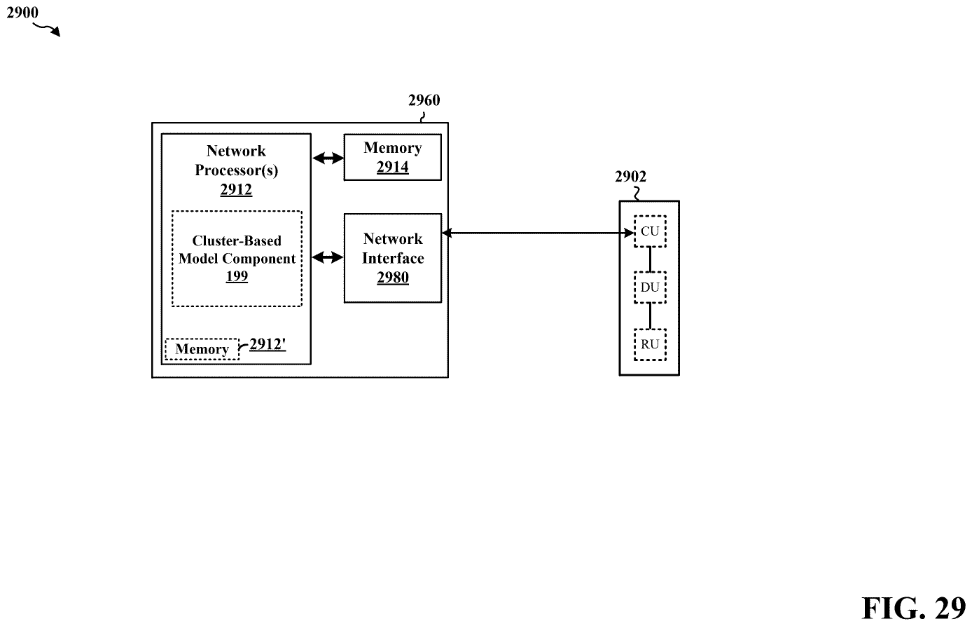

FIG. 20 is a flowchart 2000 of a method of wireless communication. The method may be performed by a network entity such as a UE-side network entity such as a UE-side server, or a network-side network entity such as one of a network function, an OAM entity, a base station, or a RAN (or NG RAN) node (e.g., the base station 102, 406; a serving cell 1202; an NE in the set of NEs 802, 902, 1002, 1102, 1208; the server 806; the server 1008, 1108; the network entity 2702, 2802, 2960). At 2030, the network entity may transmit, for a UE, first information identifying a cell cluster comprising one or more cells of a plurality of cells. For example, 2030 may be performed by CU processor(s) 2812, DU processor(s) 2832, RU processor(s) 2842, transceiver(s) 2846, antenna(s) 2880, network processor 2912, network interface 2980, and/or cluster-based model component 199 of FIGS. 28 and 29. In some aspects, first information (e.g., the first information identifying a cell cluster) may include a data collection configuration. The first information identifying the cell cluster, in some aspects, may be associated with, or include, one or more of an identifier of the cell cluster, a HPLMN identifier, a third information regarding one or more ML enabled features, feature groups, or functions associated with the cell cluster (e.g., implemented, or associated with, one or more AI/ML models or ML models), or fourth information regarding an area scope (e.g., cell IDs and/or frequency [ARFCN]) associated with the cell cluster. In some aspects, may include at least one threshold for at least one corresponding KPI (e.g., related to a prediction accuracy) associated with an ML model associated with an identified cell cluster. In some aspects, the first information may be transmitted via SI. For example, referring to FIGS. 8 and 10-12, a server 806, a serving cell 1202, a server 1008/1108, may transmit cluster information 856/1026/1126/1226.

At 2040, the network entity may output, for a ML model associated with a task to be performed by the UE, a data collection configuration associated with the cell cluster. For example, 2040 may be performed by CU processor(s) 2812, DU processor(s) 2832, RU processor(s) 2842, transceiver(s) 2846, antenna(s) 2880, network processor 2912, network interface 2980, and/or cluster-based model component 199 of FIGS. 28 and 29. Referring to FIGS. 8 and 10-12, for example, a server 806, a serving cell 1202, a server 1008/1108, may transmit cluster information 856/1026/1126 (including a data collection configuration), a trained AI/ML model 866/1036 (including a data collection configuration), or training information 1227 (including a data collection configuration).

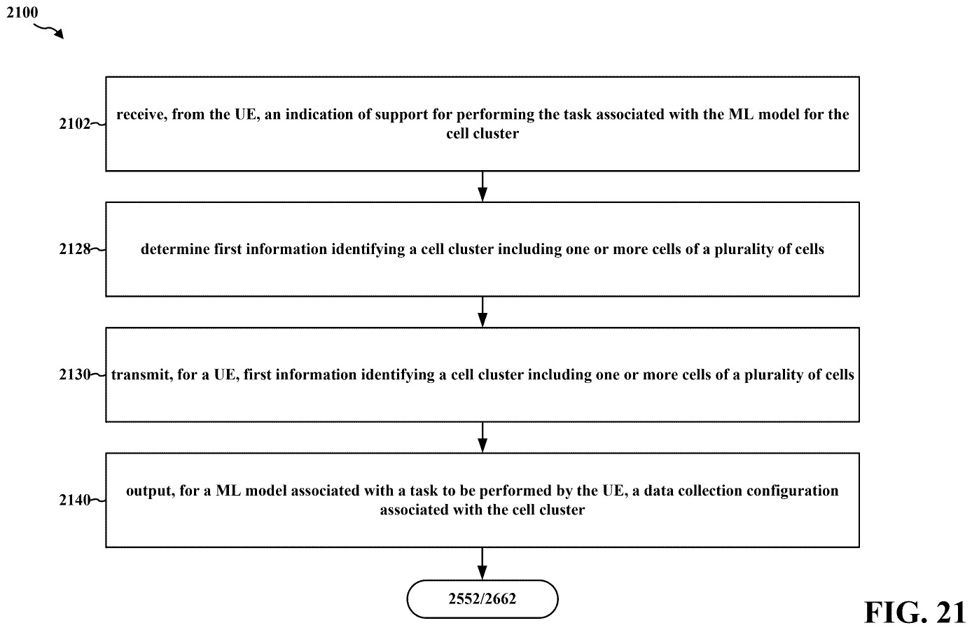

FIG. 21 is a flowchart 2100 of a method of wireless communication. The method may be performed by a network entity such as a UE-side network entity such as a UE-side server, or a network-side network entity such as one of a network function, an OAM entity, a base station, or a RAN (or NG RAN) node (e.g., the base station 102, 406; a serving cell 1202; an NE in the set of NEs 802, 902, 1002, 1102, 1208; the server 806; the server 1008, 1108; the network entity 2702, 2802, 2960). At 2102, the network entity may receive, from the UE, an indication of support for performing the task associated with the ML model for the cell cluster. For example, 2102 may be performed by CU processor(s) 2812, DU processor(s) 2832, RU processor(s) 2842, transceiver(s) 2846, antenna(s) 2880, network processor 2912, network interface 2980, and/or cluster-based model component 199 of FIGS. 28 and 29. The indication of the support, in some aspects, may include one or more of: a first indication of support for a first maximum number of measured cells for one of (i) each cell cluster in a plurality of identified cell clusters or (ii) the plurality of identified cell clusters; a second indication of support for a second maximum number of measured carrier frequencies for one of (i) each cell cluster in the plurality of identified cell clusters or (ii) the plurality of identified cell clusters; or a third indication of support for a third maximum number of predictions for one of (i) each cell cluster in the plurality of identified cell clusters or (ii) the plurality of identified cell clusters. In some aspects, first information (e.g., the first information obtained at 2030) identifying a cell cluster including one or more cells of a plurality of cells may be based on the indication of the support. In some aspects, the indication of the support may be associated with one of a UE capability message, a UE assistance information message, or a RRC message. For example, referring to FIG. 10, the server 1008 may receive the UE capability indication 1010.

At 2128, the network entity may determine first information identifying a cell cluster including one or more cells of a plurality of cells. For example, 2128 may be performed by CU processor(s) 2812, DU processor(s) 2832, RU processor(s) 2842, transceiver(s) 2846, antenna(s) 2880, network processor 2912, network interface 2980, and/or cluster-based model component 199 of FIGS. 28 and 29. In some aspects, the first information may be determined based on the indication of the support received at 2102. The first information, in some aspects, may include a cluster membership identifying one or more of a plurality of cells included in the cell cluster. The plurality of cells, in some aspects, may include a serving cell and one or more neighboring cells. For example, referring to FIGS. 10-12, the server 1008/1108 or the serving cell 1202 and the set of NEs 1208 may determine, at 1024, one or more cluster memberships for one or more AI/ML models and/or tasks (e.g., prediction objectives) associated with the AI/ML models.

At 2130, the network entity may transmit, for a UE, first information identifying a cell cluster comprising one or more cells of the plurality of cells. For example, 2130 may be performed by CU processor(s) 2812, DU processor(s) 2832, RU processor(s) 2842, transceiver(s) 2846, antenna(s) 2880, network processor 2912, network interface 2980, and/or cluster-based model component 199 of FIGS. 28 and 29. In some aspects, first information (e.g., the first information identifying a cell cluster) may include a data collection configuration. The first information identifying the cell cluster, in some aspects, may be associated with, or include, one or more of an identifier of the cell cluster, a HPLMN identifier, a third information regarding one or more ML enabled features, feature groups, or functions associated with the cell cluster (e.g., implemented, or associated with, one or more AI/ML models or ML models), or fourth information regarding an area scope (e.g., cell IDs and/or frequency [ARFCN]) associated with the cell cluster. In some aspects, may include at least one threshold for at least one corresponding KPI (e.g., related to a prediction accuracy) associated with an ML model associated with an identified cell cluster. In some aspects, the first information may be transmitted via SI. For example, referring to FIGS. 8 and 10-12, a server 806, a serving cell 1202, a server 1008/1108, may transmit cluster information 856/1026/1126/1226.

At 2140, the network entity may output, for a ML model associated with a task to be performed by the UE, a data collection configuration associated with the cell cluster.

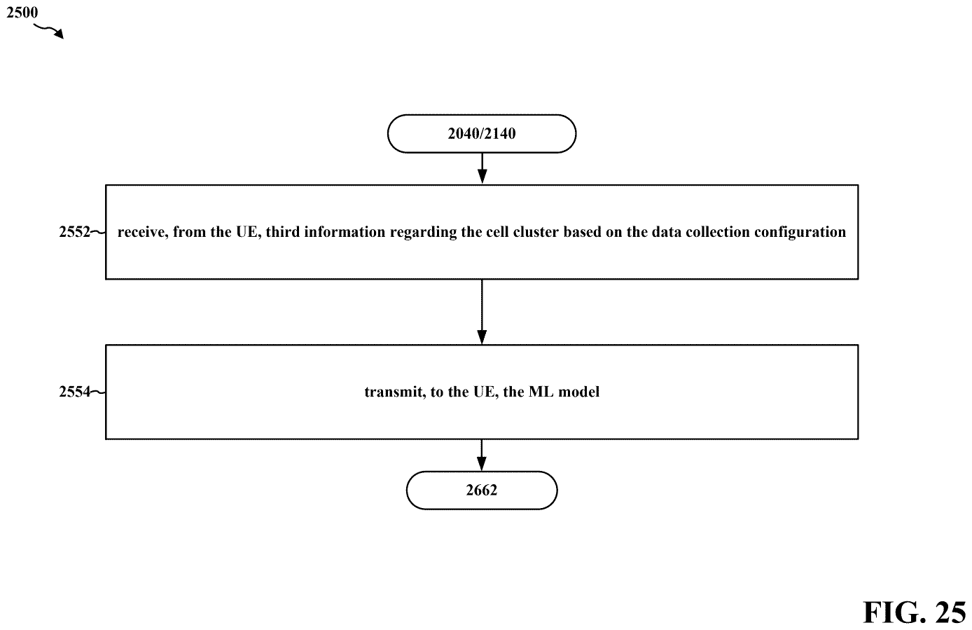

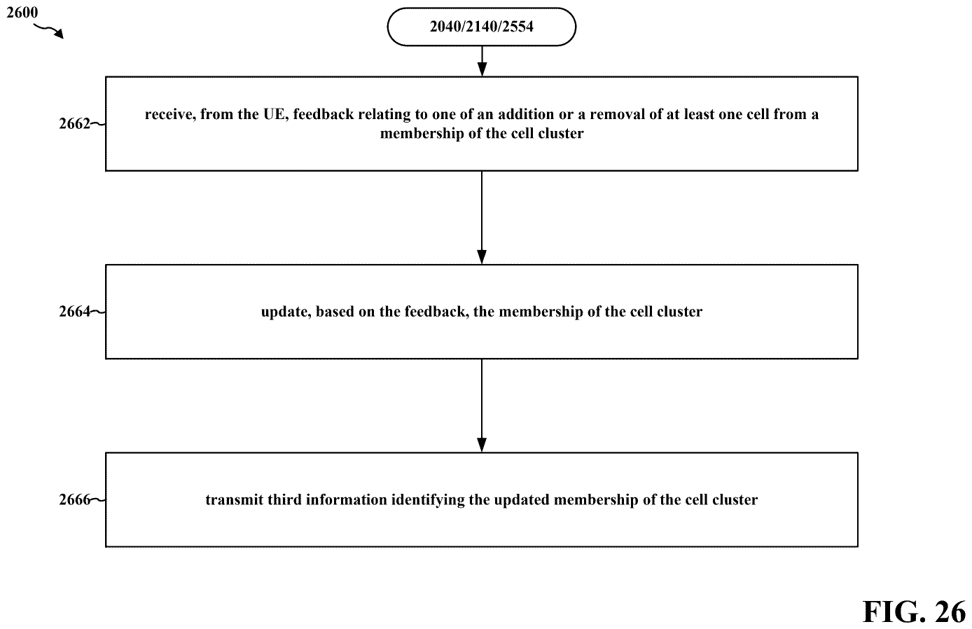

For example, 2140 may be performed by CU processor(s) 2812, DU processor(s) 2832, RU processor(s) 2842, transceiver(s) 2846, antenna(s) 2880, network processor 2912, network interface 2980, and/or cluster-based model component 199 of FIGS. 28 and 29. Referring to FIGS. 8 and 10-12, for example, a server 806, a serving cell 1202, a server 1008/1108, may transmit cluster information 856/1026/1126 (including a data collection configuration), a trained AI/ML model 866/1036 (including a data collection configuration), or training information 1227 (including a data collection configuration). The method illustrated in flowchart 2100, e.g., outputting the data collection configuration at 2140, may be followed by one of 2552 or 2662 of FIG. 25 or 26, respectively.

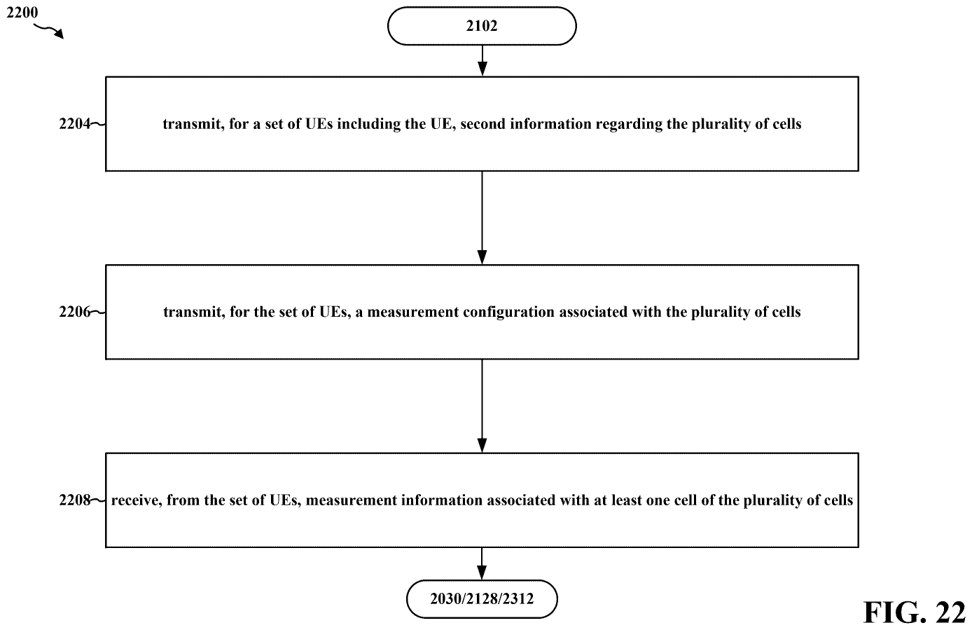

FIG. 22 is a flowchart 2200 of a method of wireless communication. The method may be performed by a network entity such as a UE-side network entity such as a UE-side server, or a network-side network entity such as one of a network function, an OAM entity, a base station, or a RAN (or NG RAN) node (e.g., the base station 102, 406; a serving cell 1202; an NE in the set of NEs 802, 902, 1002, 1102, 1208; the server 806; the server 1008, 1108; the network entity 2702, 2802, 2960). The flowchart 2200, in some aspects, may follow after receiving, from the UE, an indication of support for performing the task associated with the ML model for the cell cluster at 2102 of FIG. 21. At 2204, the network entity may transmit for a set of UEs comprising the UE, second information regarding the plurality of cells. For example, 2204 may be performed by CU processor(s) 2812, DU processor(s) 2832, RU processor(s) 2842, transceiver(s) 2846, antenna(s) 2880, network processor 2912, network interface 2980, and/or cluster-based model component 199 of FIGS. 28 and 29. The second information, in some aspects, may be transmitted via one or more of SI or dedicated signaling. For example, referring to FIGS. 8 and 9, an NE in a set of UEs (804/904) may transmit SI 850/950.

At 2206, the NE may transmit, for the set of UEs, a measurement configuration associated with the plurality of cells. In some aspects, the plurality of cells includes a serving cell and one or more neighboring cells. For example, 2206 may be performed by CU processor(s) 2812, DU processor(s) 2832, RU processor(s) 2842, transceiver(s) 2846, antenna(s) 2880, network processor 2912, network interface 2980, and/or cluster-based model component 199 of FIGS. 28 and 29. Referring to FIGS. 10 and 11, a server 1008/1108 may transmit a measurement configuration 1014/1114.

At 2208, the NE may receive, from the set of UEs, measurement information associated with at least one cell of the plurality of cells. For example, 2208 may be performed by CU processor(s) 2812, DU processor(s) 2832, RU processor(s) 2842, transceiver(s) 2846, antenna(s) 2880, network processor 2912, network interface 2980, and/or cluster-based model component 199 of FIGS. 28 and 29. In some aspects, a membership of the cell cluster (e.g., the first information transmitted at 2030/2130 may be determined) based on the measurement information. Referring to FIGS. 8, 10, and 11, a UE in a set of UEs (1004/1104) may transmit measurement information 1022/1122 to a server 1008/1108 or a NE in the set of NEs 1002/1102 (or a UE in a set of UEs 804 may transmit measurement information to a server 806). The method illustrated in flowchart 2200, e.g., receiving the measurement information at 2208, may be followed by one of 2030, 2128, 2312 of FIGS. 20, 21, and 23, respectively. In some aspects, the determination at 2128 may be based on the measurement information received at 2208.

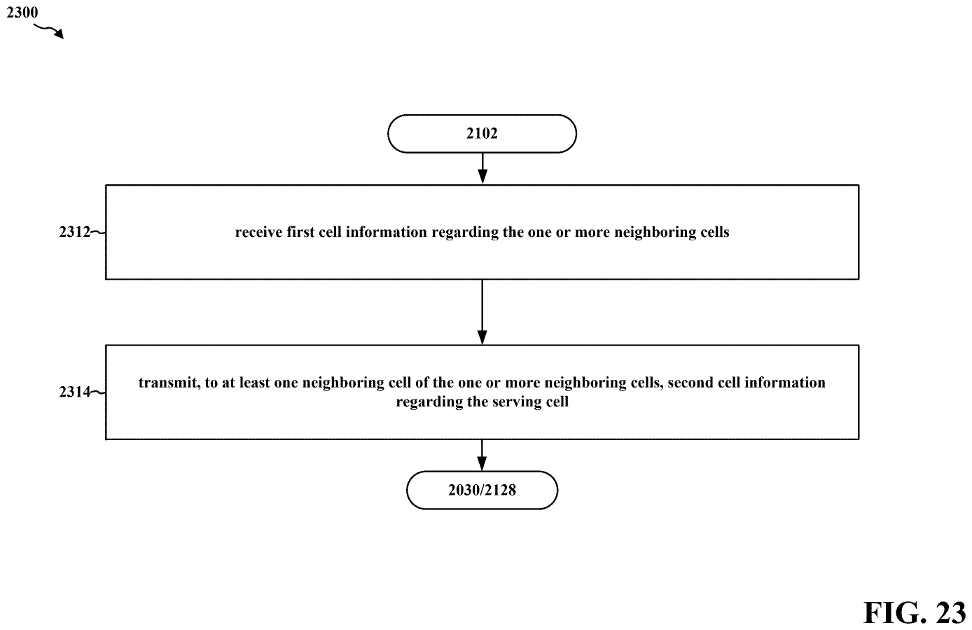

FIG. 23 is a flowchart 2300 of a method of wireless communication. The method may be performed by a network entity such as a UE-side network entity such as a UE-side server, or a network-side network entity such as one of a network function, an OAM entity, a base station, or a RAN (or NG RAN) node (e.g., the base station 102, 406; a serving cell 1202; an NE in the set of NEs 802, 902, 1002, 1102, 1208; the server 806; the server 1008, 1108; the network entity 2702, 2802, 2960). The flowchart 2300, in some aspects, may follow after receiving, from the UE, an indication of support for performing the task associated with the ML model for the cell cluster at 2102 of FIG. 21. At 2312, the network entity may receive first cell information regarding one or more neighboring cells. For example, 2312 may be performed by CU processor(s) 2812, DU processor(s) 2832, RU processor(s) 2842, transceiver(s) 2846, antenna(s) 2880, network processor 2912, network interface 2980, and/or cluster-based model component 199 of FIGS. 28 and 29. For example, referring to FIG. 12, as part of determining, at 1224, one or more cluster memberships for one or more AI/ML models and/or tasks (e.g., prediction objectives) associated with the AI/ML models, serving cell 1202 may exchange, with the set of NEs 1208, cell information.

At 2314, the network entity may transmit, to at least one neighboring cell of the one or more neighboring cells, second cell information regarding the serving cell. For example, 2314 may be performed by CU processor(s) 2812, DU processor(s) 2832,

RU processor(s) 2842, transceiver(s) 2846, antenna(s) 2880, network processor 2912, network interface 2980, and/or cluster-based model component 199 of FIGS. 28 and 29. In some aspects, a membership of the cell cluster (e.g., the first information transmitted at 2030/2130 may be determined) based on the first cell information and/or the second cell information. For example, referring to FIG. 12, as part of determining, at 1224, one or more cluster memberships for one or more AI/ML models and/or tasks (e.g., prediction objectives) associated with the AI/ML models, serving cell 1202 may exchange, with the set of NEs 1208, cell information. The method illustrated in flowchart 2300, e.g., transmitting the second cell information at 2314, may be followed by one of 2030 or 2130 of FIG. 20 or 21, respectively.

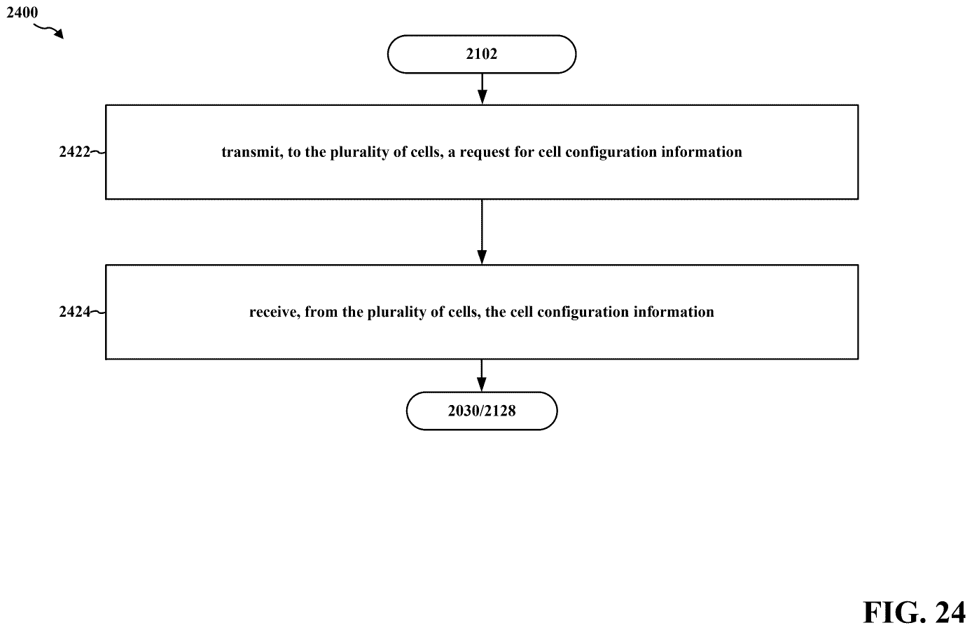

FIG. 24 is a flowchart 2400 of a method of wireless communication. The method may be performed by a network entity such as a UE-side network entity such as a UE-side server, or a network-side network entity such as one of a network function, an OAM entity, a base station, or a RAN (or NG RAN) node (e.g., the base station 102, 406; a serving cell 1202; an NE in the set of NEs 802, 902, 1002, 1102, 1208; the server 806; the server 1008, 1108; the network entity 2702, 2802, 2960). The flowchart 2400, in some aspects, may follow after receiving, from the UE, an indication of support for performing the task associated with the ML model for the cell cluster at 2102 of FIG. 21. At 2422, the network entity may transmit, to the plurality of cells, a request for cell configuration information. For example, 2422 may be performed by CU processor(s) 2812, DU processor(s) 2832, RU processor(s) 2842, transceiver(s) 2846, antenna(s) 2880, network processor 2912, network interface 2980, and/or cluster-based model component 199 of FIGS. 28 and 29. For example, referring to FIGS. 10 and 11, the server 1008/1108 may transmit cell configuration request 1011/1111.

At 2424, the network entity may receive, from the plurality of cells, the cell configuration information. For example, 2424 may be performed by CU processor(s) 2812, DU processor(s) 2832, RU processor(s) 2842, transceiver(s) 2846, antenna(s) 2880, network processor 2912, network interface 2980, and/or cluster-based model component 199 of FIGS. 28 and 29. For example, referring to FIGS. 10 and 11, the server 1008/1108 may receive cell configuration response 1012/1112. The method illustrated in flowchart 2400, e.g., receiving the cell configuration information at 2424, may be followed by one of 2030 or 2128 of FIG. 20 or 21, respectively. In some aspects, the determination at 2128 may be based on the cell configuration information received at 2424.

FIG. 25 is a flowchart 2500 of a method of wireless communication. The method may be performed by a network entity such as a UE-side network entity such as a UE-side server, or a network-side network entity such as one of a network function, an OAM entity, a base station, or a RAN (or NG RAN) node (e.g., the base station 102, 406; a serving cell 1202; an NE in the set of NEs 802, 902, 1002, 1102, 1208; the server 806; the server 1008, 1108; the network entity 2702, 2802, 2960). The flowchart 2500, in some aspects, may follow after outputting, the data collection configuration associated with the cell cluster at 2040 or 2140 of FIGS. 20 and 21, respectively. At 2552, the network entity may receive, from the UE, third information regarding the cell cluster based on the data collection configuration. For example, 2552 may be performed by CU processor(s) 2812, DU processor(s) 2832, RU processor(s) 2842, transceiver(s) 2846, antenna(s) 2880, network processor 2912, network interface 2980, and/or cluster-based model component 199 of FIGS. 28 and 29. Referring to FIG. 10, for example, the server 1008 may receive training data 1032 from a UE in the set of UEs 1004.

At 2554, the network entity may transmit, to the UE, the ML model. For example, 2554 may be performed by CU processor(s) 2812, DU processor(s) 2832, RU processor(s) 2842, transceiver(s) 2846, antenna(s) 2880, network processor 2912, network interface 2980, and/or cluster-based model component 199 of FIGS. 28 and 29. Referring to FIG. 10, for example, server 1008 may provide a trained AI/ML model 1036 to the UE in the set of UEs 1004. The method illustrated in flowchart 2500, e.g., receiving the cell configuration information at 2554, may be followed by 2662 of FIG. 26.

FIG. 26 is a flowchart 2600 of a method of wireless communication. The method may be performed by a network entity such as a UE-side network entity such as a UE-side server, or a network-side network entity such as one of a network function, an OAM entity, a base station, or a RAN (or NG RAN) node (e.g., the base station 102, 406; a serving cell 1202; an NE in the set of NEs 802, 902, 1002, 1102, 1208; the server 806; the server 1008, 1108; the network entity 2702, 2802, 2960). The flowchart 2600, in some aspects, may follow after outputting, the data collection configuration associated with the cell cluster at 2040 or 2140 or after receiving the cell configuration information at 2554, of FIG. 20, 21, or 25, respectively. At 2662, the network entity may receive, from the UE, feedback relating to one of an addition or a removal of at least one cell from a membership of the cell cluster. For example, 2652 may be performed by CU processor(s) 2812, DU processor(s) 2832, RU processor(s) 2842, transceiver(s) 2846, antenna(s) 2880, network processor 2912, network interface 2980, and/or cluster-based model component 199 of FIGS. 28 and 29. In some aspects, the feedback may include one or more measures of an accuracy of a prediction for one or more ML enabled features, feature groups, or functions associated with one or more of the cell cluster using the ML model or one or more or a modified cell clusters suing the ML model or modified ML models. Referring to FIG. 10, for example, the server 1008 may receive feedback 1069 (e.g., based on the AI/ML refinement at 1068) from the UE in the set of UEs 1004.

At 2664, the network entity may update, based on the feedback, the membership of the cell cluster. For example, 2664 may be performed by CU processor(s) 2812, DU processor(s) 2832, RU processor(s) 2842, transceiver(s) 2846, antenna(s) 2880, network processor 2912, network interface 2980, and/or cluster-based model component 199 of FIGS. 28 and 29. The update, in some aspects, may include one or more of an addition of at least a first cell (e.g., a cell not previously identified as being part of the cluster) or a removal of at least a second cell (e.g., a cell previously identified as being part of the cluster). Referring to FIG. 10, for example, the server 1008 may update a cluster membership (e.g., at 1024) as described in relation to the (periodic or event-triggered) repetition of cluster determination 1001.

At 2666, the network entity may transmit third information identifying the updated membership of the cell cluster. For example, 2666 may be performed by CU processor(s) 2812, DU processor(s) 2832, RU processor(s) 2842, transceiver(s) 2846, antenna(s) 2880, network processor 2912, network interface 2980, and/or cluster-based model component 199 of FIGS. 28 and 29. Referring to FIG. 10, for example, server 1008 may, after updating a cluster membership (e.g., at 1024) as described in relation to the (periodic or event-triggered) repetition of cluster determination 1001, provide and a UE in a set of UEs 1004 may receive (updated) cluster information 1026.

FIG. 27 is a diagram 2700 illustrating an example of a hardware implementation for an apparatus 2704. The apparatus 2704 may be a UE, a component of a UE, or may implement UE functionality. In some aspects, the apparatus 2704 may include at least one cellular baseband processor 2724 (also referred to as a modem) coupled to one or more transceivers 2722 (e.g., cellular RF transceiver). The cellular baseband processor(s) 2724 may include at least one on-chip memory 2724′. In some aspects, the apparatus 2704 may further include one or more subscriber identity modules (SIM) cards 2720 and at least one application processor 2706 coupled to a secure digital (SD) card 2708 and a screen 2710. The application processor(s) 2706 may include on-chip memory 2706′. In some aspects, the apparatus 2704 may further include a Bluetooth module 2712, a WLAN module 2714, an SPS module 2716 (e.g., GNSS module), one or more sensor modules 2718 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 2726, a power supply 2730, and/or a camera 2732. The Bluetooth module 2712, the WLAN module 2714, and the SPS module 2716 may include an on-chip transceiver (TRX) (or in some cases, just a receiver (RX)). The Bluetooth module 2712, the WLAN module 2714, and the SPS module 2716 may include their own dedicated antennas and/or utilize one or more antennas 2780 for communication. The cellular baseband processor(s) 2724 communicates through the transceiver(s) 2722 via the one or more antennas 2780 with the UE 104 and/or with an RU associated with a network entity 2702. The cellular baseband processor(s) 2724 and the application processor(s) 2706 may each include a computer-readable medium/memory 2724′, 2706′, respectively. The additional memory modules 2726 may also be considered a computer-readable medium/memory. Each computer-readable medium/memory 2724′, 2706′, 2726 may be non-transitory. The cellular baseband processor(s) 2724 and the application processor(s) 2706 are each responsible for general processing, including the execution of software stored on the computer-readable medium/memory. The software, when executed by the cellular baseband processor(s) 2724/application processor(s) 2706, causes the cellular baseband processor(s) 2724/application processor(s) 2706 to perform the various functions described supra. The cellular baseband processor(s) 2724 and the application processor(s) 2706 are configured to perform the various functions described supra based at least in part of the information stored in the memory. That is, the cellular baseband processor(s) 2724 and the application processor(s) 2706 may be configured to perform a first subset of the various functions described supra without information stored in the memory and may be configured to perform a second subset of the various functions described supra based on the information stored in the memory. The computer-readable medium/memory may also be used for storing data that is manipulated by the cellular baseband processor(s) 2724/application processor(s) 2706 when executing software. The cellular baseband processor(s) 2724/application processor(s) 2706 may be a component of the UE 350 and may include the at least one memory 360 and/or at least one of the TX processor 368, the RX processor 356, and the controller/processor 359. In one configuration, the apparatus 2704 may be at least one processor chip (modem and/or application) and include just the cellular baseband processor(s) 2724 and/or the application processor(s) 2706, and in another configuration, the apparatus 2704 may be the entire UE (e.g., see UE 350 of FIG. 3) and include the additional modules of the apparatus 2704.

As discussed supra, the cluster-based model component 198 may be configured to obtain, first information identifying a cell cluster comprising one or more cells of a plurality of cells, where the plurality of cells comprises a serving cell and one or more neighboring cells, and perform, based on the first information, a task associated with a ML model. The cluster-based model component 198 may be within the cellular baseband processor(s) 2724, the application processor(s) 2706, or both the cellular baseband processor(s) 2724 and the application processor(s) 2706. The cluster-based model component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 2704 may include a variety of components configured for various functions. In one configuration, the apparatus 2704, and in particular the cellular baseband processor(s) 2724 and/or the application processor(s) 2706, may include means for obtaining first information identifying a cell cluster comprising one or more cells of a plurality of cells. The apparatus 2704, and in particular the cellular baseband processor(s) 2724 and/or the application processor(s) 2706, may include means for performing, based on the first information, a task associated with a machine learning (ML) model. The apparatus 2704, and in particular the cellular baseband processor(s) 2724 and/or the application processor(s) 2706, may include means for receiving, from the serving cell, second information regarding the plurality of cells. The apparatus 2704, and in particular the cellular baseband processor(s) 2724 and/or the application processor(s) 2706, may include means for generating the first information identifying the cell cluster based on the second information. The apparatus 2704, and in particular the cellular baseband processor(s) 2724 and/or the application processor(s) 2706, may include means for receiving, from a server associated with a plurality of UEs, the first information identifying the cell cluster. The apparatus 2704, and in particular the cellular baseband processor(s) 2724 and/or the application processor(s) 2706, may include means for receiving, from a network entity, the first information identifying the cell cluster. The apparatus 2704, and in particular the cellular baseband processor(s) 2724 and/or the application processor(s) 2706, may include means for receiving a measurement configuration associated with the plurality of cells. The apparatus 2704, and in particular the cellular baseband processor(s) 2724 and/or the application processor(s) 2706, may include means for performing, based on the measurement configuration, a set of measurements associated with at least one cell of the plurality of cells. The apparatus 2704, and in particular the cellular baseband processor(s) 2724 and/or the application processor(s) 2706, may include means for transmitting, to a network entity, information based on the set of measurements associated with the at least one cell of the plurality of cells. The apparatus 2704, and in particular the cellular baseband processor(s) 2724 and/or the application processor(s) 2706, may include means for transmitting, to a network entity, feedback relating to one of an addition or a removal of at least one cell from the cell cluster. The apparatus 2704, and in particular the cellular baseband processor(s) 2724 and/or the application processor(s) 2706, may include means for receiving, from the network entity and based on the feedback, third information identifying an update to a membership of the cell cluster. The apparatus 2704, and in particular the cellular baseband processor(s) 2724 and/or the application processor(s) 2706, may include means for transmitting, to a network entity, an indication of support for performing the task associated with the ML model based on the cell cluster. The apparatus 2704, and in particular the cellular baseband processor(s) 2724 and/or the application processor(s) 2706, may include means for receiving a data collection configuration associated with the cell cluster. The apparatus 2704, and in particular the cellular baseband processor(s) 2724 and/or the application processor(s) 2706, may include means for collecting, based on the data collection configuration, data associated with at least one cell of the cell cluster. The apparatus 2704, and in particular the cellular baseband processor(s) 2724 and/or the application processor(s) 2706, may include means for training the ML model based on the data associated with the at least one cell of the cell cluster. The apparatus 2704, and in particular the cellular baseband processor(s) 2724 and/or the application processor(s) 2706, may include means for generating, based on the data, a prediction for one or more ML enabled features, feature groups, or functions associated with the cell cluster using the ML model. The apparatus 2704, and in particular the cellular baseband processor(s) 2724 and/or the application processor(s) 2706, may include means for transmitting, to a network entity, third information based on the data associated with the at least one cell of the cell cluster. The apparatus 2704, and in particular the cellular baseband processor(s) 2724 and/or the application processor(s) 2706, may include means for receiving, based on the third information, the ML model. The apparatus 2704, and in particular the cellular baseband processor(s) 2724 and/or the application processor(s) 2706, may include means for collecting additional data associated with the at least one cell of the cell cluster. The apparatus 2704, and in particular the cellular baseband processor(s) 2724 and/or the application processor(s) 2706, may include means for updating the ML model based on the additional data. The apparatus 2704, and in particular the cellular baseband processor(s) 2724 and/or the application processor(s) 2706, may include means for generating, based on the additional data, a prediction for one or more ML enabled features, feature groups, or functions associated with the cell cluster using the ML model. The apparatus 2704 may further include means for performing any of the aspects described in connection with the flowcharts in FIGS. 13-19, and/or performed by the UE in the communication flow of FIGS. 8-12. The means may be the cluster-based model component 198 of the apparatus 2704 configured to perform the functions recited by the means. As described supra, the apparatus 2704 may include the TX processor 368, the RX processor 356, and the controller/processor 359. As such, in one configuration, the means may be the TX processor 368, the RX processor 356, and/or the controller/processor 359 configured to perform the functions recited by the means. FIG. 28 is a diagram 2800 illustrating an example of a hardware implementation for a network entity 2802. The network entity 2802 may be a BS, a component of a BS, or may implement BS functionality. The network entity 2802 may include at least one of a CU 2810, a DU 2830, or an RU 2840. For example, depending on the layer functionality handled by the cluster-based model component 199, the network entity 2802 may include the CU 2810; both the CU 2810 and the DU 2830; each of the CU 2810, the DU 2830, and the RU 2840; the DU 2830; both the DU 2830 and the RU 2840; or the RU 2840. The CU 2810 may include at least one CU processor 2812. The CU processor(s) 2812 may include on-chip memory 2812′. In some aspects, the CU 2810 may further include additional memory modules 2814 and a communications interface 2818. The CU 2810 communicates with the DU 2830 through a midhaul link, such as an F1 interface. The DU 2830 may include at least one DU processor 2832. The DU processor(s) 2832 may include on-chip memory 2832′. In some aspects, the DU 2830 may further include additional memory modules 2834 and a communications interface 2838. The DU 2830 communicates with the RU 2840 through a fronthaul link. The RU 2840 may include at least one RU processor 2842. The RU processor(s) 2842 may include on-chip memory 2842′. In some aspects, the RU 2840 may further include additional memory modules 2844, one or more transceivers 2846, one or more antennas 2880, and a communications interface 2848. The RU 2840 communicates with the UE 104. The on-chip memory 2812′, 2832′, 2842′ and the additional memory modules 2814, 2834, 2844 may each be considered a computer-readable medium/memory. Each computer-readable medium/memory

may be non-transitory. Each of the processors 2812, 2832, 2842 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the cluster-based model component 199 may be configured to transmit, for a UE, first information identifying a cell cluster comprising one or more cells of a plurality of cells, where the plurality of cells comprises a serving cell and one or more neighboring cells, and output, for a ML model associated with a task to be performed by the UE, a data collection configuration associated with the cell cluster. The cluster-based model component 199 may be within one or more processors of one or more of the CU 2810, DU 2830, and the RU 2840. The cluster-based model component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2802 may include a variety of components configured for various functions. In one configuration, the network entity 2802 may include means for transmitting, for a user equipment (UE), first information identifying a cell cluster comprising one or more cells of a plurality of cells. The network entity 2802, in some aspects, may include means for outputting, for a machine learning (ML) model associated with a task to be performed by the UE, a data collection configuration associated with the cell cluster. The network entity 2802, in some aspects, may include means for transmitting, for a set of UEs comprising the UE, second information regarding the plurality of cells. The network entity 2802, in some aspects, may include means for transmitting, for the set of UEs, a measurement configuration associated with the plurality of cells. The network entity 2802, in some aspects, may include means for receiving, from the set of UEs, measurement information associated with at least one cell of the plurality of cells. The network entity 2802, in some aspects, may include means for receiving, from the UE, feedback relating to one of an addition or a removal of at least one cell from a membership of the cell cluster. The network entity 2802, in some aspects, may include means for updating, based on the feedback, the membership of the cell cluster. The network entity 2802, in some aspects, may include means for transmitting third information identifying the updated membership of the cell cluster. The network entity 2802, in some aspects, may include means for receiving, from the UE, an indication of support for performing the task associated with the ML model for the cell cluster. The network entity 2802, in some aspects, may include means for training the ML model. The network entity 2802, in some aspects, may include means for receiving, from the UE, third information regarding the cell cluster based on the data collection configuration. The network entity 2802, in some aspects, may include means for transmitting, to the UE, the ML model. The network entity 2802, in some aspects, may include means for transmitting, to the plurality of cells, a request for cell configuration information. The network entity 2802, in some aspects, may include means for receiving, from the plurality of cells, the cell configuration information. The network entity 2802, in some aspects, may include means for receiving first cell information regarding the one or more neighboring cells. The network entity 2802, in some aspects, may include means for transmitting, to at least one neighboring cell of the one or more neighboring cells, second cell information regarding the serving cell. The network entity 2802, in some aspects, may include means for transmitting the first information in system information. The network entity 2802 may further include means for performing any of the aspects described in connection with the flowchart in FIGS. 20-26, and/or performed by the base station in the communication flow of FIGS. 8-12. The means may be the cluster-based model component 199 of the network entity 2802 configured to perform the functions recited by the means. As described supra, the network entity 2802 may include the TX processor 316, the RX processor 370, and the controller/processor 375. As such, in one configuration, the means may be the TX processor 316, the RX processor 370, and/or the controller/processor 375 configured to perform the functions recited by the means.

FIG. 29 is a diagram 2900 illustrating an example of a hardware implementation for a network entity 2960. In one example, the network entity 2960 may be within the core network 120. The network entity 2960 may include at least one network processor 2912. The network processor(s) 2912 may include on-chip memory 2912′. In some aspects, the network entity 2960 may further include additional memory modules 2914. The network entity 2960 communicates via the network interface 2980 directly (e.g., backhaul link) or indirectly (e.g., through a RIC) with the CU 2902. The on-chip memory 2912′ and the additional memory modules 2914 may each be considered a computer-readable medium/memory. Each computer-readable medium/memory may be non-transitory. The network processor(s) 2912 is responsible for general processing, including the execution of software stored on the computer-readable medium/memory. The software, when executed by the corresponding processor(s) causes the processor(s) to perform the various functions described supra. The computer-readable medium/memory may also be used for storing data that is manipulated by the processor(s) when executing software.

As discussed supra, the cluster-based model component 199 may be configured to transmit, for a UE, first information identifying a cell cluster comprising one or more cells of a plurality of cells, where the plurality of cells comprises a serving cell and one or more neighboring cells, and output, for a ML model associated with a task to be performed by the UE, a data collection configuration associated with the cell cluster. The cluster-based model component 199 may be within the network processor(s) 2912. The cluster-based model component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 2960 may include a variety of components configured for various functions. In one configuration, the network entity 2960 may include means for transmitting, for a user equipment (UE), first information identifying a cell cluster comprising one or more cells of a plurality of cells. The network entity 2960, in some aspects, may include means for outputting, for a machine learning (ML) model associated with a task to be performed by the UE, a data collection configuration associated with the cell cluster. The network entity 2960, in some aspects, may include means for transmitting, for a set of UEs comprising the UE, second information regarding the plurality of cells. The network entity 2960, in some aspects, may include means for transmitting, for the set of UEs, a measurement configuration associated with the plurality of cells. The network entity 2960, in some aspects, may include means for receiving, from the set of UEs, measurement information associated with at least one cell of the plurality of cells. The network entity 2960, in some aspects, may include means for receiving, from the UE, feedback relating to one of an addition or a removal of at least one cell from a membership of the cell cluster. The network entity 2960, in some aspects, may include means for updating, based on the feedback, the membership of the cell cluster. The network entity 2960, in some aspects, may include means for transmitting third information identifying the updated membership of the cell cluster. The network entity 2960, in some aspects, may include means for receiving, from the UE, an indication of support for performing the task associated with the ML model for the cell cluster. The network entity 2960, in some aspects, may include means for training the ML model. The network entity 2960, in some aspects, may include means for receiving, from the UE, third information regarding the cell cluster based on the data collection configuration. The network entity 2960, in some aspects, may include means for transmitting, to the UE, the ML model. The network entity 2960, in some aspects, may include means for transmitting, to the plurality of cells, a request for cell configuration information. The network entity 2960, in some aspects, may include means for receiving, from the plurality of cells, the cell configuration information. The network entity 2960, in some aspects, may include means for receiving first cell information regarding the one or more neighboring cells. The network entity 2960, in some aspects, may include means for transmitting, to at least one neighboring cell of the one or more neighboring cells, second cell information regarding the serving cell. The network entity 2960, in some aspects, may include means for transmitting the first information in system information. The network entity 2960 may further include means for performing any of the aspects described in connection with the flowcharts in FIGS. 21-26, and/or performed by the base station in the communication flow of FIGS. 8-12. The means may be the cluster-based model component 199 of the network entity 2960 configured to perform the functions recited by the means.

Various aspects relate generally to forming clusters of neighboring cells specific for use in AI/ML mobility predictions and related signaling (e.g., how to form clusters for AI/ML-based predictions such as for RRM measurement prediction, measurement event prediction, RLF prediction, and handover failure prediction). The clusters may be formed, in some aspects, for measurement collection for AI/ML model training and/or for AI/ML predictions during inference. Some aspects more specifically relate to UE-side cluster formation (e.g., specification and/or identification) or network-side cluster formation. In some examples, a UE may be configured to receive, from a serving cell, first information regarding a plurality of cells, where the plurality of cells includes the serving cell and one or more neighboring cells, obtain, based on the first information regarding the plurality of cells, second information identifying a cell cluster including one or more cells of the plurality of cells, and perform, based on the second information, a task associated with a first ML model. In some examples, a network, a network node, a network function, a base station, or OAM function may be configured to transmit, for a first UE, first information regarding a plurality of cells, where the plurality of cells includes a serving cell and one or more neighboring cells, transmit, for the first UE, second information identifying a cell cluster including one or more cells of the plurality of cells, and transmit, for a ML model associated with a task to be performed by the first UE, a data collection configuration associated with the cell cluster.

Particular aspects of the subject matter described in this disclosure can be implemented to realize one or more of the following potential advantages. In some examples, by selecting the cells included in a cluster associated with a cluster-based AI/ML model, the described techniques can be used to improve the accuracy of predictions related to RRM and/or mobility.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor (i.e., a set of one or more processors P) is configured to perform a set of functions F, each processor of P may be configured to perform a subset S of F, where S & F. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.
Aspect 1 is a method of wireless communication at a user equipment (UE), comprising: obtaining first information identifying a cell cluster comprising one or more cells of a plurality of cells, wherein the plurality of cells comprises a serving cell and one or more neighboring cells; and performing, based on the first information, a task associated with a machine learning (ML) model.
Aspect 2 is the method of aspect 1, further comprising: receiving, from the serving cell, second information regarding the plurality of cells, and wherein obtaining the first information identifying the cell cluster comprises generating the first information identifying the cell cluster based on the second information.
Aspect 3 is the method of aspect 1, wherein obtaining the first information identifying the cell cluster comprises one of: receiving, from a server associated with a plurality of UEs, the first information identifying the cell cluster, wherein the plurality of UEs comprises the UE; or receiving, from a network entity, the first information identifying the cell cluster.
Aspect 4 is the method of any of aspects 1 to 3, wherein the first information identifying the cell cluster is associated with one or more of: an identifier of the cell cluster; a home public land mobile network (HPLMN) identifier; third information regarding one or more ML enabled features, feature groups, or functions associated with the cell cluster; or fourth information regarding an area scope associated with the cell cluster.
Aspect 5 is the method of any of aspects 1 to 4, further comprising: receiving a measurement configuration associated with the plurality of cells; and performing, based on the measurement configuration, a set of measurements associated with at least one cell of the plurality of cells.
Aspect 6 is the method of aspect 5, further comprising: transmitting, to a network entity, second information based on the set of measurements associated with the at least one cell of the plurality of cells, wherein obtaining the first information identifying the cell cluster comprises receiving, from the network entity, the first information identifying the cell cluster.
Aspect 7 is the method of any of aspects 1 to 6, wherein the first information further comprises at least one threshold for at least one corresponding key performance indicator (KPI) associated with the ML model.
Aspect 8 is the method of aspect 7, further comprising: transmitting, to a network entity, feedback relating to one of an addition or a removal of at least one cell from the cell cluster, wherein the feedback is based on the at least one threshold for the at least one corresponding KPI.
Aspect 9 is the method of aspect 8, further comprising: receiving, from the network entity and based on the feedback, third information identifying an update to a membership of the cell cluster.
Aspect 10 is the method of any of aspects 1 to 9, further comprising: transmitting, to a network entity, an indication of support for performing the task associated with the ML model based on the cell cluster, wherein the indication of the support is associated with one of a UE capability message, a UE assistance information message, or a radio resource control (RRC) message.
Aspect 11 is the method of aspect 10, wherein the indication of the support comprises one or more of: a first indication of support for a first maximum number of measured cells for one of (i) each cell cluster in a plurality of identified cell clusters or (ii) the plurality of identified cell clusters; a second indication of support for a second maximum number of measured carrier frequencies for one of (i) each cell cluster in the plurality of identified cell clusters or (ii) the plurality of identified cell clusters; or a third indication of support for a third maximum number of predictions for one of (i) each cell cluster in the plurality of identified cell clusters or (ii) the plurality of identified cell clusters.
Aspect 12 is the method of any of aspects 1 and 3 to 11, further comprising: receiving a data collection configuration associated with the cell cluster; and collecting, based on the data collection configuration, data associated with at least one cell of the cell cluster.
Aspect 13 is the method of aspect 12, wherein performing the task associated with the ML model comprises one or more of: training the ML model based on the data associated with the at least one cell of the cell cluster; or generating, based on the data, a prediction for one or more ML enabled features, feature groups, or functions associated with the cell cluster using the ML model.
Aspect 14 is the method of aspect 12, further comprising: transmitting, to a network entity, third information based on the data associated with the at least one cell of the cell cluster; receiving, based on the third information, the ML model; and collecting additional data associated with the at least one cell of the cell cluster, wherein performing the task associated with the ML model comprises one or more of: updating the ML model based on the additional data; or generating, based on the additional data, a prediction for one or more ML enabled features, feature groups, or functions associated with the cell cluster using the ML model.
Aspect 15 is the method of any of aspects 3, 6, 8-11, and 14, wherein the network entity is one of: a network function, an operations, administration, and maintenance (OAM) entity, a base station, or a radio area network (RAN) node.
Aspect 16 is a method of wireless communication at a network entity, comprising: transmitting, for a user equipment (UE), first information identifying a cell cluster comprising one or more cells of a plurality of cells, wherein the plurality of cells comprises a serving cell and one or more neighboring cells; and outputting, for a machine learning (ML) model associated with a task to be performed by the UE, a data collection configuration associated with the cell cluster.
Aspect 17 is the method of aspect 16, further comprising: transmitting, for a set of UEs comprising the UE, second information regarding the plurality of cells; and transmitting, for the set of UEs, a measurement configuration associated with the plurality of cells.
Aspect 18 is the method of aspect 17, further comprising: receiving, from the set of UEs, measurement information associated with at least one cell of the plurality of cells, wherein a membership of the cell cluster is based on the measurement information.
Aspect 19 is the method of any of aspects 16 to 18, wherein the first information further comprises at least one threshold for at least one corresponding key performance indicator (KPI) associated with the ML model.
Aspect 20 is the method of aspect 19, further comprising: receiving, from the UE, feedback relating to one of an addition or a removal of at least one cell from a membership of the cell cluster, wherein the feedback is based on the at least one threshold for the at least one corresponding KPI.
Aspect 21 is the method of aspect 20, further comprising: updating, based on the feedback, the membership of the cell cluster; and transmitting third information identifying the updated membership of the cell cluster.
Aspect 22 is the method of any of aspects 16 to 21, further comprising: receiving, from the UE, an indication of support for performing the task associated with the ML model for the cell cluster, wherein the indication of the support is associated with one of a UE capability message, a UE assistance information message, or a radio resource control (RRC) message.
Aspect 23 is the method of aspect 22, wherein the indication of the support comprises one or more of: a first indication of support for a first maximum number of measured cells for one of (i) each cell cluster in a plurality of identified cell clusters or (ii) the plurality of identified cell clusters; a second indication of support for a second maximum number of measured carrier frequencies for one of (i) each cell cluster in the plurality of identified cell clusters or (ii) the plurality of identified cell clusters; or a third indication of support for a third maximum number of predictions for one of (i) each cell cluster in the plurality of identified cell clusters or (ii) the plurality of identified cell clusters.
Aspect 24 is the method of any of aspects 16 to 23, wherein the task associated with the ML model comprises one or more of: training the ML model; or generating a prediction for one or more ML enabled features, feature groups, or functions associated with the cell cluster using the ML model.
Aspect 25 is the method of any of aspects 16 to 24, further comprising: receiving, from the UE, third information regarding the cell cluster based on the data collection configuration; and transmitting, to the UE, the ML model.
Aspect 26 is the method of any of aspects 16 to 25, wherein the network entity is a network function, the method further comprising: transmitting, to the plurality of cells, a request for cell configuration information; and receiving, from the plurality of cells, the cell configuration information, wherein the first information is based on the cell configuration information.
Aspect 27 is the method of any of aspects 16 to 25, wherein the network entity is the serving cell, the method further comprising: receiving first cell information regarding the one or more neighboring cells; and transmitting, to at least one neighboring cell of the one or more neighboring cells, second cell information regarding the serving cell, wherein a membership of the cell cluster is based on one or more of the first cell information or the second cell information.
Aspect 28 is the method of any of aspects 16 to 27, wherein the first information identifies a plurality of cell clusters including the cell cluster comprising the one or more cells of the plurality of cells, wherein a first cell cluster of the plurality of cell clusters and a second cell cluster of the plurality of cell clusters comprise at least a first cell, and wherein the first cell cluster comprises a second cell that is not included in the second cell cluster.
Aspect 29 is the method of any of aspects 16 to 28, wherein the first information identifying the cell cluster is associated with one or more of: an identifier of the cell cluster; a home public land mobile network (HPLMN) identifier; third information regarding one or more ML enabled features, feature groups, or functions associated with the cell cluster; or fourth information regarding an area scope associated with the cell cluster.
Aspect 30 is the method of any of aspects 16 to 29, wherein transmitting the first information comprises: transmitting the first information in system information.
Aspect 31 is the method of any of aspects 16 to 30, wherein the network entity is one of: a network function; an operations, administration, and maintenance (OAM) entity; a base station; the serving cell; or a radio area network (RAN) node.
Aspect 32 is an apparatus for wireless communication at a wireless device, comprising: at least one memory; and at least one processor coupled to the at least one memory, the at least one processor is configured to perform the method of any of aspects 1 to 15.
Aspect 33 is an apparatus for wireless communication at a wireless device, comprising means for performing each step in the method of any of aspects 1 to 15.
Aspect 34 is the apparatus of any of aspects 32 to 33, further comprising a transceiver configured to receive or to transmit in association with the method of any of aspects 1 to 15.
Aspect 35 is a computer-readable medium (e.g. a non-transitory computer-readable medium) storing computer executable code at a wireless device, the code when executed by at least one processor causes the at least one processor to perform the method of any of aspects 1 to 15.
Aspect 36 is an apparatus for wireless communication at a network entity, comprising: at least one memory; and at least one processor coupled to the at least one memory, the at least one processor is configured to perform the method of any of aspects 16 to 31.
Aspect 37 is an apparatus for wireless communication at a network entity, comprising means for performing each step in the method of any of aspects 16 to 31.
Aspect 38 is the apparatus of any of aspects 37 to 38, further comprising a transceiver configured to receive or to transmit in association with the method of any of aspects 16 to 31.
Aspect 39 is a computer-readable medium (e.g. a non-transitory computer-readable medium) storing computer executable code at a network entity, the code when executed by at least one processor causes the at least one processor to perform the method of any of aspects 16 to 31.

What is claimed is:

1. An apparatus for wireless communication at a user equipment (UE), comprising:
at least one memory; and
at least one processor coupled to the at least one memory and, based at least in part on information stored in the at least one memory, the at least one processor is configured to:
obtain first information identifying a cell cluster comprising one or more cells of a plurality of cells, wherein the plurality of cells comprises a serving cell and one or more neighboring cells; and
perform, based on the first information, a task associated with a machine learning (ML) model.

2. The apparatus of claim 1, wherein the at least one processor is further configured to:
receive, from the serving cell, second information regarding the plurality of cells, and wherein, to obtain the first information identifying the cell cluster, the at least one processor is configured to generate the first information identifying the cell cluster based on the second information.

3. The apparatus of claim 1, wherein, to obtain the first information identifying the cell cluster, the at least one processor is configured to one of:
receive, from a server associated with a plurality of UEs, the first information identifying the cell cluster, wherein the plurality of UEs comprises the UE; or
receive, from a network entity, the first information identifying the cell cluster.

4. The apparatus of claim 1, wherein the first information identifying the cell cluster is associated with one or more of:
an identifier of the cell cluster;
a home public land mobile network (HPLMN) identifier;
third information regarding one or more ML enabled features, feature groups, or functions associated with the cell cluster; or
fourth information regarding an area scope associated with the cell cluster.

5. The apparatus of claim 1, wherein the at least one processor is further configured to:
receive a measurement configuration associated with the plurality of cells;
perform, based on the measurement configuration, a set of measurements associated with at least one cell of the plurality of cells; and
transmit, to a network entity, second information based on the set of measurements associated with the at least one cell of the plurality of cells, wherein, to obtain the first information identifying the cell cluster, the at least one processor is configured to receive, from the network entity, the first information identifying the cell cluster.

6. The apparatus of claim 1, wherein the first information further comprises at least one threshold for at least one corresponding key performance indicator (KPI) associated with the ML model, wherein the at least one processor is further configured to:
transmit, to a network entity, feedback relating to one of an addition or a removal of at least one cell from the cell cluster, wherein the feedback is based on the at least one threshold for the at least one corresponding KPI; and
receive, from the network entity and based on the feedback, third information identifying an update to a membership of the cell cluster.

7. The apparatus of claim 1, wherein the at least one processor is further configured to:
transmit, to a network entity, an indication of support for performing the task associated with the ML model based on the cell cluster, wherein the indication of the support is associated with one of a UE capability message, a UE assistance information message, or a radio resource control (RRC) message.

8. The apparatus of claim 7, wherein the indication of the support comprises one or more of:
a first indication of support for a first maximum number of measured cells for one of (i) each cell cluster in a plurality of identified cell clusters or (ii) the plurality of identified cell clusters;
a second indication of support for a second maximum number of measured carrier frequencies for one of (i) each cell cluster in the plurality of identified cell clusters or (ii) the plurality of identified cell clusters; or
a third indication of support for a third maximum number of predictions for one of (i) each cell cluster in the plurality of identified cell clusters or (ii) the plurality of identified cell clusters.

9. The apparatus of claim 1, wherein the at least one processor is further configured to:
receive a data collection configuration associated with the cell cluster; and
collect, based on the data collection configuration, data associated with at least one cell of the cell cluster.

10. The apparatus of claim 9, wherein, to perform the task associated with the ML model, the at least one processor is configured to one or more of:
train the ML model based on the data associated with the at least one cell of the cell cluster; or
generate, based on the data, a prediction for one or more ML enabled features, feature groups, or functions associated with the cell cluster using the ML model.

11. The apparatus of claim 9, wherein the at least one processor is further configured to:
transmit, to a network entity, third information based on the data associated with the at least one cell of the cell cluster;
receive, based on the third information, the ML model; and
collect additional data associated with the at least one cell of the cell cluster, wherein, to perform the task associated with the ML model, the at least one processor is configured to one or more of:
update the ML model based on the additional data; or
generate, based on the additional data, a prediction for one or more ML enabled features, feature groups, or functions associated with the cell cluster using the ML model.

12. The apparatus of claim 11, wherein the network entity is one of:
a network function,
an operations, administration, and maintenance (OAM) entity,
a base station, or
a radio area network (RAN) node.

13. An apparatus for wireless communication at a network entity, comprising:
at least one memory; and
at least one processor coupled to the at least one memory and, based at least in part on information stored in the at least one memory, the at least one processor is configured to:
transmit, for a user equipment (UE), first information identifying a cell cluster comprising one or more cells of a plurality of cells, wherein the plurality of cells comprises a serving cell and one or more neighboring cells; and
output, for a machine learning (ML) model associated with a task to be performed by the UE, a data collection configuration associated with the cell cluster.

14. The apparatus of claim 13, wherein the at least one processor is further configured to:
transmit, for a set of UEs comprising the UE, second information regarding the plurality of cells; and
transmit, for the set of UEs, a measurement configuration associated with the plurality of cells.

15. The apparatus of claim 14, wherein the at least one processor is further configured to:
receive, from the set of UEs, measurement information associated with at least one cell of the plurality of cells, wherein a membership of the cell cluster is based on the measurement information.

16. The apparatus of claim 13, wherein the first information further comprises at least one threshold for at least one corresponding key performance indicator (KPI) associated with the ML model, wherein the at least one processor is further configured to:
receive, from the UE, feedback relating to one of an addition or a removal of at least one cell from a membership of the cell cluster, wherein the feedback is based on the at least one threshold for the at least one corresponding KPI;
update, based on the feedback, the membership of the cell cluster; and
transmit third information identifying the updated membership of the cell cluster.

17. The apparatus of claim 13, wherein the at least one processor is further configured to:
receive, from the UE, an indication of support for performing the task associated with the ML model for the cell cluster, wherein the indication of the support is associated with one of a UE capability message, a UE assistance information message, or a radio resource control (RRC) message.

18. The apparatus of claim 17, wherein the indication of the support comprises one or more of:
a first indication of support for a first maximum number of measured cells for one of (i) each cell cluster in a plurality of identified cell clusters or (ii) the plurality of identified cell clusters;
a second indication of support for a second maximum number of measured carrier frequencies for one of (i) each cell cluster in the plurality of identified cell clusters or (ii) the plurality of identified cell clusters; or
a third indication of support for a third maximum number of predictions for one of (i) each cell cluster in the plurality of identified cell clusters or (ii) the plurality of identified cell clusters.

19. The apparatus of claim 13, wherein the at least one processor is further configured to:
receive, from the UE, third information regarding the cell cluster based on the data collection configuration; and
transmit, to the UE, the ML model.

20. The apparatus of claim 13, wherein the network entity is a network function, wherein the at least one processor is further configured to:
transmit, to the plurality of cells, a request for cell configuration information; and
receive, from the plurality of cells, the cell configuration information, wherein the first information is based on the cell configuration information.

21. The apparatus of claim 13, wherein the network entity is the serving cell, wherein the at least one processor is further configured to:
receive first cell information regarding the one or more neighboring cells; and
transmit, to at least one neighboring cell of the one or more neighboring cells, second cell information regarding the serving cell, wherein a membership of the cell cluster is based on one or more of the first cell information or the second cell information.

22. The apparatus of claim 13, wherein the first information identifies a plurality of cell clusters including the cell cluster comprising the one or more cells of the plurality of cells, wherein a first cell cluster of the plurality of cell clusters and a second cell cluster of the plurality of cell clusters comprise at least a first cell, and wherein the first cell cluster comprises a second cell that is not included in the second cell cluster.

23. The apparatus of claim 13, wherein the first information identifying the cell cluster is associated with one or more of:
an identifier of the cell cluster;
a home public land mobile network (HPLMN) identifier;
third information regarding one or more ML enabled features, feature groups, or functions associated with the cell cluster; or
fourth information regarding an area scope associated with the cell cluster.

24. The apparatus of claim 13, wherein to transmit the first information, the at least one processor is configured to:
transmit the first information in system information.

25. The apparatus of claim 13, wherein the network entity is one of:
a network function;
an operations, administration, and maintenance (OAM) entity;
a base station;
the serving cell; or
a radio area network (RAN) node.

26. A method of wireless communication at a user equipment (UE), comprising:
obtaining first information identifying a cell cluster comprising one or more cells of a plurality of cells, wherein the plurality of cells comprises a serving cell and one or more neighboring cells; and
performing, based on the first information, a task associated with a machine learning (ML) model.

27. The method of claim 26, wherein obtaining the first information identifying the cell cluster comprises one of:
receiving, from the serving cell, second information regarding the plurality of cells, and wherein obtaining the first information identifying the cell cluster comprises generating the first information identifying the cell cluster based on the second information;
receiving, from a server associated with a plurality of UEs, the first information identifying the cell cluster, wherein the plurality of UEs comprises the UE; or
receiving, from a network entity, the first information identifying the cell cluster.

28. The method of claim 26, wherein the first information identifying the cell cluster is associated with one or more of:
an identifier of the cell cluster;
a home public land mobile network (HPLMN) identifier;
third information regarding one or more ML enabled features, feature groups, or functions associated with the cell cluster; or
fourth information regarding an area scope associated with the cell cluster.

29. A method of wireless communication at a network entity, comprising:
transmitting, for a user equipment (UE), first information identifying a cell cluster comprising one or more cells of a plurality of cells, wherein the plurality of cells comprises a serving cell and one or more neighboring cells; and
outputting, for a machine learning (ML) model associated with a task to be performed by the UE, a data collection configuration associated with the cell cluster.

30. The method of claim 29, wherein the first information identifying the cell cluster is associated with one or more of:
an identifier of the cell cluster;
a home public land mobile network (HPLMN) identifier;
third information regarding one or more ML enabled features, feature groups, or functions associated with the cell cluster; or
fourth information regarding an area scope associated with the cell cluster.
